(19) United States
(12) Patent Application Publication
(10) Pub. No.: US 2026/0063966 A1
(43) Pub. Date: Mar. 5, 2026

(54) NONLINEAR ALL-OPTICAL MACHINE LEARNING SYSTEMS AND METHODS USING NONLINEAR OPTICAL RESONATOR-BASED NEURONS

(71) Applicant: Yongxi Tan, Hillsborough, NJ (US)

(72) Inventor: Yongxi Tan, Hillsborough, NJ (US)

(21) Appl. No.: 19/313,248

(22) Filed: Aug. 28, 2025

Related U.S. Application Data
(60) Provisional application No. 63/689,937, filed on Sep. 3, 2024.
(60) Provisional application No. 63/689,947, filed on Sep. 3, 2024.

(51) Int. Cl. G02F 1/35

(52) U.S. Cl. CPC G02F 1/3515

(57) ABSTRACT

A nonlinear all optical machine learning system (NAOMLS) with nonlinear optical resonator-based continuous wave and/or spiking neurons (NORs) and linear optical components or layers (LOL) learns to implement target tasks after machine learning based direct and/or indirect inverse design and/or optimization of the NORs and/or optimization of the LOL. The inversely designed and/or optimized NORs and the optimized LOL collectively define learnable mapping functions between input lights and output lights of the NAOMLS to meet target objectives for target tasks. In some embodiments, the NORs are indirectly and inversely designed to meet inversely designed objectives in order to be integrated with the NAOMLS so that the NAOMLS can function properly to meet target objectives for target tasks. In some embodiments, the NORs are integrated directly with the NAOMLS and inversely designed and/or optimized with the LOL to directly meet target objectives for target tasks.

### CROSS-REFERENCE TO RELATED APPLICATIONS

This application claims the benefit of and priority to U.S. Provisional Patent Application No. 63/689,937 filed on Sep. 3, 2024 and U.S. Provisional Patent Application No. 63/689,947 filed on Sep. 3, 2024, which are hereby incorporated by reference.

### TECHNICAL FIELD

The embodiments discussed in the present disclosure relate to nonlinear all-optical machine learning systems with one or more nonlinear optical resonator-based neurons that can perform, at the speed of light, various target tasks or functions that an artificial neural network can implement.

### BACKGROUND

Unless otherwise indicated in the present disclosure, the materials described in the present disclosure are not prior art to the claims in the present application and are not admitted to be prior art by inclusion in this section.

Artificial intelligence (AI), especially deep neural network or deep learning accelerated by graphics processing units (GPUs) or AI-chip, plays more and more import role in a wide range of applications, including but not limited to (IBNLT), generative AI for text/image/video/audio (e.g., ChatGPT, Stability AI), discriminative AI (e.g., image recognition, object detection/identification/tracking, segmentation), artificial general intelligence, super-resolution, autonomous driving, drone, robotics, smart phone/home/city, internet of things, surveillance, AR/VR, communication, etc. However the fast-growing computing demand (e.g., lower power consumption, lower latency, higher speed, higher bandwidth) of AI, especially large neural work, becomes more and more challenging for electronic-based AI accelerator (e.g., GPU, AI-chip, FPGA, TPU), especially considering the fact that Moore's law is ending.

Given the inherent advantages (e.g., massive parallelism, little or no power consumption, light speed, high bandwidth) of optical information processing, various optical computing architectures or frameworks were proposed to meet the AI demand. For example, Mach-Zehnder interferometers (MZI) based nanophotonic circuit was proposed to implement optical matrix multiplication for a neural network (Y. Shen et al, Deep learning with coherent nanophotonic circuits, Nature Photonics, 2017, 11:441). Diffractive optics was used as optical convolutional layer for a hybrid optical-electronic neural network (J. Chang et al, Hybrid optical-electronic convolutional neural networks with optimized diffractive optics for image classification, Scientific Reports, 2018, 8:12324). Multiple diffractive layers were used as diffractive deep neural network to learn various machine learning tasks (X. Lin et al, All-optical machine learning using diffractive deep neural networks, Science, 2018, 361:1004; A. Ozcan et al, Devices and methods employing optical-based machine learning using diffractive deep neural networks, US 2021/0142170 A1, U.S. Pat. No. 11,392,830 B2 and U.S. Pat. No. 12,086,717 B2). Although certain optical nonlinear material (e.g., SBN photorefractive crystal) was proposed to be used as optical nonlinear activation function in all optical diffraction-depth neural network (Q. Dai et al, Nonlinear all-optical deep-learning system and method with multistage space-frequency domain modulation, 2020, U.S. Pat. No. 11,600,060 B2), lack of practical, efficient and effective optical nonlinear material or device or module with strong nonlinearity significantly impedes the application of optical computing systems or methods in AI, since nonlinear activation function plays most important role in the power and versatility of neural networks.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In general, the present disclosure relates to a nonlinear all optical machine learning system with built-in optical nonlinearity that can perform same or similar functions and tasks as artificial neural networks. More particularly, some embodiments of the present disclosure relate to indirect or direct inverse design and optimization of one or more nonlinear optical resonator-based neurons to be used as an optical nonlinear activation functions or components in the nonlinear all-optical machine learning system for various AI tasks.

In some embodiments, a variety of nonlinear optical resonator (NOR) based continuous wave (CW) and/or spiking neurons or elements or devices or modules (CW or spiking NORs) are indirectly and inversely designed and optimized to meet inversely designed objectives (e.g., target or expected nonlinear output response curve shape, low output reflective light intensity for transmissive CW or spiking NOR, low electric current/voltage applied to NOR to generate nonlinear output response, small aperture size of NOR to generate nonlinear output response, polarization control for output transmissive light and/or output reflective light, single output pulse number for spiking NOR, etc) in order to be integrated as optical nonlinear activation functions or components in a nonlinear all optical machine learning system so that the integrated nonlinear all optical machine learning system can function properly to meet target objectives or criteria (e.g., high accuracy, good performance, low power consumption, low optical noise, etc) for target tasks or functions (e.g., classification, generative task, large language model, etc). As will be appreciated by those skilled in the art, some embodiments of CW or spiking NOR include but are not limited to the following components:
1) one or more optical resonant cavity, IBNLT, standing wave cavity (e.g., vertical cavity, edge emitting cavity) in which light propagates back and forth and forms standing wave patterns between two or more materials or elements/devices/modules/components (e.g., mirror, periodic structure [e.g., distributed Bragg reflector {DBR, e.g., AlGaAs/AlAs, AlGaInP/AlInP, AlGaAs/GaN, AlN/GaN, GaN, AlxGa1-xAs, (AlxGa1-x)0.5In0.5P/(AlyGa1-y)0.5In0.5P, TiO2, etc}, 1D/2D/3D grating, 1D/2D/3D photonic crystal] or aperiodically alternating structure of same or different type of materials [e.g., suitable reflective materials {e.g., metal, semiconductor, glass, ceramic}, dielectric materials, InGaAs/InAlAs, Ta2O5/SiO2, AlN/GaN, etc], metamaterial [e.g., metasurface, metaline]), traveling wave cavity in which light propagates in two opposite directions or goes around in a loop like fashion (e.g., ring cavity, whispering-gallery cavity, microdisk cavity, microtoroid cavity, microcapillary cavity, microsphere cavity, microbubble cavity, etc), photonic crystal cavity in which light is confined inside a cavity or small area (e.g., defect, break) in the 1D/2D/3D periodic nanostructure/material/element (IBNLT, semiconductors, dielectrics, wide bandgap materials, polymers, hybrid structures [e.g., combinations of various materials]), and through one or more materials or elements/devices inside a photonic crystal cavity, a plasmonic cavity in which light is confined and enhanced by excitation of surface plasmon polaritons (SPP) at metal-dielectric interfaces, a hybrid cavity which combines two or more different physical systems, materials, or cavity designs to achieve enhanced or new functionalities (IBNLT, hybrid standing-wave and traveling-wave cavity, hybrid external cavity, ring-linear coupled cavity);
2) one or more materials or elements/devices/modules, IBNLT, a gain medium (which is electrically pumped and/or optically-pumped and/or chemically-pumped) providing gain for light propagating inside the resonant cavity, a loss material (which is either unpumped or electrically pumped and/or optically-pumped and/or chemically-pumped) exhibiting loss for light propagating inside the resonant cavity, phase change materials or elements/devices (PCM), an active or passive material or elements/devices/modules modulating or manipulating or changing one or more properties (e.g., current, voltage, amplitude, phase, frequency, pulse shape/position/width/amplitude/phase/frequency/repetition rate) of an electric signal and/or one or more properties (e.g., intensity, phase, frequency, polarization, orbital angular momentum [OAM], pulse shape/position/width/amplitude/phase/frequency/repetition rate, geometry [e.g., direction, size, shape], focus, etc.) of light propagating inside and/or outside of the resonant cavity (e.g., various modulators, lens, output coupler, polarizing element, photodiode, piezo actuator, microelectromechanical systems, grating, dispersive mirror, metamaterial or metasurface, etc);
3) optical materials/elements/devices and materials/devices may be separated by, IBNLT, free-space (e.g., vacuum, air, liquid), passive and/or active materials (e.g., glass, fiber, spacer, waveguide, semiconductor);
4) same or different type of optical materials/elements/devices (e.g., DBR, DBR+photonic crystal, DBRs from different type of materials) may be used for same or different cavities (e.g., single/coupled/cascade/external cavity);
5) same or different type of materials/elements/devices may be used (e.g., gain medium+loss material, active loss material which is electrically and/or optically pumped+passive loss material which is unpumped, gain medium+optical modulation element/device, gain medium+electric modulation device, gain medium+pulse picker);
6) certain components (e.g., gain medium, loss material, PCM, modulation device) of CW or spiking NOR may be electrically pumped by electric current/voltage/signal with certain properties (e.g., bias voltage, amplitude, phase, frequency, pulse width/position/shape/duration/intensity/repetition rate, operation time) being dynamically modulated (e.g., amplitude modulation, phase modulation, frequency modulation, pulse width modulation, pulse-position modulation) or not (e.g., no change, constant over time, 0 current), and/or optically pumped by optical signal (IBNLT, CW and/or >=1 pulses, polarized or non-polarized, single frequency or multi-frequencies, coherent or incoherent, frequency detuned [frequency different from the resonant frequency of the cavity] or not, OAM or not, plane wave or non-plane wave, visible or invisible, patterned [e.g., 1D/2D/3D structure light, hologram, temporal and/or spatial pattern] or not) with certain properties (e.g., intensity, phase, polarization, frequencies, OAM, pulse width/position/duration/shape/number/intensity/repetition rate, beam size/shape) being modulated or not;
7) in some embodiments, >=1 controller (eg., automated control system, smart control systems, AI powered agents or systems) may be configured to manage operational states (IBNLT, sleep or standby mode, wake up, turn on, turn off, different nonlinear relationship between input and output light, different configuration, different polarization state, different geometry and/or position and/or angle) of >=1 CW and/or spiking NORs on >=1 layers of >=1 devices by dynamically adjust relevant tunable parameters or variables or components (eg., certain properties of electric current/voltage/signal applied to relevant components of CW and/or spiking NORs, tunable or movable and/or rotatable and/or deformable parts or components [e.g., MEMS, NEMS, liquid crystal, PD, modulator, lens] of NORs) in real time according to >=1 temperature values (e.g., detected and/or estimated and/or predicted temperature) of >=1 NORs and/or environment, >=1 power consumption values (e.g., detected and/or estimated and/or predicted power consumption) of >=1 NORs, locations or positions of >=1 NORs, >=1 time periods, >=1 types of information (e.g., environment information [e.g., position, speed, time], information from controllers, information received by >=1 NORs, information pre-process or post-processed computing block/component of >=1 NORs, light transmitted to and reflected from >=1 objects or scenes, temporal information, spatial information), >=1 criteria (e.g., event-based conditions to trigger action/process/state, change-based update [e.g., only update >=1 NORs with to-be updated values different from current values], coded rolling shutter like row-by-row or block-by-block space and time control and update for >=1 NORs on >=1 layers of >=1 devices, pixel or row or layer or section or group wise update), >=1 objectives, >=1 tasks.
8) in some embodiments, electric current applied to gain medium may be below lasing threshold current; in some embodiments, electric current applied to gain medium may be equal to or above lasing threshold current; in some embodiments, electric current may be above or equal to or below certain threshold current at different time window; in some embodiments, electric current/voltage/signal applied to gain medium may be modulated according to certain pattern and/or modulation technique (e.g., pulse width modulation, amplitude/phase modulation, analog/digital modulation);
9) in one embodiment, electric current/voltage applied to PCM or loss material or modulating element/device may be below or equal to certain threshold (e.g, 0); in another embodiment, electric current/voltage applied to PCM or loss material or modulating element/device may be above certain threshold; in another embodiment, electric current/voltage applied to PCM or loss material or modulating element/device may be above or equal to or below certain threshold at different time window; in yet another embodiment, electric current/voltage applied to PCM or loss material or modulating element/device may be modulated according to certain pattern and/or modulation technique (e.g., pulse width modulation, amplitude/phase/polarization modulation, analog/digital modulation);
10) spiking NOR may emit light as >=1 pulses or spikes if one or more criteria are met (but no output pulse or spike otherwise), IBNLT, spiking NOR is designed to generate pulses or spikes under certain conditions according to certain mechanisms (e.g., gain switch, Q switch, active/passive mode lock, cavity dump, self-phase modulation, group-velocity dispersion, saturable absorption, soliton-assisted time-lens compression, pulsed pumping electrically and/or optically, external pulse carving), intensity of >=1 input pulses is larger than certain threshold and no output spike otherwise, interval of >=2 pulses (e.g., with intensity below threshold for each pulse) is less than certain threshold, pumping current and/or light is above certain threshold for certain duration, modulator (e.g., Q-switcher, pulse picker, cavity dumper) is switched to “on” or “off” state; and/or
11) Polarization of CW or spiking NOR may be controlled by, IBNLT, grating, anisotropy (e.g., stress, cavity geometry, shape [e.g., rectangle, rhombus, ellipse] for aperture and/or active region and/or mesas, anisotropic current injection, confinement), liquid crystal, metasurface, optical injection (e.g., wavelength and/or polarization of input light), external polarization selection elements; in one embodiment, polarization of transmissive output light and/or reflective output light of transmissive CW or spiking NOR may be controlled; in another embodiment, polarization of reflective output light of reflective CW or spiking NOR may be controlled.

In some embodiments, several steps or processes may be involved to inversely design optimal nonlinear optical material/element/device (e.g, 0D [i.e, single pixel] or 1D array or 2D array of nonlinear optical resonators as CW or spiking NORs) to meet inversely designed objectives in order to be integrated as optical nonlinear activation functions or components in the nonlinear all optical machine learning system so that the nonlinear all optical machine learning system can function properly to meet target objectives or criteria for target tasks or functions. These steps may include:
1) identify >=1 inversely designed tasks and/or objectives to be optimized (e.g., expected objectives for certain tasks, type of CW or spiking NOR, certain targets or expected properties of CW or spiking NOR, certain targets or expected properties of output light and/or relationships between output light and input light) and >=1 inversely designed design parameter spaces (e.g., parameters relevant to specific spiking/pulse generating mechanism, parameters relevant to CW or spiking NOR, parameters relevant to models used to simulate CW or spiking NOR, certain property of input light, certain properties of electric current/voltage/signal applied to gain medium and/or loss material or modulating element/device, etc.) of nonlinear optical material/element/device according to relevant information; Those inversely designed tasks and/or objectives and design parameters spaces are inversely designed for the nonlinear all optical machine learning systems to function properly and meet >=1 target objectives or criteria for >=1 target tasks or functions.
2) choose appropriate experiment design (e.g., random design, simplex, orthogonal design) and/or model (e.g., differentiable [e.g., gradient-based] and/or non-differentiable model, deep learning, reinforcement learning, hyperparameter optimization, global optimization) to optimize the design of nonlinear optical material/element/device according to relevant information from step 1 and domain knowledges;
3) sample a set of design points in design parameters space according to experiment designs and/or models (e.g., cold-start model, pretrained model, model built on data from previous experiments, etc);
4) perform real experiments and/or virtual experiments (e.g., simulations, differentiable and/or non-differentiable model, machine learning model, deep learning model, neural network, rate equations for CW or spiking NOR, finite-difference time-domain [FDTD], finite element method [FEM], eigenmode expansion [EEM], etc) to collect relevant information for each design point of nonlinear optical material/element/device; and/or
5) build or update model to optimize design of nonlinear optical material/element/device according to relationship between design parameters and relevant information collected from experiments.

In some embodiments, steps or processes are involved to integrate linear and/or nonlinear material/element/device (e.g., 0D/1D/2D linear or nonlinear CW NORs and/or 0D/1D/2D nonlinear spiking NORs, metamaterial) directly with a nonlinear all optical machine learning system and directly optimized together with the nonlinear all optical machine learning system to meet target objectives or criteria for target tasks or functions. These steps may include:
1) build differentiable and/or non-differentiable models (e.g., simulations, curve fitting, neural network, ordinary and/or partial differential equations [e.g., rate equations for CW or spiking NOR], neural ordinary differential equations, neural partial differential equations, FDTD, FEM, EEM, etc) for given designs of linear and/or nonlinear material/element/device;
2) integrate differentiable and/or non-differentiable linear and/or nonlinear material/element/device models with a simulation model (e.g., differentiable or non-differentiable model) of the nonlinear all optical machine learning system (e.g., optical neural network, optical sensing and computing) for target tasks/functions;
3) obtain an optimal design of the integrated nonlinear all optical machine learning system by using differentiable or non-differentiable optimization method (e.g., SGD, Adam, hyperparameter optimization, global optimization, reinforcement learning, solvers for differential equations used in simulation) to optimize structure and parameters of the simulation model and/or linear and/or nonlinear material/element/device;
4) obtain physical embodiment of optimal design of the integrated nonlinear all optical machine learning system by manufacturing a new integrated nonlinear all optical machine learning system/subsystem or applying optical design to existing integrated nonlinear all optical machine learning system; and/or
5) perform >=1 task/function with physical embodiment of the optimal design of the integrated nonlinear all optical machine learning system.

### BRIEF DESCRIPTION OF THE DRAWINGS

FIG. 1A to FIG. 1J20 schematically illustrate 63 example embodiments of nonlinear optical resonator (NOR) based CW or spiking neurons or elements/devices/modules (CW or spiking NORs) that may be used as optical nonlinear activation function or module or device or element in different optical information processing devices, architectures, systems, platforms, frameworks and methods. FIG. 1A to FIG. 1D1 schematically illustrate 30 example embodiments of standing-wave cavity based nonlinear optical resonator as a CW or spiking NOR. FIG. 1E1 to FIG. 1H1 schematically illustrate 4 example embodiments of traveling wave cavity based nonlinear optical resonator as a CW or spiking NOR. FIGS. 1I1 to 1I9 schematically illustrate 9 example embodiments of photonic crystal cavity based nonlinear optical resonator as CW or spiking NOR. FIGS. 1J1 to 1J20 schematically illustrate 20 example embodiments of plasmonic cavity based nonlinear optical resonator as CW or spiking NOR.

FIGS. 2A-2I schematically illustrate 9 example embodiments of standing wave cavity based nonlinear optical resonator as a CW or spiking NOR according to example embodiment illustrated in FIG. 1A.

FIGS. 3A-3I schematically illustrate 9 example embodiments of an electrically and/or optically pumped vertical cavity based nonlinear optical resonator as a CW or spiking NOR, according to an embodiment illustrated in FIG. 2B or FIG. 2E or FIG. 2H.

FIGS. 4A-4P schematically illustrate 16 example embodiments of an electrically and/or optically pumped edge-emitting transmissive or reflective nonlinear optical resonator as a CW or spiking NOR.

FIGS. 5A-5L illustrate 12 example embodiments of an electrically pumped transmissive or reflective vertical-cavity surface-emitting laser (VCSEL) or vertical-cavity semiconductor optical amplifier or vertical external-cavity surface-emitting laser, with or without phase change material or loss material or modulating element/device, based nonlinear optical resonator as a CW or spiking NOR.

FIGS. 5M-5N show a nonlinear relationship between an output optical intensity or phase shift and an input optical intensity for an example embodiment of a transmissive nonlinear optical resonator as a CW NOR, as illustrated in FIG. 5A.

FIG. 5O shows a leaky integrate-and-fire like nonlinear relationship (i.e. no spike/pulse output if input optical intensity is less than certain threshold, but spike/pulse output otherwise) between an output pulse optical intensity and an input pulse optical intensity for an example embodiment of a reflective VCSEL with saturable absorber as a spiking NOR, as illustrated in FIGS. 5F, 5G, 5J, and 5L.

FIGS. 6A-6L illustrate 12 example embodiments of an electrically and/or optically pumped transmissive or reflective resonant cavity light emitting diode based nonlinear optical resonator as a CW or spiking NOR.

FIGS. 7A-7F show 6 example embodiments of a traveling wave cavity based on a nonlinear optical ring resonator as a CW or spiking NOR illustrated in FIGS. 1E and 1F.

FIGS. 8A-8R schematically illustrate 18 example embodiments of a spatial arrangement of a group of pixels 16 or pixels 16a/16b/16c/16d on 1D or 2D or 3D substrate 17.

FIGS. 9A-9E schematically illustrate 5 example embodiments of an anti-reflective design for transmissive NOR 21 or optical element or device (OED) 21 (e.g., modulator, PD), in which output light reflected from NOR or OED 21 is blocked or redirected from input light.

FIGS. 10A-10C schematically illustrate 3 example embodiments of an anti-reflective design for a reflective OED 31, in which output light reflected from the OED 31 is deflected or redirected to another direction that is different from input light.

FIGS. 11A-11N schematically illustrate 14 example embodiments of a spatial arrangement between 2D/3D transmissive NOR 41 and another OED.

FIGS. 12A-12D schematically illustrate 4 example embodiments of a spatial arrangement between a reflective OED 31 or 31a/31b and another OED.

FIGS. 13A-13D schematically illustrate 4 example embodiments of a spatial arrangement to split and combine a light beam passing through OED 41 and another OED.

FIGS. 14A-14C schematically illustrate 3 example embodiments of a spatial arrangement of an OED to combine multiple beams.

FIGS. 15A-15M schematically illustrate 13 example embodiments of a spatial arrangement of an OED to route one or more light beams from one or more 1D or 2D or 3D optical components to one or more 1D or 2D or 3D optical components.

FIGS. 16A-16G schematically illustrate 7 example embodiments of transmissive and/or reflective designs for optical sensing and computing (e.g., optical neural network, hybrid optical-electric neural network, optical matrix multiplication, optical convolution, optical computer, quantum computing, optical sensing, machine vision, imaging, AR, VR, hologram, spatial computing, optical communication, etc).

FIGS. 17A-17G schematically illustrate 7 example embodiments of symmetric or loop-like designs for optical sensing and computing.

FIGS. 18A-18C schematically illustrate 3 example embodiments of a design for optical sensing and computing.

FIGS. 19A-19H schematically illustrate 8 example embodiments of a parallel or tree or graph like design for single or multiple optical neural networks.

FIGS. 20A-20G schematically illustrate 7 example embodiments of topological layout or design (e.g., sequential, parallel, symmetric or loop-like, tree, cyclic, acyclic) for interactions or collaborations among >=1 optical neural networks.

FIGS. 21A-21V schematically illustrate 22 example embodiments of a spatial arrangement between a 1D transmissive NOR 89 and another OED.

FIGS. 22A-22U schematically illustrate 21 example embodiments of a spatial arrangement between a 0D transmissive or reflective NOR 94 and another OED.

FIG. 23 illustrates a flowchart of an example embodiment of operations/processes/steps to indirectly and inversely design optimal nonlinear optical material/element/device (e.g., 0D [i.e., single pixel] or 1D array or 2D array of nonlinear optical resonator as CW and/or spiking NORs) to meet inversely designed objectives (e.g., target or expected nonlinear output response curve shape, low output reflective light intensity for transmissive CW or spiking NOR, low electric current/voltage applied to NOR to generate nonlinear output response, small aperture size of NOR to generate nonlinear output response, polarization control for output transmissive light and/or output reflective light, single output pulse number for spiking NOR, etc) in order to be integrated as optical nonlinear activation functions or components in a nonlinear all optical machine learning system so that the integrated nonlinear all optical machine learning system can function properly to meet target objectives or criteria (e.g., high accuracy, good performance, low power consumption, low optical noise, etc) for target tasks or functions (e.g., classification, generative task, large language model, etc), when the integrated nonlinear all optical machine learning systems are used for optical sensing and computing.

FIG. 24 illustrates a flowchart of an example embodiment of operations/processes/steps to integrate linear and/or a nonlinear optical material/element/device (e.g., CW and/or spiking NORs, metamaterial) directly with a nonlinear all optical machine learning system and directly optimize linear and/or nonlinear material/element/device and/or the integrated nonlinear all optical machine learning system together to meet target objectives or criteria (e.g., high accuracy, good performance, low power consumption, low optical noise, etc) for target tasks or functions (e.g., classification, generative task, large language model, etc).

FIG. 25 illustrates a flowchart of an example embodiment of operations/processes/steps to transform and/or encode and/or augment input data before applying to one or more 2D layer/array of target optical components (e.g., input layer, modulation layer [e.g., phase and/or amplitude SLM, 3D printed], activation layer [e.g., nonlinear optical resonator-based continuous wave or spiking neurons], PD layer, either simulated or real one) of the integrated nonlinear all optical machine learning system, during the optimization of the integrated nonlinear all optical machine learning system.

FIG. 26A-C illustrate how an example embodiment of a CW or spiking NOR may be used as an optical activation function in a diffractive deep neural network (D2NN) for classification tasks, as an example embodiment for FIG. 23, FIG. 24 and FIG. 25.

### DETAILED DESCRIPTION OF EXAMPLE EMBODIMENTS

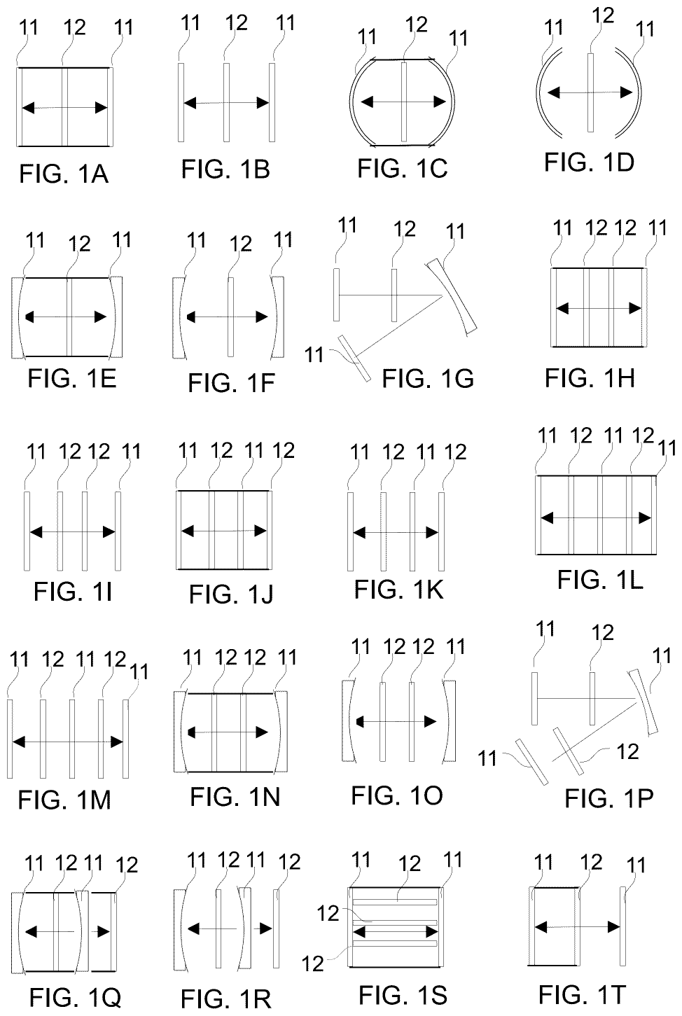

FIG. 1A to FIG. 1J20 schematically illustrate 63 example embodiments of nonlinear optical resonator (NOR) based CW or spiking neurons or elements/devices/modules (CW or spiking NORs) that are used as optical nonlinear activation function or module or device or element in different optical information processing devices, architectures, systems, platforms, frameworks and methods. As will be appreciated by those skilled in the art, the embodiments of CW or spiking NORs include but are not limited to the following components:
1) one or more optical resonant cavity, IBNLT, standing wave cavity in which light propagates back and forth and forms standing wave patterns between two or more materials or elements/devices/modules 11 (e.g., mirror, periodic structure [e.g., distributed Bragg reflector {DBR, e.g., AlGaAs/AlAs, AlGaInP/AlInP, AlGaAs/GaN, AlN/GaN, GaN, AlxGa1-xAs, (AlxGa1-x)0.5In0.5P/(AlyGa1-y)0.5In0.5P, TiO2, etc}, 1D/2D/3D grating, 1D/2D/3D photonic crystal] or aperiodically alternating structure of same or different type of materials [e.g., suitable reflective materials {e.g., metal, semiconductor, glass, ceramic}, dielectric materials, InGaAs/InAlAs, Ta2O5/SiO2, AlN/GaN, etc], metamaterial [e.g., metasurface, metaline]), traveling wave cavity in which light propagates in two opposite directions or goes around in a loop like fashion (IBNLT, ring cavity, whispering-gallery cavity, microdisk cavity, microtoroid cavity, microcapillary cavity, microsphere cavity, microbubble cavity, etc), photonic crystal cavity in which light is confined inside cavity or small area (e.g., defect, break) in the 1D/2D/3D periodic nanostructure/material/element (IBNLT, semiconductors [e.g., Silicon, Gallium Arsenide, Indium Phosphide], dielectrics [e.g., Silicon Nitride, SiO2], wide bandgap materials [e.g., hexagonal boron nitride, diamond], polymers, hybrid structures [e.g., combinations of various materials]), and through one or more materials or elements/devices inside photonic crystal cavity, plasmonic cavity in which light is confined and enhanced by excitation of surface plasmon polaritons (SPP) at metal-dielectric interfaces, hybrid cavity which combines two or more different physical systems, materials, or cavity designs to achieve enhanced or new functionalities (IBNLT, hybrid standing-wave and traveling-wave cavity, hybrid external cavity, ring-linear coupled cavity, whispering-gallery with partial back-reflection, hybrid photonic-plasmonic cavities, hybrid photonic crystal/bowtie plasmonic cavities, hybrid micro-ring resonator with quantum dots, nanocube-on-mirror antenna with a fabry-pérot microcavity, metasurface based hybrid cavities);
2) one or more materials or elements/devices/modules 12, IBNLT, gain medium (which is electrically pumped and/or optically-pumped and/or chemically-pumped) providing gain for light propagating inside the resonant cavity (e.g., crystals [e.g., yttrium aluminium garnet, yttrium orthovanadate, sapphire, caesium cadmium bromide] doped with rare-earth ions [e.g., neodymium, ytterbium, or erbium] or transition metal ions [e.g., titanium or chromium], glasses [e.g. silicate or phosphate glasses] doped with active ions, gases [e.g., helium and neon, nitrogen, argon, krypton, carbon monoxide, carbon dioxide, hydrogen fluoride or metal vapors], ceramics [e.g., metal oxide ceramics, non-oxide ceramics, composite ceramics, sesquioxide ceramics, and non-cubic doped fluorapatite ceramics], semiconductors [e.g., gallium arsenide or GaAs, aluminum gallium arsenide or AlGaAs, indium gallium arsenide or InGaAs, gallium nitride or GaN, indium gallium nitride or InGaN, indium gallium arsenide phosphide or InGaAsPh, gallium phosphide or GaP, aluminum indium gallium phosphide or AlInGaP], liquid dyes [e.g., coumarins, oxadiazoles, oligophenylenes, xanthenes merocyanines and cyanines], the rhodamines nuclear pumped media [e.g., uranium], and free electrons propagating through an undulator or wiggler, solid, plasma, nanoparticle, quantum dot, single quantum well or multiple quantum well (MQW) [e.g., InAs/GaAs MQW, InGaN MQW, InGaN/GaN MQW, GaInN/GaN MQW], quantum dash, quantum wire, phosphor, organic compound, perovskite, etc), loss material (which is either unpumped or electrically pumped and/or optically-pumped and/or chemically-pumped) exhibiting loss for light propagating inside the resonant cavity (e.g., semiconductor materials [e.g., InP, InGaAsP, GaAs, GaN, InGaAs, InAlAs, AlGaInP, etc], crystals [e.g., rare-earth doped crystals such as Cr:YAG, Cr⁴⁺:YAG, V³⁺:YAG, Fe²⁺:ZnSe, Cr²⁺:ZnS, Nd:Cr:YVO4], saturable absorber [e.g., quantum dot, quantum well, quantum dash, semiconductor such as Gallium Arsenide, semiconductor saturable absorber mirrors (SESAM), carbon nanotube, graphene, chromium, samarium or bismuth dopants, liquid organic dyes, doped crystals], reverse saturate absorber [e.g., semiconductor nanocrystal, quantum dot, C60], other suitable absorptive material, nanoparticle, metamaterial, lithium niobate, etc), phase change materials or elements/devices (PCM, e.g., Ge—Sb—Te [e.g., Ge₂Sb₂Te₅], Ge—Sb—Se—Te [e.g., Ge2Sb2Se4Te1]), active or passive material or elements/devices/modules modulating or manipulating or changing one or more properties (e.g., current, voltage, amplitude, phase, frequency, pulse shape/width/amplitude/phase/frequency/repetition rate) of electric signal and/or one or more properties (e.g., intensity, phase, frequency, polarization, orbital angular momentum [OAM], pulse shape/position/width/intensity/phase/frequency/repetition rate, geometry [e.g., direction, size, shape], focus, etc) of light propagating inside and/or outside of the resonant cavity (e.g., acousto-optical device/modulator, electro-optical device/modulator [e.g., Pockels cell, Kerr cell], electro-absorption device/modulator [e.g., semiconductor electroabsorption modulator, MQW modulator], Thermo-optic device/modulator, mechanical device/modulator, magneto-optic device/modulator, electronic device/modulator, electrochromic device/modulator, liquid crystal device/modulator, ring modulator, opto-electronic oscillator, Mach-Zehnder modulator, PCM modulator, Mach-Zehnder integrated-optic device/modulator, intensity and/or phase and/or polarization modulator, spatial light modulator [SLM], frequency modulator, frequency conversion device, optical switch, mechanic device [e.g., shutter, chopper wheel, or spinning mirror/prism], saturable absorber, reverse saturate absorber, artificial saturable absorbers [e.g., Kerr lensing with aperture, nonlinear mirror with a frequency-doubling crystal, nonlinear fiber, nonlinear polarization rotation device, nonlinear optical loop mirror, nonlinear amplifying loop mirrors, Mamyshev oscillator, array of waveguides exhibiting nonlinear coupling], hard or soft aperture, lens, kerr medium, mode locker, pulse picker, cavity dumper, output coupler, polarizing element, photodiode, piezo actuator, microelectromechanical systems [MEMS], nanoelectromechanical systems [NEMS], grating, dispersive mirror, etc);
3) optical materials/elements/devices 11 and materials/devices 12 may be separated by, IBNLT, free-space (e.g., vacuum, air, liquid), passive and/or active materials (e.g., glass, fiber, spacer, waveguide, semiconductor);
4) same or different type of optical materials/elements/devices 11 (e.g., DBR, DBR+photonic crystal, DBRs from different type of materials) may be used for same or different cavities (e.g., single/coupled/cascade/external cavity);
5) same or different type of materials/elements/devices 12 may be used (e.g., gain medium+loss material or PCM or modulating element/device, gain mediums from different types of materials, loss materials from different type of material, active loss material which is electrically and/or optically pumped+passive loss material which is unpumped, gain medium+optical modulation element/device [e.g., electro-optic modulator, acousto-optic modulator, Mach-Zehnder integrated-optic modulator, semiconductor electroabsorption modulator, artificial saturable absorber], gain medium+electric modulation device, gain medium+Kerr medium with/without aperture, gain medium optically pumped by pulse or continuous wave laser diode that is modulated for desired property, gain medium electrically pumped by current that is modulated by desired signal, gain medium+cavity dumper, gain medium+pulse picker, etc.);
6) certain components (e.g., gain medium, active loss material, PCM, modulation material or device or component) of CW or spiking NOR may be electrically pumped by electric current/voltage/signal with certain properties (e.g., bias voltage, voltage, bias current, current, amplitude, phase, frequency, pulse width/position/shape/duration/intensity/interval/repetition rate, quantization level, modulation, operation time) being dynamically modulated (e.g., analog modulation, digital modulation, amplitude modulation, phase modulation, frequency modulation, pulse width modulation, pulse-position modulation) or not (e.g., no change, constant over time, 0 current), and/or optically pumped by optical signal (IBNLT, CW and/or >=1 pulses, polarized and/or non-polarized, single frequency and/or multi-frequencies, coherent or incoherent, frequency detuned [frequency different from the resonant frequency of the cavity] and/or not, OAM and/or not, plane wave and/or non-plane wave, visible and/or invisible, patterned [e.g., 1D/2D/3D structure light, hologram, temporal and/or spatial pattern] and/or not) with certain properties (e.g., intensity, phase, polarization, frequencies, OAM, pulse width/position/duration/shape/number/intensity/interval/repetition rate, beam size/shape) being modulated or not;
7) in some embodiments, >=1 controller (e.g., automated control system, smart control systems, AI powered agents or systems, transistors, circuits, CPU, FPGA, GPU, ASIC) may be configured to manage operational states (IBNLT, sleep or standby mode [e.g., low-bias standby current/voltage, timed sleep], wake up, turn on, turn off, low power mode [e.g., low electric current/voltage], different nonlinear relationship between input and output light, different configuration, different modulation of electric current/voltage/signal, different polarization state, different geometry [e.g., shape, position, rotation, size, angle] or states for tunable components) for >=1 CW and/or spiking NORs on >=1 layers of >=1 devices by dynamically adjust relevant adjustable or tunable parameters or variables or components (e.g., certain properties of electric current/voltage/signal applied to relevant components of CW and/or spiking NORs, tunable or movable and/or rotatable and/or deformable parts or components [e.g., MEMS, NEMS, liquid crystal, PD, modulator, lens] of NORs) in real time according to >=1 temperature values (e.g., temperature detected by sensors, temperature estimated or approximated using relevant information [e.g., temperature of nearby NORs or components, certain relevant hardware and/or software activity signals], current or future temperature predicted for current load and task using >=1 statistical or machine learning models built from historical data) of >=1 NORs and/or >=1 layers and/or >=1 devices and/or environment, >=1 power consumption values (e.g., power consumption detected by sensors, power consumption estimated or approximated using relevant information [e.g., power consumption of nearby NORs or components, certain relevant hardware and/or software activity signals], current or future power consumption predicted for current load and task using >=1 statistical or machine learning models built from historical data) of >=1 NORs and/or >=1 layers and/or >=1 devices, locations or positions of >=1 NORs and/or >=1 layers and/or >=1 devices, >=1 time periods, >=1 types of information (e.g., environment information [e.g., temperature, location, position, speed, time], information from controllers, information from >=1 layers of >=1 devices, information received by >=1 NORs, information pre-process or post-processed by computing block/component of >=1 NORs, information on light transmitted to and reflected from >=1 objects or scenes, temporal information, spatial information, workload [eg., detected, estimate, predicted]), >=1 criteria (e.g., aggregation method for >=1 values [e.g, average/median for temperature values or power consumption values], event-based control and/or update [e.g., trigger action/process/state based on conditions], change-based control and/or update [e.g., only update >=1 NORs with to-be updated values different from current values], coded rolling shutter like row-by-row or block-by-block space and time control and/or update for >=1 NORs on >=1 layers of >=1 devices, pixel or row or layer or section or group wise control/update), >=1 objectives, >=1 tasks. In one embodiment, >=1 controllers may dynamically adjust the operational states (e.g, standby or sleep mode, low power mode, wake up, turn off, turn on) of >=1 CW and/or spiking NORs on >=1 layers of >=1 devices based on certain criteria (e.g., sleep mode or low power mode or turn off if aggregated temperature [e.g., averaged over detected and/or estimated and/or predicted over a certain time period C] inside/outside of >=1 NORs and/or >=1 layer of >=1 devices and/or >=1 devices and/or nearby environment is larger than a temperature threshold A for a certain time period A while wake up or turn on if aggregated temperature is less than a temperature threshold B for a certain time period B, standby mode or low power mode or turn off if aggregated power consumption [e.g., averaged over detected and/or estimated and/or predicted over a certain time period C] of >=1 NORs and/or >=1 layer of the device and/or the device is larger than a power consumption threshold A for a certain time period A while wake up or turn on if aggregated power consumption is less than a power consumption threshold B for a certain time period B, standby mode or low power mode or turn off for a certain time period A1 after certain time period A2 for an objective A or a task A while wakup or turn on for a certain time period B1 after a certain time period B2 for an objective B or a task B, standby mode or low power mode or turn off if current/future workload/activity of >=1 devices is less than a workload/activity threshold A for a certain time period A while wake up or turn on if current/future workload/activity is larger than a workload threshold B for a certain time period B). In another embodiment, >=1 controller may dynamically adjust operational states (e.g., different nonlinear relationship between input and output light, different configuration, different polarization state, different geometry) of >=1 CW and/or spiking NORs on >=1 layers of >=1 devices based on relevant information (e.g., different configurations of >=1 NORs on >=1 layers of >=1 devices based on information or criteria for different objectives or tasks, different polarization states of >=1 NORs on >=1 layers of >=1 devices based on information on input light or input data, different geometry or states for tunable component of >=1 NORs based on information received by NORs for different objectives or tasks). In another embodiment, >=1 controller may dynamically update the operational states (e.g., turn on, turn off, sleep mode, low power mode, wakeup, quantization level, different configuration, different modulation) of >=1 CW and/or spiking NORs on >=1 layers of >=1 devices in real time according to certain criteria (e.g., temporally and spatially update operation states of >=1 NORs based on certain events and/or tasks using coded rolling shutter like control, randomly turn on/off subset of >=1 NORs, changed-based update of >=1 NORs). In another embodiment, >=1 controllers may dynamically adjust operation states of >=1 CW and/or spiking NORs on >=1 layers of >=1 devices in real time to meet different objectives for different tasks (e.g., minimize power consumption for task A while maximize performance for task B, only turn on or wake up CW NORs or design A of CW NORs on section A of >=1 layers for a task A over a time period A while only turn on or wake up spiking NORs or design B of CW NORs on section B of >=1 layers for a task B over a time period B, only turn on or wake up CW and/or spiking NORs on section A of >=1 layers over a time period A while only turn on or wake up NORs on section B of >=1 layers over a time period B to reduce power consumption, only turn on or wake up type/design A pixel of the composite pixel or super pixel [e.g., composite pixel for CW NOR+spiking NOR, composite pixel for NOR+PD, composite pixel for NOR+modulator, composite pixel for design A and design B of CW NOR] for task A over a time period A while only turn on or wake up type/design B pixel of the composite pixel, switch the state or type of NORs to CW NORs for CW/spiking input light of a task A over a time period A while switch the state or type of NORs to spiking NORs for spiking input light of a task B over a time period B). In another embodiment, >=1 controllers may dynamically adjust operation states (e.g., sleep mode, low power mode, wake up, turn on, turn off, different types of nonlinear relationships between input light and output light) of >=1 CW and/or spiking NORs on >=1 layers of >=1 devices in real time to meet certain objectives (e.g., minimize overuse over a time period A, minimize power consumption over a time period A, target or expected nonlinear relationship between input light and output light for different tasks or objectives [e.g., use type A of CW NORs for task A or objective A while use type B of spiking NORs for task B or objective B], different types of nonlinear relationships between input light and output light for different CW or spiking NORs at different locations or positions [e.g., type A of CW or spiking NORs in layer 1 while type B in layer 2, type A of CW or spiking NORs for section A of of layer 1 while type B for section B of layer 1] and/or different times and/or for different objectives or tasks [e.g., turn on only subset A of CW or spiking NORs for task A or objective A during a time period A while turn on only subset B of CW or spiking NORs for task B or objective B during a time period B, use type A of CW NORs in odd number of activation layers and type B of spiking NORs in even number of activation layers for task A or objective A during a time period A while use type C of CW NORs in odd number of activation layers and type D of spiking NORs in even number of activation layers for task B or objective B during a time period B], different types of nonlinear relationships between input light and output light at different time for different objectives or tasks [e.g., type A of CW NORs for task A or objective A during a time period A, type B of spiking NORs for task B or objective B during a time period B], different modulations for different CW or spiking NORs at different times and/or different locations and/or for different objective or task [e.g., standby or sleep mode or turn off mode for section A of CW or spiking NORs in >=1 activation layers for a certain time period A and/or for a certain task A or objective A while wake up for a certain period time B and/or for a certain task B or objective B, use modulation A for section A of CW or spiking NORs in odd number of activation layers and modulation B for section B of CW or spiking NORs in even number layers during time period A for task A or objective A while use modulation C for section A of CW or spiking NORs in odd number of activation layers and modulation D for section B of CW or spiking NORs in even number layers during time period B for task B or objective B], different modulations for different objectives or tasks [e.g., electric current A or modulation A or quantization level A for type A of CW or spiking NORs for a task A or objective A while electric current B or modulation B or quantization level B for type B of CW or spiking NORs for task B or objective B], different power budgets at different time and/or for different objectives or tasks [e.g., type A of CW or spiking NORs with power consumption A during a time period A and/or for a task A or objective A while type B of CW or spiking NORs with power consumption B during a time period B and/or for a task B or objective B], different power budgets for different locations and/or different time and/or different objective or task based on different feedbacks [e.g., temperature that is detected and/or estimated and/or predicted inside and/or outside of >=1 CW or spiking NORs or >=1 layers or >=1 devices or nearby environment, detected and/or estimated and/or predicted power consumption for >=1 CW or spiking NORs or >=1 layers or >=1 devices] {e.g., standby mode or turn off >=1 CW or spiking NORs in section A of >=1 activation layers if inside and/or outside temperature averaged over relevant NORs in section A of >=1 activation layers is larger than certain temperature threshold A for certain time period A while wake up or turn on if inside and/or outside temperature averaged over relevant NORs in section A of >=1 activation layers is less than certain temperature threshold B for certain period B of time, use type A of CW or spiking NORs with power consumption A for >=1 activation layers if inside and/or outside temperature averaged over >=1 NORs in section A of >=1 activation layer is larger than certain temperature threshold A for certain time period A for task A or objective A while use type B of CW or spiking NORs with power consumption B for >=1 activation layers if inside and/or outside temperature averaged over >=1 NORs in section A of >=1 activation layer is less than certain temperature threshold B for certain time period B for task A/B or objective A/B, sleep mode or turn off >=1 CW or spiking NORs in section A of >=1 activation layers if estimated power consumption for relevant NORs in section A of >=1 activation layers is larger than certain power consumption threshold A for certain time period A while wake up or turn on if estimated power consumption for relevant NORs in section A of >=1 activation layers is less than certain power consumption threshold B for certain period B of time} etc).
8) in some embodiments, electric current applied to gain medium may be below lasing threshold current; in some embodiments, electric current applied to gain medium may be equal to or above lasing threshold current; in some embodiments, electric current/voltage applied to gain medium may be above or equal to or below certain threshold current at different time window; in some embodiments, electric current/voltage applied to gain medium may be modulated according to certain pattern and/or modulation technique (e.g., pulse width modulation, amplitude/phase modulation, analog/digital modulation);
9) in some embodiments, electric current/voltage applied to PCM or loss material or modulating element/device may be below or equal to certain threshold (e.g, 0); in another embodiment, electric current/voltage applied to PCM or loss material or modulating element/device may be above certain threshold; in another embodiment, electric current/voltage applied to PCM or loss material or modulating element/device may be above or equal to or below certain threshold at different time window; in yet another embodiment, electric current/voltage applied to PCM or loss material or modulating element/device may be modulated according to certain pattern and/or modulation technique (e.g., pulse width modulation, amplitude/phase/polarization modulation, analog/digital modulation);
10) a spiking NOR may emit light as one or more pulses or spikes if one or more criteria are met (but no output pulse or spike otherwise), IBNLT, spiking NOR is designed to generate pulses or spikes under certain conditions according to certain mechanisms (e.g., gain switch, Q switch, active/passive mode lock, cavity dump, self-phase modulation, group-velocity dispersion, saturable absorption, soliton-assisted time-lens compression, pulsed pumping electrically and/or optically, external pulse carving), intensity of >=1 input pulses is larger than certain threshold, interval of >=2 pulses (e.g., with intensity below threshold for each pulse) is less than certain threshold, pumping current and/or light is above certain threshold for certain duration, modulator (e.g., Q-switcher, pulse picker, cavity dumper) is switched to “on” or “off” state;
11) Polarization of CW or spiking NOR may be controlled by, IBNLT, grating (see for example, P. Debernardi et al, Controlling VCSEL polarization by monolithically integrated surface gratings: a survey of modelling and experimental activities, Proceedings of CAOL, 2005, 22), anisotropy (e.g., stress, cavity geometry, shape [e.g., rectangle, rhombus, ellipse] for aperture and/or active region and/or mesas, anisotropic current injection, confinement, see for example, K. Choquette et al, Control of vertical-cavity laser polarization with anisotropic transverse cavity geometries, IEEE Photonics Technology Letters, 1994, 6:40), liquid crystal, metasurface, optical injection (e.g., wavelength and/or polarization of input light), external polarization selection elements; in one embodiment, polarization of transmissive output light and/or reflective output light of transmissive CW or spiking NOR may be controlled; in another embodiment, polarization of reflective output light of reflective CW or spiking NOR may be controlled.

FIGS. 1A and 1B schematically illustrate 2 example embodiments of standing-wave cavity based nonlinear optical resonator as CW or spiking NOR in which light propagates back and forth and forms standing wave between two or more planar optical devices or elements 11, and through one or more materials or elements/devices 12 inside cavity. Example embodiments of FIGS. 1A and 1B may be, including but not limited to, edge-emitting laser (EEL), vertical cavity surface emitting laser (VCSEL), resonant cavity light-emitting diode (RCLED), gain switch laser with gain medium pumped electrically by modulated current and/or optically by CW or pulse input light, Q switch laser with both gain medium and active or passive modulator inside cavity, mode lock laser with gain medium and active modulator (e.g., electro-optic modulator, acousto-optic modulator, electroabsorption modulator, Mach-Zehnder integrated-optic modulator) and/or passive material/device (e.g., saturable absorber, artificial saturable absorber), mode lock laser with gain medium+Kerr medium+aperture inside cavity, laser with gain medium and saturable absorber inside cavity, etc.

FIGS. 1C-1G schematically illustrate 5 example embodiments of standing wave cavity based nonlinear optical resonator as CW or spiking NOR in which light propagates back and forth and forms standing wave between two or more planar and/or non-planar (e.g., curved, concave, convex) optical devices or elements 11, and through one or more materials or elements/devices 12 inside cavity.

FIGS. 1H-1I schematically illustrate 2 example embodiments of standing wave cavity based nonlinear optical resonator as a CW or spiking NOR in which light propagates back and forth between two or more planar optical material/devices/elements 11, and through two or more materials or elements/devices 12 inside cavity. Example embodiments of FIGS. 1H-1I may be, IBNLT, laser with gain medium and saturable absorber (SA) inside cavity (e.g, EEL-SA, VCSEL-SA), mode lock laser or Q switch laser with gain medium+active and/or passive modulator inside cavity, laser with gain medium and saturable absorber in cavity, etc.

FIGS. 1J-1K schematically illustrate 2 example embodiments of a standing wave cavity based nonlinear optical resonator as a CW or spiking NOR in which light propagates back and forth between two or more planar optical material/devices/elements 11, and through two or more materials or elements/devices 12, with one or more materials/device 12 outside cavity. Example embodiments of FIGS. 1J-1K may be, IBNLT, cavity dump laser with pulse picker or cavity dumper outside cavity.

FIGS. 1L-1M schematically illustrate 2 example embodiments of a standing wave cavity based nonlinear optical resonator as CW or spiking NOR in which light propagates back and forth between three or more planar optical material/devices/elements 11, and through two or more materials or elements/devices 12 inside cavity. Example embodiments of FIGS. 1L-1M may be, IBNLT, laser with gain medium and saturable absorber separated by mirror inside cavity.

FIGS. 1N-1P schematically illustrate 3 example embodiments of a standing wave cavity based nonlinear optical resonator as a CW or spiking NOR in which light propagates back and forth between two or more planar or non-planar (e.g., curved) optical material/devices/elements 11, and through two or more materials or elements/devices 12.

FIGS. 1Q-1R schematically illustrate 2 example embodiments of a standing wave cavity based nonlinear optical resonator as a CW or spiking NOR in which light propagates back and forth between two or more planar or non-planar (e.g., curved) optical material/devices/elements 11, and through two or more materials or elements/devices 12, with one or more materials/devices 12 outside cavity.

FIG. 1S schematically illustrates 1 example embodiment of a standing wave cavity based nonlinear optical resonator as CW or spiking NOR in which light propagates back and forth between two or more planar or non-planar (e.g., curved) optical material/devices/elements 11, and through two or more materials or elements/devices 12, with one or more materials/devices 12 sandwiched by two or more materials/devices 12 inside cavity. An example embodiment of FIG. 1S may be an edge-emitting laser (EEL) with a gain medium sandwiched by two saturable absorbers inside cavity.

FIGS. 1T-1X schematically illustrate 5 example embodiments of a standing wave cavity based nonlinear optical resonator as a CW or spiking NOR in which light propagates back and forth between two or more planar or non-planar (e.g., curved) optical material/devices/elements 11, and through one or more materials or elements/devices 12, with one or more material/devices/elements 11 and/or materials/devices 12 outside intra-cavity, creating an external cavity. Example embodiments of FIGS. 1T-1X may be, IBNLT, a vertical external cavity surface emitting laser (VECSEL) with saturable absorber (e.g., SESAM) and output coupler, VCSEL with external concave mirror, VCSEL with external saturable absorber, mode locked VCSEL with external saturable absorber.

FIGS. 1Y-1D1 schematically illustrate 6 example embodiments of a traveling wave cavity based nonlinear optical resonator as CW or spiking NOR in which light propagates in a loop among three or more planar and/or non-planar optical material/devices/elements 11, and through one or more materials or elements/devices 12 inside cavity.

FIGS. 1E1 and 1F1 schematically illustrate 2 example embodiments of a traveling wave cavity based nonlinear optical resonator as a CW or spiking NOR in which light propagates through optical material/devices/elements 1 (e.g., straight or curved optical fiber or waveguide), and goes around inside a ring-like optical material/devices/elements 11 (e.g., microring, fiber, waveguide), and through one or more materials or elements/devices 12. Example embodiments of FIGS. 1E1-1F1 may be, IBNLT, a ring laser with gain medium (e.g., erbium doped fiber) and/or saturable absorber (e.g., graphene) inside cavity, micro-Ring with phase change material (e.g., Ge₂Sb₂Te₅) inside cavity.

FIGS. 1G1 and 1H1 schematically illustrate 2 example embodiments of a traveling wave cavity based nonlinear optical resonator as a CW or spiking NOR in which light goes around a surface like optical material/devices/elements 11 (e.g., microdisk, microtoroid, microcapillary, microsphere, microbubble, whispering-gallery mode resonator), and through one or more materials or elements/devices 12 inside cavity.

FIGS. 1I1 to 1I9 schematically illustrate 9 example embodiments of a photonic crystal cavity based nonlinear optical resonator as a CW or spiking NOR in which light is confined inside a cavity or small area (e.g., defect, break) in the 1D/2D/3D periodic nanostructure/material/element 11 (IBNLT, semiconductors [e.g., Silicon, Gallium Arsenide, Indium Phosphide], dielectrics [e.g., Silicon Nitride, SiO2], wide bandgap materials [e.g., hexagonal boron nitride, diamond], polymers, hybrid structures [e.g., combinations of various materials]), and through one or more materials or elements/devices 12 inside photonic crystal cavity. As will be appreciated by those skilled in the art, in some embodiments, 1) nanostructure 11 in photonic crystal cavity may be in any shape, IBNLT, circle, eclipse, rectangle, square, triangle, hexagonal, bow-tie; 2) cavities may be designed and fabricated by, IBNLT, defects introduction (e.g., point defect [e.g., remove or alter single unit cell in photonic crystal lattice], line defect [e.g., remove a row of unit cells]), hole modification (e.g., shift or resize specific holes near cavity region, gradually taper hole size or spacing or position away from or towards cavity center), coupled cavity arrays, heterostructure cavities (e.g., gradually modify lattice constant along a line defect).

FIGS. 1I1 and 1I2 schematically illustrate a top view of 2 example embodiments of a 1D photonic crystal cavity based optical resonator as a CW or spiking NOR.

FIGS. 1I3 to 1I6 schematically illustrate a top view of 4 example embodiments of a 2D photonic crystal cavity based optical resonator as a CW or spiking NOR.

FIGS. 1I7 to 1I9 schematically illustrate a cross-section view of 3 example embodiments of a 3D photonic crystal cavity based optical resonator as a CW or spiking NOR (e.g., photonic crystal surface-emitting lasers [PCSEL], PCSEL with saturable absorber [PCSEL-SA]).

FIGS. 1J1 to 1J20 schematically illustrate 20 example embodiments of a plasmonic cavity based nonlinear optical resonator as a CW or spiking NOR (e.g., spaser or plasmonic laser, plasmonic VCSEL, plasmonic VCSOA, plasmonic VCSEL-SA, plasmonic VCSOA-SA) in which light is confined and enhanced by excitation of surface plasmon polaritons (SPP) at metal-dielectric interfaces. As will be appreciated by those skilled in the art, in some embodiments, 1) dielectric material/structure/element 11a may include, but is not limited to, air (e.g., air gaps as dielectric layer), semiconductor (e.g., silicon, GaAs), SiO2, Al2O3, Si3N4, TiO2, MgF2, polymers (e.g., polymethyl methacrylate, SU-8); 2) metallic nanostructure/material/element 11b may include, but is not limited to, nanoparticle, nanowire, bowtie antennas, channel waveguide, metal (e.g., silver, gold, aluminum); 3) one or more materials or elements/devices 12 may be used inside plasmonic cavity, IBNLT, active material, loss material, modulating devices, plasmonic component or crystal (e.g., quantum dot).

FIGS. 1J1 and 1J2 schematically illustrate 2 example embodiments of a trapped standing wave plasmonic cavity based optical resonator as a CW or spiking NOR, in which, SPPs are reflected from material/structure/element/device 11 IBNLT, mirror (e.g., graphene, metal), photonic crystal, defects, gratings, wedges.

FIGS. 1J3 and 1J4 schematically illustrate 2 example embodiments of a plasmonic cavity based optical resonator as a CW or spiking NOR, with one or more indented or collapse structure of any possible shape, IBNLT, rectangle, triangle, half-circle.

FIGS. 1J5 and 1J6 schematically illustrate 2 example embodiments of a dipole nanoantenna plasmonic cavity based optical resonator as a CW or spiking NOR. As will be appreciated by those skilled in the art, in some embodiments, 1) metallic nanostructure/material/element 11b may be sized and/or shaped (e.g., rod, bowtie, rectangle, circle, triangle) appropriately so that localized plasmon is resonant; 2) in this case, plasmonic cavity acts like a dipole emitter.

FIGS. 1J7 and 1J8 schematically illustrate 2 example embodiments of a gap plasmonic cavity based optical resonator as a CW or spiking NOR. As will be appreciated by those skilled in the art, in some embodiments, 1) light may be confined in the gap between two or more metallic nanostructure/material/element 11b of appropriate size and/or shape (e.g., rod, bowtie, rectangle, circle, triangle).

FIGS. 1J9 and 1J10 schematically illustrate 2 example embodiments of a plasmonic cavity based optical resonator as a CW or spiking NOR, in which, 1) one or more materials or elements/devices 12 may be on top of a dielectric-metal (D-M) structure or layer.

FIGS. 1J11 and 1J12 schematically illustrate 2 example embodiments of a plasmonic cavity based optical resonator as a CW or spiking NOR, in which, 1) one or more materials or elements/devices 12 may be inside a metal-dielectric (M-D) structure or layer.

FIGS. 1J13 and 1J14 schematically illustrate 2 example embodiments of a plasmonic cavity based optical resonator as a CW or spiking NOR, in which, 1) one or more materials or elements/devices 12 may be on top of a metal-dielectric (M-D) structure or layer.

FIG. 1J15 to 1J17 schematically illustrate 3 example embodiments of a plasmonic cavity based optical resonator as a CW or spiking NOR, in which, 1) one or more materials or elements/devices 12 may be sandwiched by two metal-dielectric (M-D) structures or layers.

FIG. 1J18 to 1J20 schematically illustrate 3 example embodiments of a plasmonic cavity based optical resonator as a CW or spiking NOR, in which, 1) one or more materials or elements/devices 12 may be sandwiched by two dielectric-metal (D-M) structures or layers.

As will be appreciated by those skilled in the art, in some embodiments, 1) in addition to the optical cavities illustrated in FIGS. 1A-1J20, any other possible optical cavity or resonator may be used as a nonlinear optical resonator for a CW or spiking NOR, IBNLT, waveguide resonator (e.g., fiber resonator, integrated optical cavity), micropillar resonator, fano resonator, metamaterial (e.g., metaline, metasurface) resonator, 2D material resonator, acoustic resonator, nano cavity (e.g., nanowire resonator), quantum cavity (e.g., quantum electrodynamics cavity), optomechanics cavity, hybrid resonator which is composed of >=2 same or different types of optical cavities.

The above-described embodiments are merely examples, and those skilled in the art will recognize that variations and modifications are possible without departing from the scope of the invention.

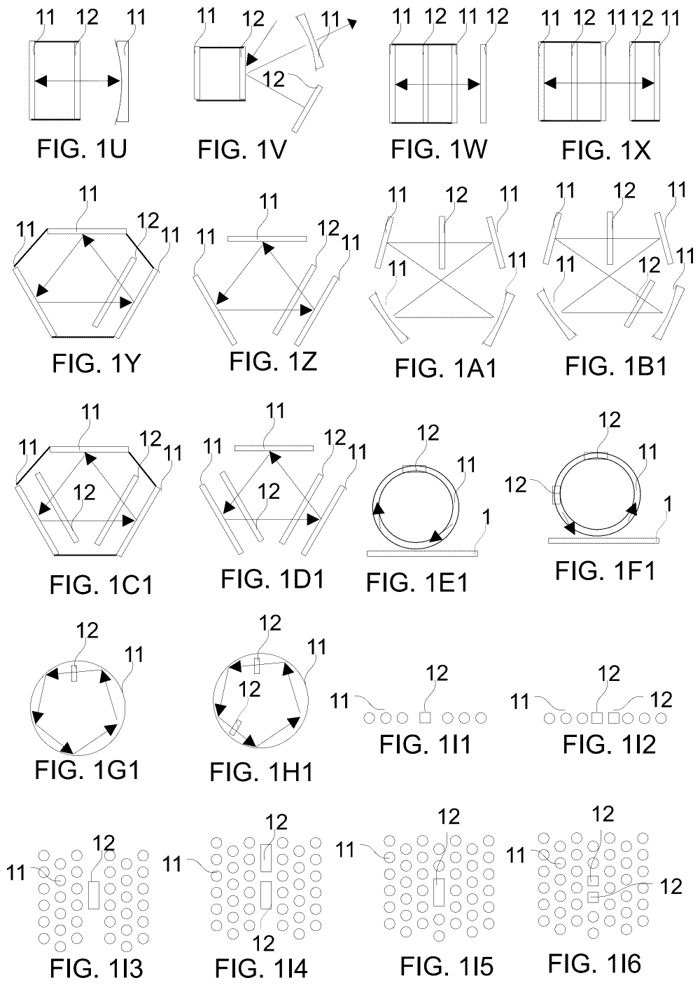

FIGS. 2A-2I schematically illustrate 9 example embodiments of a standing wave cavity based nonlinear optical resonator as a CW or spiking NOR according to one example embodiment illustrated in FIG. 1A, in which light propagates back and forth between two or more planar optical material/devices/elements 11 (e.g., mirror, periodic structure [e.g., DBR, 1D/2D/3D grating, 1D/2D/3D photonic crystal] or aperiodically alternating structure of same or different type of materials [e.g., suitable reflective materials, dielectric materials], metamaterial), and through one or more 12a (gain media) and/or 12b (loss material and/or PCM and/or modulating device/element). As will be appreciated by those skilled in the art, in some embodiments,
1) gain medium in FIGS. 2A-2F can be either electrically and/or optically pumped;
2) loss material and/or phase change material (PCM) and/or modulating device/element in FIGS. 2D-2I can be electrically and/or optically pumped/modulated, or unpumped/unmodulated;
3) in addition to the spatial arrangements illustrated in FIGS. 2A-2I, any other periodic or aperiodic spatial arrangements are also possible inside/outside >=1 cavity (e.g., cascaded/double/triple cavity), for example (M stands for mirror or DBR or photonic crystal, G for gain medium, L for loss material or modulating device/element), M-G-G-M, M-L-L-M, M-G-L-M, M-L-G-M, M-G-M-L, L-M-G-M, M-G-L-G-M, M-G-M-G-M, M-G-M-L-M, M-G-L-M-L, etc;
4) mirrors (e.g., DBR, 1D/2D/3D grating, 1D/2D/3D semiconductor photonic crystal) may be composed of periodic or aperiodically alternating structure/layer of same or different type of materials (e.g., suitable reflective materials, dielectric materials, metamaterial, etc);
5) a thickness of each layer of mirror may be same (e.g., a quarter of the resonant wavelength) or different (e.g., different thickness in each layer);
6) same or different type of materials/elements/devices may be used as gain medium (e.g., semiconductors, nanoparticle, quantum dot/well/dash/wire, etc), loss material (e.g., semiconductor materials, crystals, saturable absorber, reverse saturate absorber, other suitable absorptive material, nanoparticle, metamaterial, lithium niobate, etc), or modulating element/device, inside same or different resonant cavity;
7) one or more resonant cavity may be used (e.g., external cavity, composite cavity, cascaded cavities); and/or
8) gain medium and loss material or modulating device may be sandwiched inside same or different resonant cavity.

FIGS. 2A-2C illustrate 3 example embodiments of a standing wave cavity based nonlinear optical resonator as a CW or spiking NOR, in which gain medium is sandwiched inside a Fabry-Perot (FP) cavity or DBR cavity or photonic crystal cavity.

FIGS. 2D-2F illustrate 3 example embodiments of a standing wave cavity based nonlinear optical resonator as CW or spiking NOR, in which a gain medium and a PCM or loss material or modulating element/device are sandwiched inside a same FP cavity or DBR cavity or photonic crystal cavity. In some embodiments, the gain medium and loss material or modulating device may be sandwiched inside a different resonant cavity.

FIGS. 2G-2I illustrate 3 example embodiments of a standing wave cavity based nonlinear optical resonator as a CW or spiking NOR, in which a PCM or loss material or modulating element/device are sandwiched inside a same FP cavity or DBR cavity or photonic crystal cavity. In some embodiments, the gain medium and loss material or modulating device may be sandwiched inside different resonant cavity.

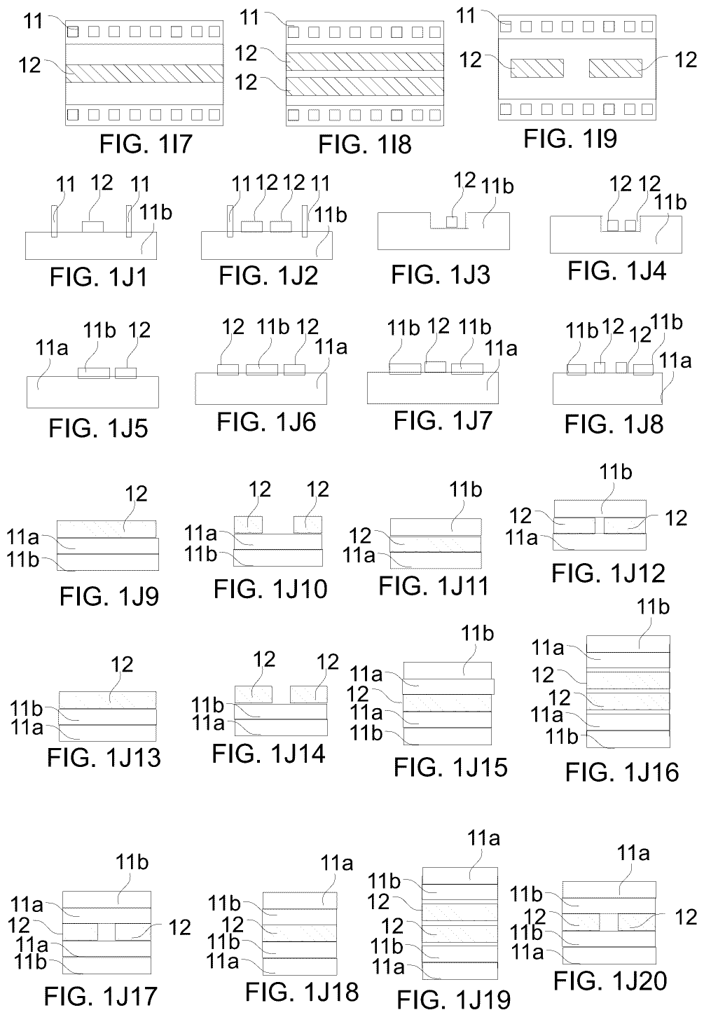

FIGS. 3A-3I schematically illustrate 9 example embodiments of an electrically and/or optically pumped vertical cavity based nonlinear optical resonator as a CW or spiking NOR, according to the embodiment illustrated in FIG. 2B or FIG. 2E or FIG. 2H, in which the optical cavity consists of two distributed Bragg reflectors (DBR), the gain medium is electrically pumped 2 and/or optically pumped 3, and the loss material or modulating element/device is either actively (electrically 2 and/or optically 3) pumped/modulated or unpumped/unmodulated (passive). As will be appreciated by those skilled in the art, in some embodiments:
1) the gain medium 12a in FIGS. 3A-3I can be pumped electrically 2 and/or optically 3;
2) the loss material and/or PCM and/or modulating device/element 12b in FIGS. 3B-3C and 3H-3I may be actively (electrically 2 and/or optically 3) pumped/modulated, or unpumped/unmodulated (e.g., passive);
3) the optical resonant cavity may include, but is not limited to, a Fabry-Perot (FP) cavity, DBR cavity, photonic crystal cavity, etc;
4) in addition to the spatial arrangements illustrated in FIGS. 3A-3I, any other periodic or aperiodic spatial arrangements are also possible and any composite cavity (e.g., cascaded cavities, external cavity) could also be used, for example (M stands for mirror or DBR or photonic crystal, G for gain medium, L for loss material or modulating element/device), M-G-G-M, M-L-L-M, M-G-L-M, M-L-G-M, M-G-M-L, L-M-G-M, M-G-L-G-M, M-G-M-G-M, M-G-M-L-M, M-G-L-M-L, etc;
5) same or different type of materials may be used as gain medium or loss material or modulating element/device inside/outside resonant cavity;
6) mirrors or reflectors (e.g., DBR, 1D/2D/3D grating, 1D/2D/3D semiconductor photonic crystal) may be composed of periodic or aperiodically alternating structure/layer of same or different type of materials (e.g., suitable reflective materials, dielectric materials, metamaterial, etc);
7) thickness of each layer of mirror may be same (e.g., a quarter of the resonant wavelength) or different (e.g., different thickness in each layer);
8) one or more resonant cavity may be used (e.g., external cavity, composite cavity, cascade cavity);
9) vertical-cavity semiconductor optical amplifier (VCSOA) or VCSEL or RCLED, with or without loss material (e.g., saturable absorber) or modulating element/device, may be used as example embodiments of nonlinear optical resonator for CW or spiking NOR; and/or
10) certain properties (e.g., intensity, phase, frequencies, polarization, pulse, OAM) of the optical signal/pump and/or certain properties (e.g., intensity, phase, frequency, pulse) of electrical current/voltage/pump may be either modulated according to certain pattern or not.

FIG. 3A illustrates one example embodiment of an electrically pumped 2 vertical cavity based nonlinear optical resonator as CW or spiking NOR, in which:
1) top/bottom DBRs 11 are constructed using alternating layers of high and low refractive index materials;
2) one or more optical gain medium 12a (e.g., multiple quantum wells, quantum dots, quantum dash made of semiconductor materials [e.g., InP, InGaAsP, GaAs, GaN, InGaAs, InAlAs, AlGaInP, etc]) are sandwiched between the top and bottom DBRs 11;
3) one side of the optical gain medium may be doped with n-type materials and the other side with p-type materials so that a p-i-n structure is formed for efficient injection of electrical current into the optical gain medium;
4) the electrical current may be injected from p-side to the n-side; in some embodiments, electric current applied to gain medium may be below lasing threshold current (in another word, the optical gain provided by electrically pumped gain medium is less than the sum of all the losses experienced by light in one round trip of the optical cavity which includes mirror losses, internal losses [e.g., absorption and scattering in the gain medium, waveguide, or other cavity components], diffraction loss, other relevant loss, etc.); in some embodiments, electric current applied to gain medium may be equal to or above lasing threshold current; in some embodiments, electric current may be above or below certain threshold current at different time window; and/or
5) certain properties (e.g., intensity, phase, pulse) of electrical current/voltage may be either modulated according to certain pattern (e.g., gain-switch laser) or not.

FIGS. 3B-3C illustrate 2 example embodiments of an electrically pumped 2 vertical cavity based nonlinear optical resonator as CW or spiking NOR, in which:
1) top/bottom DBRs 11 are constructed using alternating layers of high and low refractive index materials;
2) one or more optical gain medium 12a and loss material and/or PCM and/or modulating device/element 12b are sandwiched between the top and bottom DBRs 11;
3) one side of the optical gain medium 12a may be doped with n-type materials and the other side with p-type materials so that a p-i-n structure is formed for efficient injection of electrical current;
4) the electrical current is injected into gain medium 12a from p-side to the n-side; in some embodiments, electric current applied to gain medium may be below lasing threshold current; in some embodiments, electric current applied to gain medium may be equal to or above lasing threshold current; in some embodiments, electric current may be above or below certain threshold current at different time window;
5) electrical current or voltage may be either applied to loss material and/or PCM and/or modulating device/element 12b (e.g., Q-switch, mode-lock) or not (e.g., passive loss material or modulating element/device);
6) certain properties (e.g., intensity, phase, pulse, frequency) of electrical current/voltage may be either modulated according to certain pattern or not (e.g., constant, zero);
7) in some embodiments, gain medium 12a and loss material and/or PCM and/or modulating device/element 12b may be in different cavity (e.g., composite cavity, external cavity);
8) electric current may be injected from same or different side; and/or
9) in some embodiments, loss material and/or PCM and/or modulating device/element 12b may be reverse-biased; in some embodiments, 12b may be forward-biased.

FIG. 3D illustrates 1 example embodiment of an optically pumped 3 vertical cavity based nonlinear optical resonator as CW or spiking NOR, in which:
1) the materials on both sides of the optical gain medium 12a are undoped, and no electrical current is injected into the optical resonator;
2) instead, the optical gain medium is pumped optically 3 by light with suitable properties (e.g., intensity, wavelengths, polarization, beam size, etc);
3) certain properties (e.g., intensity, phase, wavelengths, polarization, pulse, OAM, beam shape/size) of the optical pump 3 may be either modulated according to certain pattern or not; and/or
4) optical pump may be CW or >=1 pulse.

FIGS. 3E-3I illustrates 5 example embodiments of an electrically pumped 2 and optically pumped 3 vertical cavity based nonlinear optical resonator as a CW or spiking NOR, in which:
1) top/bottom DBRs 11 are constructed using alternating layers of high and low refractive index materials;
2) one or more optical gain medium 12a and/or loss material and/or PCM and/or modulating device/element 12b are sandwiched between the top and bottom DBRs 11;
3) one side of the optical gain medium 12a may be doped with n-type materials and the other side with p-type materials so that a p-i-n structure is formed for efficient injection of electrical current into the optical gain medium;
4) optical gain medium 12a may be pumped optically 3 by light with proper properties (e.g, intensity, wavelengths, polarization, beam size, OAM, etc), and pumped electrically 2 by the electrical current injected from p-side to the n-side with its suitable magnitude;
5) electrical current or voltage may be either applied to loss material and/or PCM and/or modulating device/element 12b or not;
6) certain properties (e.g., intensity, phase, frequencies, polarization, pulse, beam size, OAM) of the optical pump 3 and/or certain properties (e.g., intensity, phase, frequency, pulse) of electrical current may be either modulated according to certain pattern or not;
7) optical pump 3 may be either CW and/or pulse;
8) gain medium 12a and loss material and/or PCM and/or modulating device/element 12b may be in same cavity or different cavity (e.g., composite cavity, cascade cavity, external cavity);
9) electric current may be injected from same or different side; and/or
10) in some embodiments, loss material and/or PCM and/or modulating device/element 12b may be reverse-biased; in some embodiments, 12b may be forward-biased.

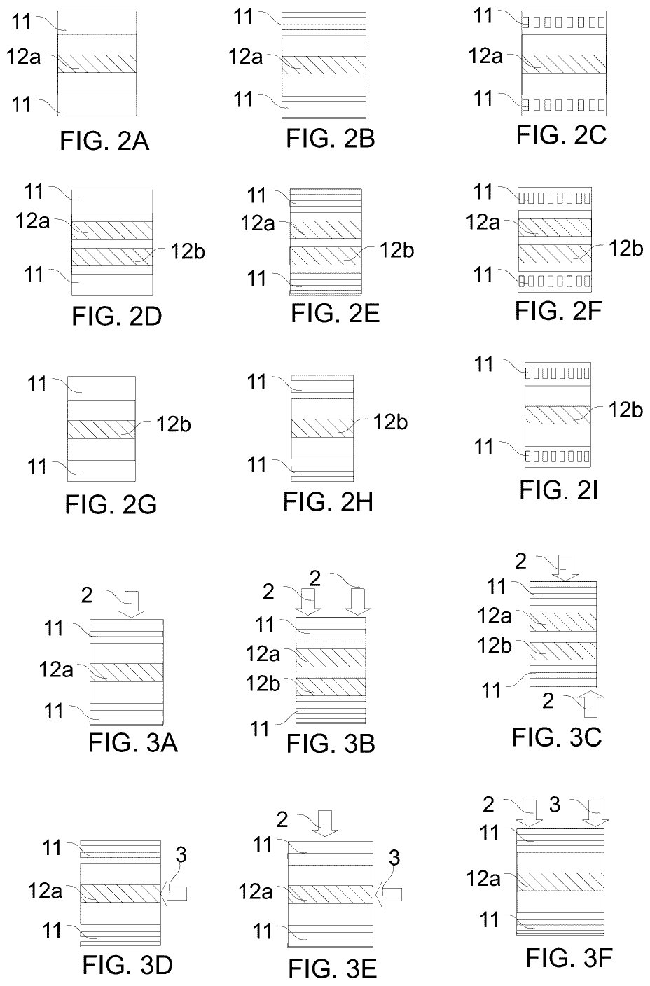

FIGS. 4A-4P schematically illustrate 16 example embodiments of an electrically pumped 2 and/or optically pumped edge-emitting transmissive or reflective nonlinear optical resonator as a CW or spiking NOR, in which 1) optical resonant cavity includes but is not limited to FP cavity, DBR cavity, photonic crystal cavity, which may be composed of or surrounded by optical material/element/mirror 11 (e.g., waveguide, cladding, cleave facet mirrors, DBR, photonic crystal) and non-transparent substrate 6; 2) gain medium 12a and/or loss material and/or PCM and/or modulating device/element 12b is sandwiched inside same or different optical resonant cavity; and/or 3) output light 5 emits along the horizontal edge.

As will be appreciated by those skilled in the art, in some embodiments:
1) gain medium 12a in FIGS. 4A-4P may be electrically and/or optically pumped;
2) loss material and/or PCM and/or modulating device/element 12b in FIGS. 4E-4P may be actively (e.g., electrically and/or optically) pumped/modulated or unpumped/unmodulated (e.g., passive);
3) in addition to the spatial arrangements illustrated in FIGS. 4A-4P, any other periodic or aperiodic spatial arrangements are also possible and any composite cavity or cascaded cavities could be used, for example (M stands for mirror or DBR or photonic crystal, G for gain medium, L for loss material or modulating element/device), M-G-G-M, M-L-L-M, M-G-L-M, M-L-G-M, M-G-M-L, L-M-G-M, M-G-L-G-M, M-G-M-G-M, M-G-M-L-M, M-G-L-M-L, etc;
4) same or different type of materials may be used as gain medium 12a and/or loss material and/or PCM and/or modulating device/element 12b inside same or different resonant cavity;
5) mirrors (e.g., DBR, 1D/2D/3D grating, 1D/2D/3D semiconductor photonic crystal) may be composed of periodic or aperiodically alternating structure/layer of same or different type of materials (e.g., suitable reflective materials, dielectric materials, etc), metamaterial;
6) thickness of each layer of mirror may be same (e.g., a quarter of the resonant wavelength) or different (e.g., different thickness in each layer);
7) one or more resonant cavity may be used (e.g., external cavity, composite cavity);
8) optical gain medium 12a may be pumped optically by light with proper properties (e.g, intensity, wavelengths, polarization, beam size, OAM, etc), and pumped electrically by the electrical current with its suitable magnitude;
9) electrical current or voltage may be either applied to loss material and/or PCM and/or modulating device/element 12b or not;
10) certain properties (e.g., intensity, phase, frequencies, polarization, pulse, beam size, OAM) of the optical pump and/or certain properties (e.g., intensity, phase, frequency, pulse) of electrical current may be either modulated according to certain pattern or not;
11) optical pump may be CW and/or >=1 pulse; optical input 4 and optical output 5 may be CW and/or >=1 pulses;
12) electric current may be injected from same or different side;
13) in some embodiments, loss material and/or PCM and/or modulating device/element 12b may be reverse-biased; in some embodiments, 12b may be forward-biased; and/or
14) in some embodiments, electric current applied to gain medium may be below lasing threshold current; in some embodiments, electric current applied to gain medium may be equal to or above lasing threshold current; in some embodiments, electric current may be above or below certain threshold current at different time window.

FIGS. 4A-4D illustrates 4 example embodiments of an electrically pumped edge-emitting transmissive and reflective nonlinear optical resonator as a CW or spiking NOR, in which 1) optical resonant cavity includes but is not limited to FP cavity, DBR cavity, photonic crystal cavity, which may be composed of or surrounded by optical element/mirror 11 (e.g., waveguide, cladding, cleave facet mirrors, DBR, photonic crystal) and non-transparent substrate 6; 2) gain medium 12a is pumped with an electrical current/voltage/signal which may be modulated according to certain pattern or not; and/or 3) passive loss material or modulating element/device is not electrically pumped or modulated.

FIGS. 4E-4H illustrate 4 example embodiments of an electrically and/or optically pumped edge-emitting transmissive and reflective nonlinear optical resonator as a CW or spiking NOR, in which 1) optical resonant cavity includes but is not limited to FP cavity, DBR cavity, photonic crystal cavity, which may be composed of or surrounded by optical element/mirror 11 (e.g., waveguide, cladding, cleave facet mirrors, DBR, photonic crystal) and non-transparent substrate 6; 2) gain medium 12a may be electrically pumped by an electrical current/voltage/signal with certain properties being modulated according to certain pattern or not (e.g., constant or 0 current), and/or optically pumped by input light 4 with certain properties being modulated or not; 3) output light 5 may be either transmissive or reflective; and/or 4) passive loss material and/or PCM and/or modulating device/element 12b is not electrically pumped but optically pumped.

FIGS. 4I-4L illustrate 4 example embodiments of an electrically and/or optically pumped edge-emitting transmissive and reflective nonlinear optical resonator as CW or spiking NOR, in which 1) optical resonant cavity includes but is not limited to FP cavity, DBR cavity, photonic crystal cavity, which may be composed of or surrounded by optical element/mirror 11 (e.g., waveguide, cladding, cleave facet mirrors, DBR, photonic crystal) and non-transparent substrate 6; 2) gain medium 12a is sandwiched between loss material and/or PCM and/or modulating device/element 12b; 3) gain medium 12a and loss material and/or PCM and/or modulating device/element 12b may be electrically pumped 2 by an electrical current/voltage/signal with certain properties being modulated or not, and/or optically pumped by input light 4 with certain properties being modulated or not; and/or 4) output light 5 may be either transmissive or reflective.

FIGS. 4M-4P illustrate 4 example embodiments of an electrically and/or optically pumped edge-emitting transmissive and reflective nonlinear optical resonator as a CW or spiking NOR, in which 1) optical resonant cavity includes but is not limited to FP cavity, DBR cavity, photonic crystal cavity, which may be composed of or surrounded by optical element/mirror 11 (e.g., waveguide, cladding, cleave facet mirrors, DBR, photonic crystal) and non-transparent substrate 6; 2) gain medium 12a may be electrically pumped 2 by an electrical current/voltage/signal with certain properties being modulated or not, and/or optically pumped by input light 4 with certain properties being modulated or not; 3) loss material and/or PCM and/or modulating device/element 12b may be electrically controlled by an electrical current/voltage/signal with certain properties being modulated or not, and/or optically pumped by input light 4 with certain properties being modulated or not; and/or 4) output light 5 may be either transmissive or reflective.

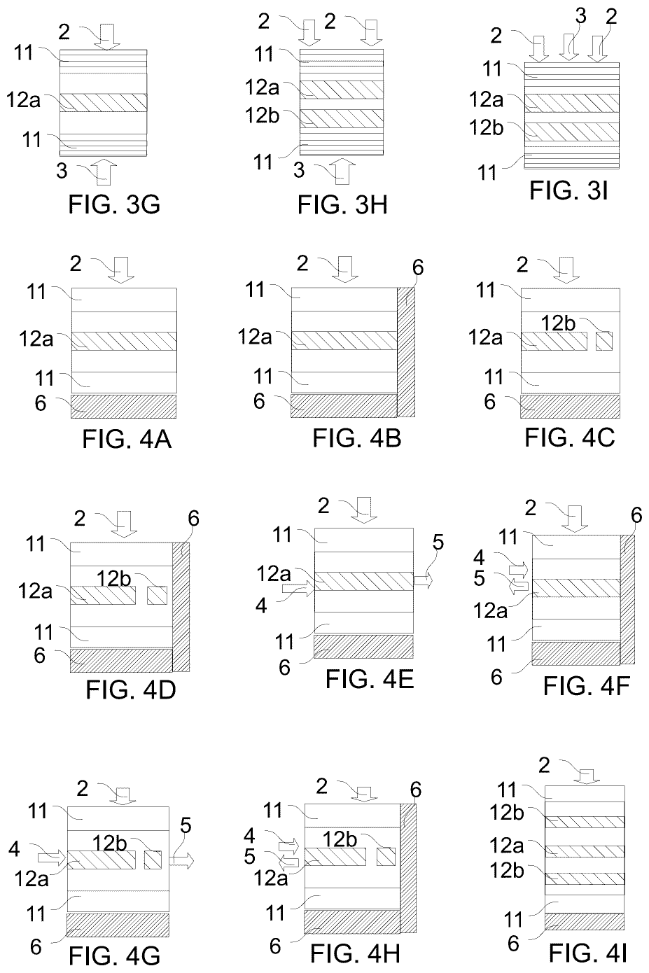

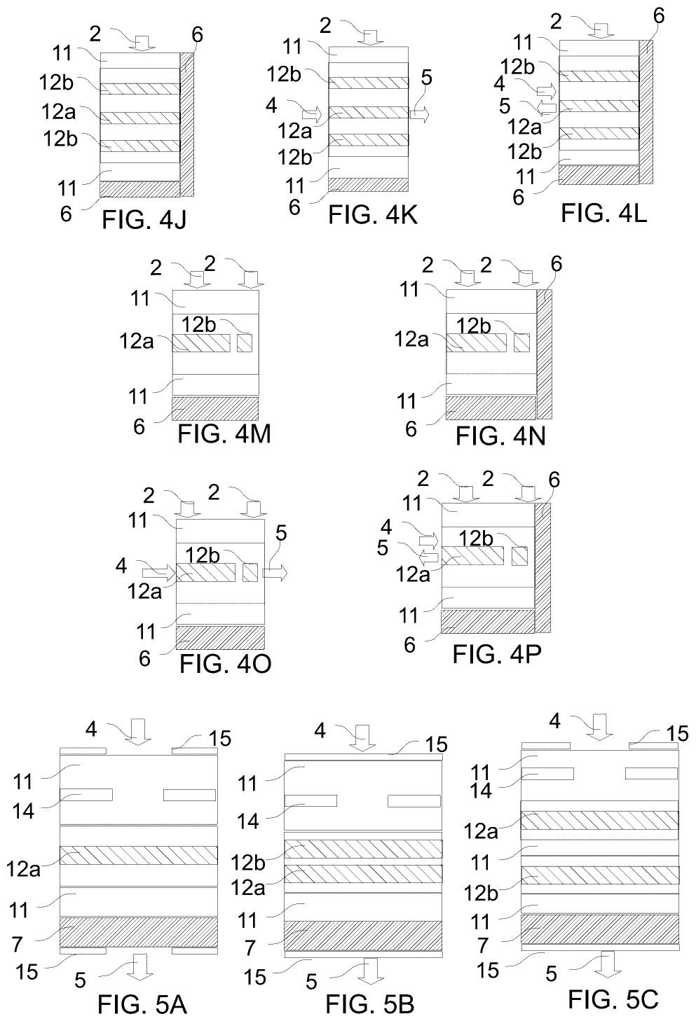

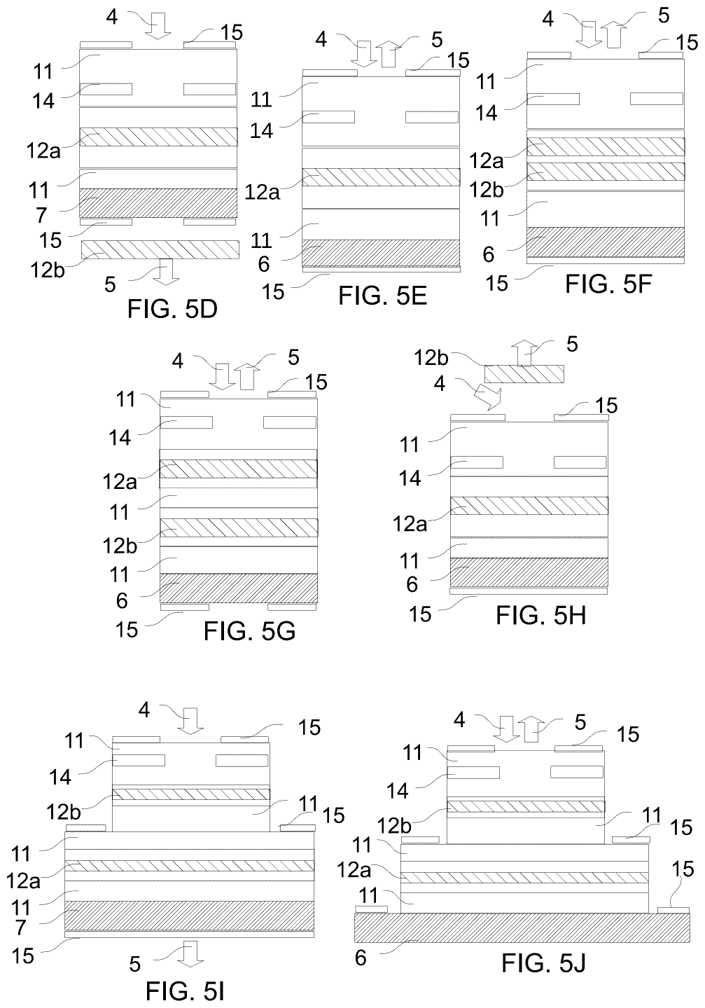

FIGS. 5A-5L illustrate 12 example embodiments of an electrically pumped transmissive or reflective VCSEL or VCSOA or VECSEL, with or without phase change material or loss material or modulating element/device, based nonlinear optical resonator as a CW or spiking NOR, in which 1) optical vertical cavity consists of two or more mirrors or reflectors (e.g., mirror, periodic structure [e.g., DBR, 1D/2D/3D grating, 1D/2D/3D photonic crystal] or aperiodically alternating structure of same or different type of materials [e.g., suitable reflective materials, dielectric materials, InGaAs/InAlAs, Ta2O5/SiO2, AlN/GaN, etc], metamaterial); 2) active gain material 12a (e.g., GaAsP, AlGaInP, InGaAs, InAlAs, InGaAsP, etc) and/or loss material and/or PCM and/or modulating device/element 12b (e.g., saturable absorber [e.g., single/multiple quantum well], reverse saturate absorber, kerr medium, modulator, etc), placed inside and/or outside vertical cavity, is electrically pumped by >=1 electrical current/voltage/signal with certain properties (e.g., intensity, phase, frequency, pulse duration/shape) being modulated according to certain pattern or not, and/or optically pumped by input light 4 with certain properties (e.g., intensity, polarization, phase, wavelengths, OAM, pulse duration/shape) being modulated or not; and/or 3) output light 5 is either transmissive for transmissive NOR or reflective for reflective NOR (reflective output light for transmissive NOR is not shown).

As will be appreciated by those skilled in the art, in some embodiments:
1) mirrors (e.g., DBR, 1D/2D/3D grating, 1D/2D/3D semiconductor photonic crystal) may be composed of periodic or aperiodically alternating structures/layers of same or different type of materials (e.g., suitable reflective materials [e.g., metal, semiconductor, glass, ceramic], dielectric materials, InGaAs/InAlAs, Ta2O5/SiO2, AlN/GaN, etc), metamaterial (e.g., metasurface, metaline);
2) thickness of each layer of mirror may be same (e.g., a quarter of the resonant wavelength) or different (e.g., different thickness in each layer);
3) material or element/device 12a or 12b in FIGS. 5A-5L inside or outside vertical cavity may be, IBNLT, gain medium 12a (e.g., crystals doped with rare-earth ions or transition metal ions, semiconductors, nanoparticle, quantum dot/well/dash/wire, etc), and/or loss material 12b (e.g., semiconductor materials, crystals, saturable absorber, reverse saturate absorber, other suitable absorptive material, nanoparticle, metamaterial, lithium niobate, etc), and/or modulating material/element/device 12b (e.g., modulator, MEMS, grating, kerr medium, PCM);
4) in addition to the spatial arrangements illustrated in FIGS. 5A-5L, any other periodic or aperiodic spatial arrangements are also possible and any possible cavity (e.g., single cavity, coupled cavity, composite cavity, cascaded cavities, external cavity) could be used, for example (M stands for mirror or DBR or photonic crystal, G for gain medium, L for loss material or modulating device/element), M-G-G-M, M-L-L-M, M-G-L-M, M-L-G-M, M-G-M-L, L-M-G-M, M-G-L-G-M, M-G-M-G-M, M-G-M-L-M, M-G-L-M-L, etc.;
5) periodic structure or aperiodically alternating structure of same or different type of materials (e.g., suitable reflective materials, dielectric materials, InGaAs/InAlAs, Ta2O5/SiO2, AlN/GaN, metamaterial) may be used for mirror or DBR or 1D/2D/3D grating or 1D/2D/3D photonic crystal;
6) semiconductor materials (e.g., InP, InGaAsP, GaAs, InGaAs, InAlAs, AlGaInP, etc) can be used as gain medium and/or loss material depending on the wavelength of operation;
7) contacts or electrodes 15 (e.g., transparent contact with/without aperture, non-transparent contact with/without aperture [e.g., ring shape], p-Contact or n-Contact) on the top and/or middle and/or bottom may be indium tin oxide (ITO) or any other suitable materials (e.g., ITO/Ag/ITO and ITO/Cu/ITO, graphene, etc);
8) input optical signal 4 may be, CW and/or >=1 pulse, polarized or non-polarized, single frequency or multi-frequencies, coherent or incoherent, frequency detuned or not, OAM or not, plane wave or non-plane wave, visible or invisible, patterned (e.g., 1D/2D/3D structure light, hologram, temporal and/or spatial pattern) or not, modulated according to certain pattern or not;
9) NOR may be injection locked or not;
10) tunable and/or movable element/device/material (e.g, MEMS, NEMS, metamaterial) may be integrated with NOR to make certain properties tunable (e.g., wavelength, position, geometry, shape, angle);
11) DBR may be n-DBR and/or p-DBR;
12) >=1 active region may be used in NOR, with each active region composed of >=1 material or element/device (e.g., gain medium, loss material, modulating element/device);
13) NOR may be confined by, IBNLT, current blocking layer, oxide layer, air-post, mesa-etched, ion/proton implanted, tunnel junctions (e.g., n⁺p⁺);
14) NOR may be die/wafer bonded or wafer fused or monolithic integrated;
15) >=1 cavity (e.g., composite/cascade/coupled cavity) may be used for NOR;
16) external cavities may be used with NOR;
17) Polarization of NOR may be controlled by, IBNLT, grating, anisotropy (e.g., stress, cavity geometry, shape [e.g., rectangle, rhombus, ellipse] for aperture and/or active region and/or mesas, anisotropic current injection, confinement), liquid crystal, metasurface, optical injection (e.g., wavelength and/or polarization of input light 4), external polarization selection elements; in one embodiment, polarization of transmissive output light and/or reflective output light of transmissive CW or spiking NOR may be controlled; in another embodiment, polarization of reflective output light of reflective CW or spiking NOR may be controlled;
18) nanoparticle (e.g., semiconductor nanoparticle, metal nanoparticle [e.g., Au], carbon-based nanoparticle, ceramic nanoparticle, photonic crystal, quantum dot, etc) may be used with NOR;
19) heat sink may be used with NOR;
20) apertures 14 and/or contact or electrode 15 and/or cavity may be in any 2D/3D shape/geometry (e.g., circle, ellipse, triangle, diamond, rhombus, square, rectangle, hexagonal, X/Y/C/Z shape, width, length, height or depth or thickness, etc);
21) for transmissive NOR, top and bottom apertures (e.g., for input and output light) may have same or different size and/or 2D/3D geometry (e.g., shape, width, length, height or depth or thickness) and/or integrated components (e.g., thin film, quantum dot, modulator, lens or lens array (e.g., fresnel, micro-lens, metalens, liquid lens), diffractive optical elements, MEMS, sensor, metamaterial), for example, circular shape for top aperture and rectangle shape for bottom aperture, integrating grating/MEMS only with bottom aperture, integrating lens only with top aperture, integrating PD with top and bottom aperture;
22) NOR may be integrated with various components, IBNLT, thin film (e.g., AlGaInP/GaInP), quantum dot/well/dash, loss material (e.g., saturable absorber), modulating element/device (e.g., electro-optic modulator, acousto-optic modulator, plasmonic modulator, electroabsorption modulator, interferometric modulator, micromechanical modulator [e.g., nanofabricated deformable or movable mirror], metamaterial/metasurface modulator, SLM, magneto-optic modulator, MQW modulator, liquid crystal modulator, Lithium Niobate modulator, VCSEL modulator, graphene modulator, passive modulator [e.g., 3D printed, metasurface, metaline], microRing modulator, waveguide modulator, MZI modulator, phase and/or amplitude and/or polarization modulator, or a combination of amplitude and/or phase and/or polarization modulators), sensor (e.g., photodiode or photodetector [PD, e.g., CMOS PD, CCD, Avalanche PD, InGaAs PIN PD, Graphene PD, metasurface PD, Single-photon avalanche diode, MQW PD, Quantum dot PD, angle-sensitive PD]), lens or lens array, diffractive optical elements (e.g., 1D/2D/3D grating, diffractive diffuser, diffractive lens), MEMS (consisting of one or more of these structures: mechanical microstructures, microsensors, micro-actuators and micro-electronics), metamaterial (e.g., metasurface, metaline, metalens);
23) electric current/voltage/signal may be applied to gain medium 12a with certain properties being modulated or not; in some embodiments, electric current applied to gain medium may be below lasing threshold current; in some embodiments, electric current applied to gain medium may be equal to or above lasing threshold current; in some embodiments, electric current may be above or below certain threshold current at different time window;
24) electric current/voltage/signal may be either actively applied to loss material and/or PCM and/or modulating device/element 12b with certain properties being modulated (according to certain pattern or criteria) or not (e.g., constant or 0 current), or not applied (e.g., passive); in some embodiments, reverse bias current may be applied to loss material and/or PCM and/or modulating device/element 12b;
25) well-known semiconductor fabrication process can be used to produce the VCSEL or VCSOAs based NOR and the process flow includes but is not limited to, epitaxial growth (e.g., use techniques like metal-organic chemical vapor deposition [MOCVD] or Molecular Beam Epitaxy [MBE] to grow multiple layers of III-V semiconductor materials, typically on a gallium arsenide substrate, to create basic layered structure of the VCSEL, e.g., active region, loss material and DBRs), lithography and patterning (e.g., photoresist is applied and patterned using techniques like deep ultraviolet lithography to define the device structures), mesa etching (e.g., mesa structure is formed through etching processes, which can be done using wet chemical etching or dry etching techniques like Inductively Coupled Plasma), oxidation or ion implant (e.g., to create current confinement apertures), passivation and insulation (e.g., mesa structures are passivated and insulated, often using atomic layer deposition [ALD] techniques for conformal coverage), metallization (e.g, electrical contacts are applied to the top and bottom of the device, which may involve thinning or removing the substrate before applying the bottom contact), dicing (e.g., wafer is diced to separate individual VCSEL devices or arrays), packaging (e.g., individual chips are mounted on submounts or other external mounts, and electrical connections are made through surface or wire bonding or flip-bonding);
26) NOR may emit light as CW or >=1 pulses or spikes if one or more criteria are met, IBNLT, no pulse or spike if input light intensity (either intensity of single pulse or spike or CW light or intensity accumulated from >1 pulse or spike in given time window) is less than certain threshold, >=1 pulse or spike if input light intensity (either intensity of single pulse or spike or CW light or intensity accumulated from >1 pulse or spike in given time window) is equal to or larger than certain threshold, no spike or pulse if NOR enter into refractory period, NOR is designed to generate pulses or spikes under certain conditions according to certain mechanisms (e.g., gain switch, Q switch, active/passive mode lock, cavity dump, self-phase modulation, group-velocity dispersion, saturable absorption, soliton-assisted time-lens compression, pulsed pumping electrically and/or optically, external pulse carving), intensity of >=1 input pulses is larger than certain threshold, interval of >=2 pulses (e.g., with intensity below threshold for each pulse) is less than certain threshold, pumping current and/or light is above certain threshold for certain duration, relevant modulator (e.g., Q-switcher, pulse picker, cavity dumper) is switched to “on” or “off” state;
27) electric current/voltage/signal applied to gain medium 12a may be modulated according to certain pattern and/or modulation technique (e.g., pulse width modulation, amplitude/phase modulation, analog/digital modulation); and/or
28) electric current/voltage applied to loss material and/or PCM and/or modulating device/element 12b may be below or equal to certain threshold (e.g, 0); in another embodiment, electric current/voltage applied to loss material or modulating element/device may be above certain threshold; in yet another embodiment, electric current/voltage applied to 12b may be modulated according to certain pattern and/or modulation technique (e.g., pulse width modulation, amplitude/phase/polarization modulation, analog/digital modulation).

FIGS. 5A-5C illustrates 3 example embodiments of electrically and/or optically pumped transmissive VCSEL or VCSOA based nonlinear optical resonator as CW or spiking NOR. As will be appreciated by those skilled in the art, in some embodiments:
1) gain medium 12a (e.g., quantum wells [e.g., InAs/GaAs MQW, InGaN MQW, InGaN/GaN MQW, GaInN/GaN MQW], quantum dashs, quantum dots, simply bulk semiconductor materials [e.g., GaAs, InGaAs, AlGaAs, InGaAlAs, InGaAsP], etc) and/or loss material and/or PCM and/or modulating device/element 12b (e.g., saturable absorber, modulator, metamaterial) may be sandwiched between >=2 mirrors 11 (e.g., DBR, 1D/2D/3D grating, 1D/2D/3D photonic crystal, metamaterial) that are composed of periodic or aperiodically alternating structure/layer (with same or different thickness in each layer) of same or different type of materials;
2) electric current/voltage/signal may be applied to gain medium 12a with certain properties being modulated or not; in some embodiments, electric current applied to gain medium may be below lasing threshold current; in some embodiments, electric current applied to gain medium may be equal to or above lasing threshold current; in some embodiments, electric current may be above or below certain threshold current at different time window;
3) electric current/voltage/signal may be either actively applied to loss material and/or PCM and/or modulating device/element 12b with certain properties being modulated (according to certain pattern or criteria) or not (e.g., constant or 0 current), or not applied (e.g., passive); in some embodiments, reverse bias current may be applied to 12b;
4) input optical signal 4 may be on the top and output from the bottom, or vise versa;
5) input light 4 may be modulated or not;
6) substrate 7 is transparent; and/or
7) gain medium 12a and loss material and/or PCM and/or modulating device/element 12b may be inside same or different cavity.

FIG. 5D illustrates an example embodiment of electrically and/or optically pumped transmissive VECSEL based nonlinear optical resonator as CW or spiking NOR. As will be appreciated by those skilled in the art, in some embodiments, 1) gain medium 12a may be sandwiched inside intra-cavity between >=two mirrors 11, and loss material and/or PCM and/or modulating device/element 12b is outside intra-cavity but inside external cavity; 2) electric current/voltage/signal may be applied to gain medium 12a with certain properties being modulated or not; 3) electric current/voltage/signal may be either actively applied to 12b with certain properties being modulated or not (e.g., constant or 0 current), or unmodulated (e.g., passive); 4) input light may be modulated or not; and/or 5) substrate 7 is transparent.

FIGS. 5E-5H illustrate 4 example embodiments of electrically and/or optically pumped reflective VCSEL or VECSEL based nonlinear optical resonator as CW or spiking NOR. As will be appreciated by those skilled in the art, in some embodiments:
1) mirrors 11 include but not limited to, periodic structure (e.g., DBR, 1D/2D/3D grating, 1D/2D/3D photonic crystal) or aperiodically alternating structure of same or different type of materials (e.g., suitable reflective materials, dielectric materials, metamaterial, etc);
2) material or element/device inside vertical cavity may be gain medium 12a and/or loss material and/or PCM and/or modulating device/element 12b;
3) semiconductor materials such as InGaAs and InGaAsP can be used depending on the wavelength of operation;
4) contact 15 (transparent or non-transparent) on the top or bottom can be ITO or any other suitable materials; in some embodiment, electrical contacts 15 may be made with metal (e.g. Ti/Pt/Au);
5) light is reflected from non-transparent substrate 6 and/or non-transparent contact 15;
6) both the optical input 4 and optical output signal 5 are on the same side of the contact 15;
7) electric current/voltage/signal may be applied to gain medium 12a with certain properties being modulated or not;
8) electric current/voltage/signal may be actively applied to loss material and/or PCM and/or modulating device/element 12b with certain properties being modulated or not (e.g., constant or 0 current), or unmodulated (e.g., passive);
9) input light may be modulated or not; and/or
10) reflecting light may be emitted from either top or bottom of NOR, depending on arrangement of high reflectivity DBR and/or non-transparent substrate 6 and/or non-transparent contact 15.

FIGS. 5I-5L illustrate 4 example embodiments of an electrically and/or optically pumped transmissive or reflective VCSEL or VCSOA based nonlinear optical resonator as a CW or spiking NOR. As will be appreciated by those skilled in the art, in some embodiments:
1) mirrors 11 include but are not limited to, periodic structure (e.g., DBR, 1D/2D/3D grating, 1D/2D/3D photonic crystal) or aperiodically alternating structure of same or different type of materials (e.g., suitable reflective materials, dielectric materials, metamaterial);
2) gain medium 12a and loss material and/or PCM and/or modulating device/element 12b may be placed in same or different cavity which may be sandwiched between same or different type of mirrors 11;
3) the contact 15 (e.g., metal, ITO or other suitable materials) may be used on the top, middle, bottom for gain medium 12a and loss material and/or PCM and/or modulating device/element 12b;
4) electric current/voltage/signal may be actively applied to gain medium 12a with certain properties being modulated or not (e.g., constant or 0 current);
5) electric current/voltage/signal may be either actively applied to loss material and/or PCM and/or modulating device/element 12b with certain properties being modulated or not (e.g., constant or 0 current), or not applied; in some embodiments, reverse bias current may be applied to 12b;
6) substrate may be transparent 7 or non-transparent 6; and/or
7) reflecting light may be emitted from either top or bottom of NOR, depending on arrangement of high reflectivity DBR and/or non-transparent substrate 6 and/or non-transparent contact 15.

FIGS. 5M-5N show nonlinear relationships between the output optical intensity or phase shift and the input optical intensity for an example embodiment of a transmissive nonlinear optical resonator as a CW NOR, as illustrated in FIG. 5A. As will be appreciated by those skilled in the art, in some embodiments:
1) well-known rate equation model for semiconductor laser amplifier (e.g., M. J. Adams et al, Analysis of semiconductor laser optical amplifiers, IEE Proc. J.-Optoelectronics, 1985, 132:58-63; S. Xiang et al, Numerical Implementation of Wavelength-Dependent Photonic Spike Timing Dependent Plasticity Based on VCSOA, IEEE Journal of Quantum Electronics, 2018, 54:1-7) may be used to simulate VCSEL or VCSOA device and may be solved by a standard ordinary differential equation solver (e.g., RK45 for Runge-Kutta method of order 5[4]), in which quantum well (0.8416 μm cavity length, group refractive index 3.0143, 5.5 mA electrical current) is sandwiched between 31 top DBRs (refractive index 3.2343 and 2.8081 for each pair of DBRs, quarter wavelength thickness) and 28 bottom DBRs (refractive index 2.6334 and 3.3079 for each pair of DBRs, quarter wavelength thickness), with 7 μm aperture diameter and 50 pm frequency detune (i.e, 845.630 nm input wavelength for 845.580 nm resonant wavelength); and/or
2) solid curves show normalized transmissive output optical intensity (FIG. 5M) and phase shift (FIG. 5N) versus normalized input optical intensity, while dashed curves show normalized reflective output optical intensity (FIG. 5M) versus normalized input optical intensity.

FIG. 5O shows a leaky integrate-and-fire (LIF) like nonlinear relationship (i.e. no spike/pulse output if input optical intensity is less than certain threshold, but spike/pulse output otherwise) between the output pulse optical intensity and input pulse optical intensity for an example embodiment of reflective VCSEL with a saturable absorber (VCSEL-SA) as a spiking NOR, as illustrated in FIGS. 5F, 5G, 5J, and 5L. As will be appreciated by those skilled in the art, in some embodiments:
1) well-known two-section rate equations model (e.g., M. A. Nahmias et al, A Leaky Integrate-and-Fire Laser Neuron for Ultrafast Cognitive Computing, IEEE JOURNAL OF SELECTED TOPICS IN QUANTUM ELECTRONICS, 2013, 19:1800212; F. Selmi et al, Relative Refractory Period in an Excitable Semiconductor Laser, Physical Review Letters, 2014, 112:183902; Q. Li et al, Simulating the spiking response of VCSEL-based optical spiking neuron, Optics Communications, 2018, 407:327-332) may be used to simulate VCSEL-SA device as a LIF spiking NOR, in which 0.033337 mA electrical current is applied to gain region (quantum well, cavity volume 3.62e-20 m³, refractive index 3.3, resonant wavelength 845.580 nm), with saturable absorber region (quantum well, cavity volume 3.16e-21 m³, refractive index 3.15, 0 electric current), 1 μm aperture diameter, 1000/150 ps carrier lifetime for gain/SA and 4.8 ps photon lifetime; and/or
2) solid curve in FIG. 5O shows reflective normalized output pulse optical intensity versus different levels of normalized optical intensity of input pulse (Gaussian-shape single pulse with 10 ps pulse width).

As will be appreciated by those skilled in the art, in some embodiments of FIGS. 5A-5O:
1) the corresponding transmissive and/or reflective nonlinear relationships of CW or spiking NOR and/or output CW or >=1 spike/pulse generated by CW or spiking NOR may be used for, IBNLT, nonlinear optical activation function for any optical sensing and computing (e.g., optical neural network, neuromorphic computing, hybrid optical-electric neural network, optical matrix multiplication, optical convolution), optical information processing, optical communication (e.g., beam steering, beam forming, encoding, decoding, transmission, communication, interconnect, switch, routing, freespace, on-chip, chip-to-chip), quantum computing, optical computer (e.g., optical transistor, optical switch, optical logic gate), optical amplifier or attenuator;
2) the corresponding nonlinear relationships may also be used, for example, to amplify input optical signal to compensate the loss of previous layers (e.g., for multiplayer optical neural network), to reduce or attenuate input optical signal, to achieve desired input optical intensity, to transmit signal;
3) different nonlinear relationships can be achieved by changing the following design parameters for vertical-cavity based nonlinear optical resonator as CW or spiking NOR, IBNLT, spiking mechanism (e.g., gain-switch, Q-switch, mode-lock, cavity-dump, opto-electronic oscillator, four-wave mixing, self-phase modulation, group-velocity dispersion, saturable absorption, soliton-assisted time-lens compression, pulsed pumping electrically and/or optically, external pulse carving), number of top/middle/bottom mirrors or reflectors (e.g., mirror, periodic structure [e.g., DBR, 1D/2D/3D grating, 1D/2D/3D photonic crystal] or aperiodically alternating structure of same or different type of materials [e.g., suitable reflective materials, dielectric materials, metamaterials]), thickness and refractive index for each layer of top and/or middle and/or bottom mirrors or reflectors, cavity (e.g., size, length, shape, geometry, number, composite cavity, cascaded cavity), aperture (e.g., size, shape, geometry, number of aperture), electrical current/voltage/signal (modulated or not) applied to gain medium and/or loss material or modulating element/devices, modulating method/technique/device for electrical current/voltage/signal and/or optical signal, properties being modulated for electrical current/voltage/signal and/or optical signal, type and number of relevant components and/or material (e.g., mirrors, gain medium, loss material or modulating element/device, oxidization layer), periodic or aperiodic spatial arrangement of relevant components and/or material, 1D/2D/3D geometry (e.g., shape, size, thickness, length, distance) of relevant components and/or material (e.g., mirrors, gain medium, active/passive loss material or modulating element/device, cavity [e.g., single, composite, double, cascade, external], aperture, oxidization layer, etc), any other relevant tunable and/or optimizable component or parameters;
4) certain properties (e.g., intensity, phase, frequency, polarization, OAM, time when incoming light is received and/or outgoing light is generated, duration/shape/intensity/response time of input and/or output CW or pulse) of input and/or output optical signal for >=1 NORs may be monitored by certain mechanism, IBNLT, reverse-biased NOR as photodetector or photodiode (PD), integrated modulator as PD, >=1 PDs integrated with NOR for top incoming light and/or bottom outgoing light (e.g., external PD [e.g., PD surrounding NOR for surrounding incoming light, PD for portion of outgoing light by absorption or reflection], extra-cavity PD below bottom DBR and/or above top DBR, intra-cavity PD below top DBR and/or above bottom DBR); and/or
5) the nonlinear relationship of the designed or manufactured NOR may be dynamically tuned or modified by changing tunable variable or parameters or properties or integrated parts/components, IBNLT, certain properties of input optical signal (e.g., wavelength different from the resonant wavelength [i.e. frequency detune], multiple wavelengths, polarization [e.g., parallel, vertical, circular, non-polarized, mixed polarization], duration/shape/intensity of the input pulse, OAM), certain properties (e.g., intensity, phase, frequency, polarization, OAM, time when incoming light is received and/or outgoing light is generated, duration/shape/intensity/response time of input and/or output CW or pulse) of input and/or output optical signal for >=1 NORs (e.g., same NOR, neighboring NORs) that is monitored by certain mechanism (e.g., PD integrated with NOR, neighboring >=1 PD or NOR, reverse-biased NOR as PD, integrated modulator as PD), certain properties (e.g., amplitude, phase, frequency, pulse width/position/shape/duration/repetition rate) of electrical current/voltage/signal applied to gain medium and/or loss material or modulating element/device, MEMS, lens (e.g., movable lens, liquid lens, tunable metalens), tunable metamaterial (e.g., tunable metasurface), modulator (e.g., MQW modulator, liquid crystal modulator, Lithium Niobate modulator, microRing modulator, MZI modulator), 1D/2D/3D geometry (e.g., distance, shape, length, size, position, spatial arrangement) of >=1 relevant components/parts.

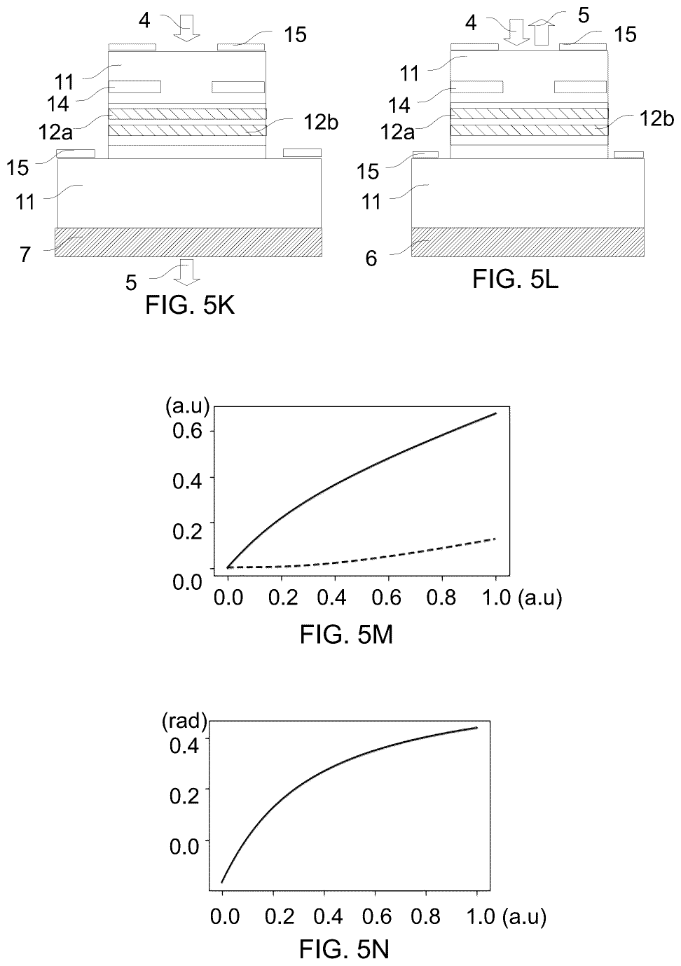

FIGS. 6A-6L illustrate 12 example embodiments of electrically and/or optically pumped transmissive or reflective resonant cavity light emitting diode (RCLED) based nonlinear optical resonator as CW or spiking NOR, in which:
1) optical vertical resonant cavity consists of two or more mirrors (e.g., DBR, 1D/2D/3D grating, 1D/2D/3D photonic crystal) that are composed of periodic or aperiodically alternating structure/layer (with same or different thickness in each layer) of same or different type of materials; and/or
2) gain medium 12a (e.g., active material of conventional light emitting diode [e.g., GaAs, GaAsP, GaN, AlGaN, AlGaInN, AlGaInP, phosphor, organic compound, perovskite, quantum dot, quantum well, quantum dash, 1D/2D/3D photonic crystal, etc]) and/or loss material and/or PCM and/or modulating device/element 12b (e.g., saturable absorber, reverse saturate absorber, kerr medium, modulator, etc), placed inside cavity and/or outside vertical cavity (e.g., DBRs, 1D/2D/3D grating, 1D/2D/3D photonic crystal, for higher output intensity, better directionality, improved spectral purity), is electrically pumped by >=1 electrical current/voltage/signal with certain properties (e.g., intensity, phase, frequency, pulse duration/shape) being modulated according to certain pattern or not, and/or optically pumped by input light 4 with certain properties (e.g., intensity, polarization, phase, wavelengths, OAM, pulse duration/shape) being modulated or not. Output light 5 is either transmissive for transmissive NOR or reflective for reflective NOR (reflective output light for transmissive NOR is not shown)

As will be appreciated by those skilled in the art, in some embodiments:
1) mirrors (e.g., DBR, 1D/2D/3D grating, 1D/2D/3D photonic crystal) may be composed of periodic or aperiodically alternating structure/layer (with same or different thickness in each layer) of same or different type of materials;
2) thickness of each layer of mirror may be same (e.g., a quarter of the resonant wavelength) or different (e.g., different thickness in each layer);
3) material or element/device 12a or 12b in FIGS. 6A-6L inside or outside vertical cavity may include, but is not limited to, gain medium 12a (e.g., phosphor, organic compound [e.g., Alq3, dopants that can emit light when excited], polymeric materials [e.g., conductive polymers such as PPV and polyfluorenes], ZnSe, CdSe, perovskite, graphene, carbon nanotubes, nanoparticle, quantum dot, quantum well or MQW, quantum dash, quantum wire, crystals doped with rare-earth ions or transition metal ions, glasses doped with active ions, ceramics, semiconductors, liquid dyes, the rhodamines nuclear pumped media, and free electrons propagating through an undulator or wiggler, solid, plasma, etc.), and/or PCM 12b, and/or loss material 12b (e.g., semiconductor materials, crystals, saturable absorber, reverse saturate absorber, other suitable absorptive material, nanoparticle, metamaterial, lithium niobate, etc.), and/or modulating element/device 12b (e.g., modulator, MEMS, grating, kerr medium);
4) in addition to the spatial arrangements illustrated in FIGS. 6A-6L, any other periodic or aperiodic spatial arrangements are also possible and any possible cavity (e.g., single cavity, coupled cavity, composite cavity, cascaded cavities, external cavity) could be used, for example (M stands for mirror or DBR or photonic crystal, G for gain medium, L for loss material or modulating device/element), M-G-G-M, M-L-L-M, M-G-L-M, M-L-G-M, M-G-M-L, L-M-G-M, M-G-L-G-M, M-G-M-G-M, M-G-M-L-M, M-G-L-M-L, etc.;
5) periodic structure or aperiodically alternating structure of same or different type of materials (e.g., suitable reflective materials, dielectric materials, InGaAs/InAlAs, Ta₂O₅/SiO2, AlN/GaN, metamaterial, etc) may be used for mirror or DBR or 1D/2D/3D grating or 1D/2D/3D photonic crystal;
6) suitable materials (e.g, semiconductor materials, organic compound, polymeric materials, ZnSe, CdSe, perovskite, graphene, carbon nanotubes) can be used as gain medium and/or loss material depending on the wavelength of operation; according to certain pattern or not;
9) NOR may be injection locked or not;
10) tunable or movable element/device/component (e.g, MEMS, metamaterial) may be integrated with NOR to make certain properties tunable (e.g., wavelength, position, geometry, shape, angle);
11) DBR may be n-DBR and/or p-DBR;
12) >=1 active region may be used in NOR, with each active region composed of >=1 material or element/device (e.g., gain medium, loss material, modulating element/device);
13) NOR may be confined by, IBNLT, current blocking layer, oxide layer, air-post, mesa-etched, ion/proton implanted, tunnel junctions (e.g., n⁺p⁺);
14) NOR may be die/chip/wafer bonded or wafer fused or monolithic integrated;
15) >=1 cavity (e.g., composite/cascade/coupled cavity) may be used for NOR;
16) external cavities may be used with NOR;
17) Polarization of NOR may be controlled by, IBNLT, grating, anisotropy (e.g., stress, cavity geometry, shape [e.g., rectangle, rhombus, ellipse] for aperture and/or active region and/or mesas, anisotropic current injection, confinement), liquid crystal, metasurface, optical injection (e.g., wavelength and/or polarization of input light), external polarization selection elements; in one embodiment, polarization of transmissive output light and/or reflective output light of transmissive CW or spiking NOR may be controlled; in another embodiment, polarization of reflective output light of reflective CW or spiking NOR may be controlled;
18) nanoparticle (e.g., semiconductor nanoparticle, metal nanoparticle [e.g., Au], carbon-based nanoparticle, ceramic nanoparticle, photonic crystal, quantum dot, etc) may be used with NOR;
19) heat sink may be used with NOR;
20) aperture 14 and/or contacts or electrodes 15 (transparent or non-transparent) and/or cavity may be in any 2D/3D shape/geometry (e.g., circle, ellipse, triangle, diamond, rhombus, square, rectangle, hexagonal, X/Y/C/Z shape, width, length, height or depth or thickness, etc);
21) for transmissive NOR, top and bottom apertures (e.g., for input and output light) may have same or different size and/or 2D/3D geometry (e.g., shape, width, length, height or depth or thickness) and/or integrated components (e.g., thin film, quantum dot, modulator, lens or lens array, diffractive optical elements, MEMS, sensor, metamaterial), for example, circular shape for top aperture and rectangle shape for bottom aperture, integrating grating/MEMS only with bottom aperture, integrating lens only with top aperture, integrating PD with top and bottom aperture;
22) NOR may be integrated with various components, IBNLT, thin film (e.g., AlGaInP/GaInP), quantum dot/well/dash, loss material (e.g., saturable absorber), modulating element/device (e.g., electro-optic modulator, acousto-optic modulator, plasmonic modulator, electroabsorption modulator, interferometric modulator, micromechanical modulator [e.g., nanofabricated deformable or movable mirror], metamaterial/metasurface modulator, SLM, magneto-optic modulator, MQW modulator, liquid crystal modulator, Lithium Niobate modulator, VCSEL modulator, graphene modulator, passive modulator [e.g., 3D printed, metasurface, metaline], microRing modulator, waveguide modulator, MZI modulator, phase and/or amplitude and/or polarization modulator, or a combination of amplitude and/or phase and/or polarization modulators), sensor (e.g., photodiode or photodetector [PD, e.g., CMOS PD, CCD, Avalanche PD, InGaAs PIN PD, Graphene PD, metasurface PD, Single-photon avalanche diode, MQW PD, Quantum dot PD, angle-sensitive PD]), lens or lens array (e.g., fresnel, micro-lens, metalens, liquid lens), diffractive optical elements (e.g., 1D/2D/3D grating, diffractive diffuser, diffractive lens), MEMS (consisting of one or more of these structures: mechanical microstructures, microsensors, micro-actuators and micro-electronics), metamaterial (e.g., metasurface, metaline, metalens);
23) electric current/voltage/signal may be applied to gain medium 12a with certain properties being modulated or not; in some embodiments, electric current applied to gain medium may be below lasing threshold current; in some embodiments, electric current applied to gain medium may be equal to or above lasing threshold current; in some embodiments, electric current may be above or below certain threshold current at different time window;
24) electric current/voltage/signal may be either actively applied to loss material and/or PCM and/or modulating device/element 12b with certain properties being modulated (according to certain pattern or criteria) or not (e.g., constant or 0 current), or not applied (e.g., passive); in some embodiments, reverse bias current may be applied to 12b;
25) in some embodiments, semiconductor fabrication process can be used to produce the RCLED based NOR and the process flow includes but not limited to, epitaxial growth (e.g., RCLED structure is grown on a substrate (often Si or GaN) using techniques like MBE or MOCVD. This includes growing layers such as buffer layers, n-type and p-type semiconductor layers, quantum wells, loss material, and contact layers), wafer bonding (e.g, in some cases, especially for GaN-on-Si RCLEDs, wafer bonding is used to transfer the epitaxial layers to a new substrate), substrate removal (e.g., The original growth substrate [e.g., Si] is removed to allow for the formation of the optical cavity), mirror deposition (e.g., High-quality DBRs are deposited on both sides of the active region to form the optical cavity. This may involve chemical mechanical polishing to reduce surface roughness before deposition), mesa etching (e.g., Dry etching is used to define the device structure, often in a circular shape), contact formation (e.g., Metal contacts are deposited for both p-type and n-type regions of the device), passivation (e.g., A passivation layer is applied to protect the device and reduce surface recombination), metallization (e.g., Additional metal layers are deposited for electrical connections and heat dissipation), packaging (e.g., devices are packaged for protection and to facilitate integration into various applications);
26) in some embodiments, electric current/voltage/signal applied to gain medium 12a may be above certain threshold; in some embodiments, electric current/voltage/signal applied to gain medium 12a may be equal to or below certain threshold; in some embodiments, electric current/voltage/signal applied to gain medium 12a may be above or equal to or below certain threshold at different time window; in some embodiments, electric current/voltage/signal applied to gain medium 12a may be modulated according to certain pattern and/or modulation technique (e.g., pulse width modulation, amplitude/phase modulation, analog/digital modulation);
27) in one embodiment, electric current/voltage applied to loss material and/or PCM and/or modulating device/element 12b may be below or equal to certain threshold (e.g, 0); in another embodiment, electric current/voltage applied to 12b may be above certain threshold; in another embodiment, electric current/voltage applied to 12b may be above or equal to or below certain threshold at different time; in yet another embodiment, electric current/voltage applied to 12b may be modulated according to certain pattern and/or modulation technique (e.g., pulse width modulation, amplitude/phase/polarization modulation, analog/digital modulation);
28) NOR may emit light as CW or >=1 pulses or spikes if one or more criteria are met, IBNLT, no pulse or spike if input light intensity (either intensity of single pulse or spike or CW light or intensity accumulated from >1 pulse or spike in given time window) is less than certain threshold, >=1 pulse or spike if input light intensity (either intensity of single pulse or spike or CW light or intensity accumulated from >1 pulse or spike in given time window) is equal to or larger than certain threshold, no spike or pulse if NOR enter into refractory period, NOR is designed to generate pulses or spikes under certain conditions according to certain mechanisms (e.g., gain switch, Q switch, active/passive mode lock, cavity dump, self-phase modulation, group-velocity dispersion, saturable absorption, soliton-assisted time-lens compression, pulsed pumping electrically and/or optically, external pulse carving), intensity of >=1 input pulses is larger than certain threshold, interval of >=2 pulses (e.g., with intensity below threshold for each pulse) is less than certain threshold, pumping current and/or light is above certain threshold for certain duration, relevant modulator (e.g., Q-switcher, pulse picker, cavity dumper) is switched to “on” or “off” state.

FIGS. 6A-6C illustrates 3 example embodiments of electrically and/or optically pumped transmissive RCLED based nonlinear optical resonator as CW or spiking NOR. As will be appreciated by those skilled in the art, in some embodiments:
1) gain medium 12a (e.g., quantum wells [e.g., InAs/GaAs MQW, InGaN MQW, InGaN/GaN MQW, GaInN/GaN MQW], quantum dashs, quantum dots, simply bulk semiconductor materials, organic compound, polymeric materials, ZnSe, CdSe, perovskite, graphene, carbon nanotubes, etc) and/or loss material and/or PCM and/or modulating device/element 12b (e.g., saturable absorber, kerr medium, modulator, metamaterial) may be sandwiched between >=2 mirrors 11 (e.g., DBR, 1D/2D/3D grating, 1D/2D/3D photonic crystal, metamaterial) that are composed of periodic or aperiodically alternating structure/layer (with same or different thickness in each layer) of same or different type of materials;
2) electric current/voltage/signal may be applied to gain medium 12a with certain properties being modulated or not; in some embodiments, electric current applied to gain medium may be below lasing threshold current; in some embodiments, electric current applied to gain medium may be equal to or above lasing threshold current; in some embodiments, electric current may be above or below certain threshold current at different time window;
3) electric current/voltage/signal may be either actively applied to loss material and/or PCM and/or modulating device/element 12b with certain properties being modulated (according to certain pattern or criteria) or not (e.g., constant or 0 current), or not applied (e.g., passive); in some embodiments, reverse bias current may be applied to 12b;
4) input optical signal 4 may be on the top and output from the bottom, or vise versa;
5) input light 4 may be modulated or not;
6) substrate 7 is transparent; and/or
7) gain medium 12a and loss material and/or PCM and/or modulating device/element 12b may be inside same or different cavity.

FIG. 6D illustrates 1 example embodiment of electrically and/or optically pumped transmissive external cavity RCLED based nonlinear optical resonator as CW or spiking NOR. As will be appreciated by those skilled in the art, in some embodiments, 1) gain medium 12a may be sandwiched inside intra-cavity between >=two mirrors 11, and loss material and/or PCM and/or modulating device/element 12b is outside intra-cavity but inside external cavity; 2) electric current/voltage/signal may be applied to gain medium 12a with certain properties being modulated or not; 3) electric current/voltage/signal may be either actively applied to 12b with certain properties being modulated or not (e.g., constant or 0 current), or unmodulated (e.g., passive); 4) input light 4 may be modulated or not; and/or 5) substrate 7 is transparent.

FIGS. 6E-6H illustrate 4 example embodiments of electrically and/or optically pumped reflective RCLED based nonlinear optical resonator as CW or spiking NOR. As will be appreciated by those skilled in the art, in some embodiments:
1) mirrors 11 include but not limited to, periodic structure (e.g., DBR, 1D/2D/3D grating, 1D/2D/3D photonic crystal) or aperiodically alternating structure of same or different type of materials (e.g., suitable reflective materials, dielectric materials, metamaterial);
2) material or element/device inside vertical cavity may be gain medium 12a and/or loss material and/or PCM and/or modulating device/element 12b;
3) suitable material (e.g., semiconductor materials, organic compound, polymeric materials, ZnSe, CdSe, perovskite, graphene, carbon nanotubes) can be used depending on the wavelength of operation;
4) contact 15 on the top or bottom can be ITO or any other suitable materials; in some embodiment, electrical contacts 15 may be made with metal (e.g. Ti/Pt/Au);
5) output light 5 is reflected from non-transparent substrate 6 and/or non-transparent contact 15;
6) both the optical input 4 and optical output signal 5 are on the same side of the contact 15;
7) electric current/voltage/signal may be applied to gain medium 12a with certain properties being modulated or not;
8) electric current/voltage/signal may be actively applied to loss material and/or PCM and/or modulating device/element 12b with certain properties being modulated or not (e.g., constant or 0 current), or unmodulated (e.g., passive);
9) input light may be modulated or not; and/or
10) reflecting light may be emitted from either top or bottom of NOR, depending on arrangement of high reflectivity DBR and/or non-transparent substrate 6 and/or non-transparent contact 15.

FIGS. 6I-6L illustrate 4 example embodiments of electrically and/or optically pumped transmissive or reflective RCLED based nonlinear optical resonator as CW or spiking NOR. As will be appreciated by those skilled in the art, in some embodiments:
1) mirrors 11 include but are not limited to, periodic structure (e.g., DBR, 1D/2D/3D grating, 1D/2D/3D photonic crystal) or aperiodically alternating structure of same or different type of materials (e.g., suitable reflective materials, dielectric materials, metamaterial);
2) gain medium 12a and loss material and/or PCM and/or modulating device/element 12b may be placed in same or different cavity which may be sandwiched between same or different type of mirrors 11;
3) contact 15 (e.g., metal, ITO or other suitable materials) may be used on the top, middle, bottom for gain medium 12a and loss material and/or PCM and/or modulating device/element 12b;
4) electric current/voltage/signal may be actively applied to gain medium 12a with certain properties being modulated or not (e.g., constant or 0 current);
5) electric current/voltage/signal may be either actively applied to loss material and/or PCM and/or modulating device/element 12b with certain properties being modulated or not (e.g., constant or 0 current), or not applied; in some embodiments, reverse bias current may be applied to 12b;
6) substrate may be transparent 7 or non transparent 6; and/or
7) reflecting light may be emitted from either top or bottom of NOR, depending on arrangement of high reflectivity DBR and/or non-transparent substrate 6 and/or non-transparent contact 15.

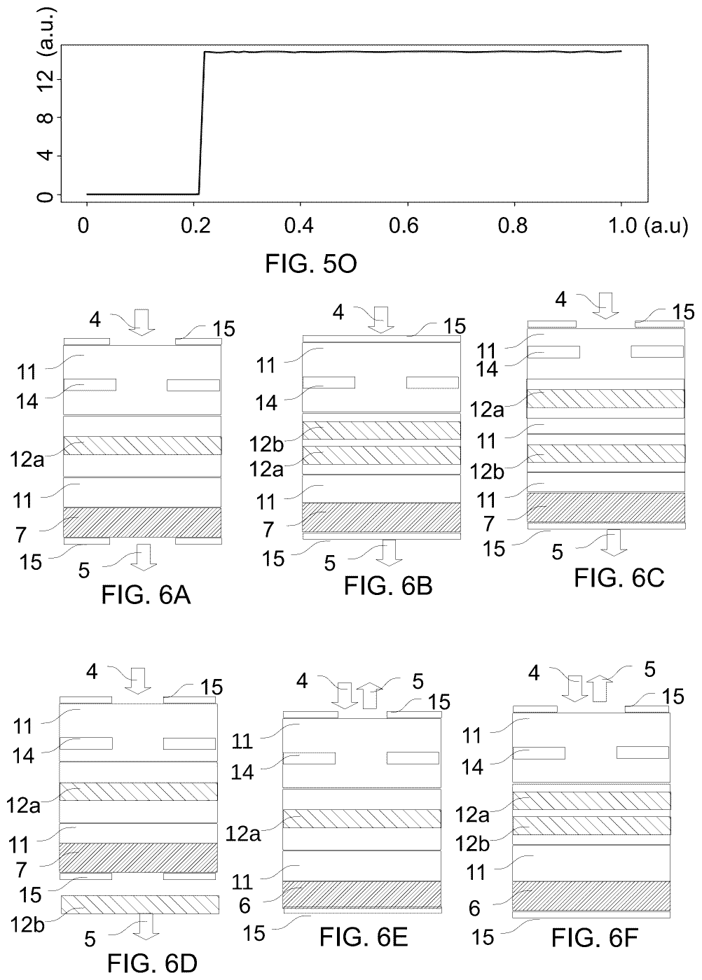

FIGS. 7A-7F show 6 example embodiments of traveling wave cavity (as illustrated in FIGS. 1E-1F) based nonlinear optical ring resonator as CW or spiking NOR, in which 1) nonlinear optical ring resonator obeys the principles or properties behind total internal reflection, constructive interference, and optical coupling; and/or 2) light propagates through (e.g., input, output, transmit, relay, inter-connect) optical element or device (OED) 1 (e.g., fiber, waveguide, microring), and goes around inside loop-like OED 11 (e.g., microring, fiber, waveguide) which is coupled to OED 1 and/or other OED 11, and goes through optical material 12 (e.g., gain medium and/or loss material or PCM or modulating element/device).

As will be appreciated by those skilled in the art, in some embodiments:
1) material 12 can be either electrically and/or optically pumped or unpumped;
2) in addition to the spatial arrangements of OED 11, OED 1 and material 12 inside ring cavity as illustrated in FIG. 7A-7F, any other periodic or aperiodic 1D/2D/3D spatial arrangements are also possible, for example (R stands for OED 11, G for gain medium, L for loss material), R-G-G-R, R-G-R-G, R-L-L-R, R-L-R-L-R, R-G-L-R, R-G-R-L, R-G-R-L-R, R-G-L-G-R, R-L-G-L-R, R-G-R-L-G-R, etc.;
3) material or element/device 12 inside or outside ring cavity may be, IBNLT, gain medium (e.g., crystals doped with rare-earth ions or transition metal ions, glasses doped with active ions, semiconductors, nanoparticle, quantum dot/well/dash/wire, etc), and/or loss material (e.g., semiconductor materials, crystals, saturable absorber, reverse saturate absorber, other suitable absorptive material, nanoparticle, metamaterial, lithium niobate, etc), and/or PCM, and/or modulating material/element/device (e.g., modulator, MEMS, grating, kerr medium);
4) at least one ring or loop-like (fully or partial closed) structure is used for traveling wave cavity;
5) shape or geometry of OED 11 can be, IBNLT, ring, circle, ellipse, rectangle, triangle, diamond, rhombus, hexagonal, half ring;
6) same or different spatial arrangements of OED 11 and material 12 may be used for different ring cavity; and/or
7) same or different shape/geometry (e.g., radius, size, shape, etc) of OED 11 may be used for different ring cavity.

FIGS. 7A and 7B illustrate 2 example embodiments of traveling wave cavity based nonlinear optical ring resonator uses single ring shape OED 11 with optical material 12 inside.

FIGS. 7C-7F illustrate 4 example embodiments of spatial arrangement of 2 ring shape OED 11 with optical material 12 inside, and OED 1.

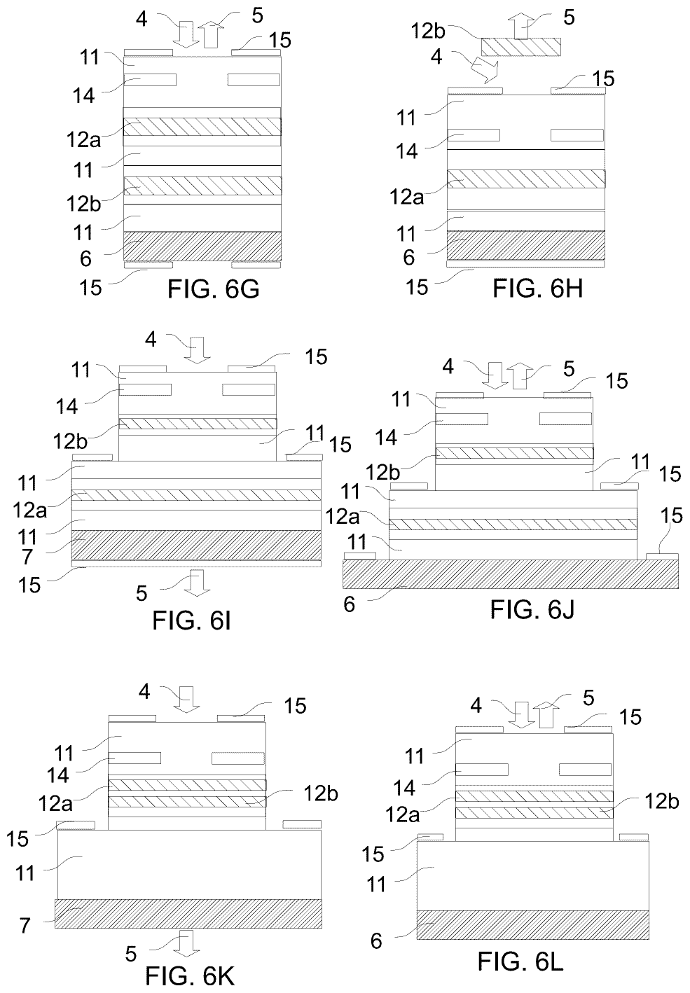

FIGS. 8A-8R illustrate 18 example embodiments of spatial arrangement of group of pixels 16 or pixels 16a/16b/16c/16d on 1D or 2D or 3D substrate 17. As will be appreciated by those skilled in the art, in some embodiments:
1) type of pixel 16 or 16a/16b/16c/16d may be, IBNLT, transmissive and/or reflective nonlinear optical resonator (CW or spiking NOR, e.g., VCSEL, VCSOA, VECSEL, RCLED, ring or microring laser, whispering-gallery laser, micropillar laser, microdisk laser, VCSEL-SA, VCSOA-SA, VECSEL-SA, RCLED-SA, micropillar laser-SA, microdisk laser-SA, ring or microring laser-SA, whispering-gallery laser-SA, mode locked VCSEL, mode locked VCSOA, mode locked VECSEL, mode locked micropillar laser, mode locked microdisk laser, mode locked ring or microring laser, mode locked whispering-gallery laser), modulator (e.g., electro-optic modulator, acousto-optic modulator, plasmonic modulator, electroabsorption modulator, interferometric modulator, micromechanical modulator [e.g., nanofabricated deformable or movable mirror], metamaterial/metasurface modulator, SLM, magneto-optic modulator, MQW modulator, liquid crystal modulator, Lithium Niobate modulator, VCSEL modulator, graphene modulator, passive modulator [e.g., 3D printed, metasurface, metaline], microRing modulator, waveguide modulator, MZI modulator, phase and/or amplitude and/or polarization modulator, or a combination of amplitude and/or phase and/or polarization modulators), sensor (e.g., photodiode or photodetector [PD, e.g., CMOS PD, CCD, Avalanche PD, InGaAs PIN PD, Graphene PD, metasurface PD, metal-semiconductor-metal photodetector, Single-photon avalanche diode, MQW PD, Quantum dot PD, angle-sensitive PD]), diffractive optical elements (e.g., 1D/2D/3D grating, diffractive diffuser, diffractive lens), lens or lens array (e.g., fresnel, micro-lens, meta-lens, liquid lens), transistors (e.g., circuit), MEMS (consisting of one or more of these structures: mechanical microstructures, microsensors, micro-actuators and micro-electronics) or NEMS, metamaterial (e.g., metasurface, metaline, metalens), thin film (e.g., AlGaInP/GaInP), quantum dot/well/dash, composite pixel (e.g., Lens before and/or after NOR or Modulator or sensor, MEMS before and/or after and/or inside and/or surrounding NOR or Modulator or sensor, sensor before and/or after and/or inside and/or surrounding NOR or Modulator, transistor beside and/or before and/or after NOR or Modulator, smart pixel, super pixels [eg., >=2 same or different types and/or designs of CW NORs and/or spiking NORs and/or modulators and/or sensors], angle-sensitive pixel);
2) 2D/3D shape or geometry of substrate 17 may be, IBNLT, rectangle, circle, ellipse, triangle, diamond, rhombus, ring, hexagonal, planar, non-planar;
3) 2D/3D shape or geometry of pixel 16 or 16a/16b/16c/16d may be, IBNLT, circle, ellipse, rectangle, triangle, diamond, rhombus, trapezoid, hexagonal, cross, X-shape, Y-shape, any other possible shape/geometry; pixel 16 or 16a/16b/16c/16d on same substrate 17 may have same or different type and/or size and/or 1D/2D/3D geometry (e.g., shape, width, length, height or depth or thickness, rotation);
4) for transmissive pixel 16 or 16a/16b/16c/16d, top and bottom apertures (e.g., for input and output light) of pixel 16 or 16a/16b/16c/16d may have same or different size and/or 2D/3D geometry (e.g., shape, width, length, height or depth or thickness) and/or integrated components (e.g., thin film, quantum dot, modulator, lens or lens array, diffractive optical elements, MEMS, sensor, metamaterial) and/or polarization control, for example, circular shape for top aperture and rectangle shape for bottom aperture, integrating grating/MEMS only with bottom aperture, integrating lens only with top aperture, integrating PD with top and bottom aperture;
5) substrate 17 may include but is not limited to, at least one type of pixel 16 or 16a/16b/16c/16d (e.g., NOR, modulator, PD, MEMS, transistor, Lens, VCSOA+RCLED, NOR+modulator, modulator+PD, NOR+PD, InGaAs PIN+CMOS PD), at least one pixel of 16 or 16a/16b/16c/16d, at least one size and/or 1D/2D/3D shape/geometry and/or rotation of pixel 16 or 16a/16b/16c/16d (e.g., 3 μm pixel size, 5 μm+10 μm pixel size, rectangle+circle shape, 45+60 degree rotation, 5 μm+10 μm height or depth or thickness), at least one group of pixels 16 or 16a/16b/16c/16d (e.g., group/section of VCSOA+group of RCLED, group of rectangle shape pixel+group of circle shape pixel);
6) pixel 16 or 16a/16b/16c/16d may be addressed or modulated or tuned, for example, layer-wise, column or row-wise, section or group-wise, pixel-wise;
7) all or subset of pixels 16 or 16a/16b/16c/16d may be modulated or tuned according to certain criteria, IBNLT, temporally and spatially turn on and/or off all/subset/group of pixel 16 or 16a/16b/16c/16d according to certain criteria or schedule (e.g., randomly turn on/off subset of pixel 16 or 16a/16b/16c/16d, coded rolling shutter, event-based, change-based [e.g., only update pixels which have to-be-updated values different from current values]);
8) pixel 16 or 16a/16b/16c/16d may be on the same and/or different side of and/or inside/within substrate 17;
9) pixel 16 or 16a/16b/16c/16d may be formed or fabricated above/below/within substrate 17 by having/changing/alternating (periodically or aperiodically) same or different properties (e.g., refractive index, transmission, reflection, polarization, shape, thickness or height or depth, geometry), and/or incorporating different active materials and/or passive materials (e.g, crystal, polymer, semiconductor, graphene, quantum dots, quantum well, carbon nanotubes, metamaterial, plasmonic structure, 3D print material), and/or integrating with same or different passive component and/or active component (e.g., modulators, PD, NOR, MEMS, Lens), at same or different regions or locations or depths of substrate 17;
10) pixel 16 or 16a/16b/16c/16d may be modulated or addressed based on certain quantization level (e.g., 256 levels for 8-bit, 4 levels for 2-bit, 2 levels for 1-bit);
11) pixel 16 or 16a/16b/16c/16d and/or substrate 17 may be coated with layer or film or material to, for example, avoid reflection, partially transmit or block light, absorb or attenuate transmissive and/or reflective light;
12) various fabrication methods may be used for pixel 16 or 16a/16b/16c/16d and/or substrate 17, including but not limited, 3D print, photo-lithography, multi-photon lithography, Metal-Organic Chemical Vapour Deposition, Molecular Beam Epitaxy, evaporative deposition, ion beam deposition, inductively coupled plasma chemical vapor deposition; and/or
13) pixel 16 or 16a/16b/16c/16d and/or substrate 17 may be either fixed or dynamically (fully or partially) adjustable or tunable (e.g., movable, rotatable, deformable).

FIGS. 8A-8H illustrate 8 example embodiments of spatial arrangement of same 2D/3D geometry (e.g., shape, size, rotation, etc) of same type of pixels 16 on substrate 17.

FIGS. 8I-8L illustrate 4 example embodiments of spatial arrangement of different 2D/3D geometry (e.g., shape, size, rotation, etc) of same type or design of pixels 16a/16b/16c/16d on substrate 17.

FIGS. 8M-8P illustrate 4 example embodiments of spatial arrangement of same or different 2D/3D geometry (e.g., shape, size, rotation, etc) and/or group/section of >=2 designs and/or types of pixels 16a/16b/16c/16d (e.g., different designs of same type of NORs, different types of NORs [e.g., VCSOA+RCLED, CW NOR+spiking NOR], NOR+modulator, NOR+PD, NOR+modulator+PD, PD+modulator) on substrate 17.

FIG. 8Q illustrates an example embodiment of spatial arrangement of same or different geometry (e.g., shape, size, rotation, etc) of >=2 types of pixels (e.g., 16a/16b/16c) on same side of substrate 17. In some embodiments, >=1 first subset of pixels (eg., geometry A of pixel, type A pixel, design A of type A pixel) are configured for >=1 first objectives or tasks according to relevant information (e.g., information received and/or processed by >=1 first subset of pixels, information from >=1 integrated computing components of >=1 first subset of pixels, information from external computing components, information from input modules, information from output modules), and >=1 second subset of pixels (e.g., geometry B of pixel, type B pixel, design B of type A pixel) are configured for >=1 second objectives or tasks according to relevant information (e.g., information received and/or processed by >=1 first subset of pixels, information received and/or processed by >=1 second subset of pixels, information from >=1 integrated computing components of >=1 second subset of pixels, information from external computing components, information from input modules, information from output modules). For example, in one embodiment, input optical signal may be received by first subset of type A pixel 16a (e.g., PD [e.g., CMOS PD, CCD, Avalanche PD, InGaAs PIN PD, Graphene PD, metasurface PD, Single-photon avalanche diode, MQW PD, Quantum dot PD, angle-sensitive PD]), then two second subsets of pixels 16b and/or 16c (e.g., CW and/or spiking NOR, modulator, transistors+VCSEL/VCSOA, transistors+NOR, transistors+modulator, NOR+modulator) emit or transmit or reflect or modulate or transform relevant optical signal according to relevant information (e.g., after post-processing input signal received by pixel 16a). In another embodiment, input optical signal may be received by first subset of pixels 16a (e.g., CMOS PD, angle-sensitive PD, modulator, NOR) and/or second subsets of pixels 16b and/or 16c (e.g., InGaAs PIN PD, modulator, NOR) for same or different purpose, IBNLT, cheap PD/modulator/NOR pixel 16a vs expensive PD/modulator/NOR pixel 16b/16c for slow vs fast signal processing (e.g., MHz vs GHz), PD pixel 16a to monitor light surrounding NOR/modulator pixel 16b/16c, PD pixel 16a vs type A modulator pixel 16b and/or type B modulator/NOR pixel 16c to detect vs modulate and/or transform light of different properties (e.g., wavelength, polarization, incident angle, etc), CW NOR pixel 16a vs spiking NOR pixel 16b/16c for different objectives and/or tasks, design A of CW NOR pixel 16a vs design B of CW NOR pixel 16b and design C of spiking NOR pixel 16c for different polarization states of input light.

FIG. 8R illustrates an example embodiment of spatial arrangement of same or different geometry (e.g., shape, size, rotation, etc) of >=1 type of pixels (e.g., 16a/16b/16c) on different side of substrate 17. In one embodiment, input optical signal may be received by first subset of pixels 16a (e.g., PD, NOR, modulator), then second subsets of pixels 16b and/or 16c (e.g., transistors+VCSEL, transistor+NOR, transistor+modulator, NOR+modulator) emit or transmit or reflect or modulate or transform relevant optical signal according to information received by pixel 16a and/or postprocessed by pixel 16a and/or 16b and/or 16c and/or external computing unit and/or input module and/or output module.

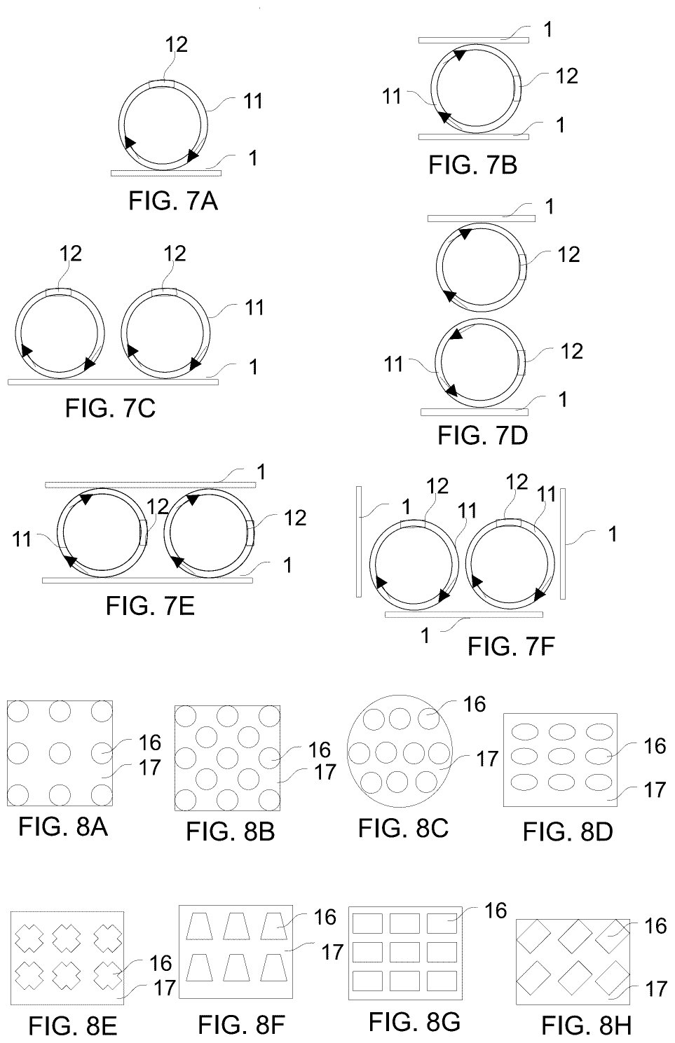

FIGS. 9A-9E illustrate 5 example embodiments of anti-reflective design for transmissive nonlinear optical resonator as CW or spiking NOR 21 or OED 21 (e.g., modulator, PD), in which output light reflected from NOR or OED 21 is blocked or redirected from input light. As will be appreciated by those skilled in the art, in some embodiments, NOR or OED 21 may be 0D (e.g., single pixel of NOR or OED), 1D (e.g., line or curve or sequence of NOR or OED pixels) or 2D (e.g., array or group of NOR or OED pixels, planar or non-planar). OED 22 is blocking OED (eg., anti-reflective film, polarizer), OED 22a is polarizer, OED 23 is quarter waveplate, OED 24 is waveplate or polarizer, OED 25 is polarization rotator or half waveplate, OED 26 is polarizer or polarization rotator, OED 27 is polarization beam splitter (PBS), OED 28 is half waveplate, and OED 29 is polarization rotator.

FIG. 9A illustrates an example embodiment in which reflected light from NOR or OED 21 is blocked by material or device or component or layer 22 (e.g., anti-reflective coating, polarizer). Another example embodiment as illustrated by FIG. 9A is 1) input light passes through polarizer 22 to become linear polarized (e.g., vertical polarized); and/or 2) output light reflected from NOR 21 may be horizontal linear polarized by various polarization control mechanisms (e.g., using grating or anisotropy [e.g., rectangle or rhombus shape] for input aperture [for input light] of pixels in NOR 21), which is then blocked by polarizer 22.

FIG. 9B illustrates an example embodiment in which 1) optionally, input light passes through polarizer 22 to become linear polarized (e.g., vertical polarized); 2) linear polarized light passes through quarter waveplate 23 to become circular polarized (e.g., right-handed circular polarized [RCP]); 3) after polarized (e.g., circular [e.g., RCP], linear) light passes through NOR 21, optionally, transmissive polarized (e.g., circular [e.g., RCP]) output light passes through waveplate 24 (eg quarter waveplate, quarter+half waveplate) or polarizer 24 to become linear polarized; and/or 4) reflective circular polarized (e.g., left-handed circular polarized [LCP]) output light passed back through quarter waveplate 23 to become 90 degree rotated linear polarized (e.g., horizontal polarized), which is then blocked by polarizer 22.

FIG. 9C illustrates an example embodiment in which 1) optionally, input light passes through polarizer 22 to become linear polarized (e.g., vertical polarized); 2) linear polarized light passes through polarization rotator 25 (e.g., Faraday rotator) to rotate 45 degree; 3) 45 degree polarized light passes through polarizer 26 (e.g., 45 degree polarizer); 4) after 45 degree polarized light passes through NOR 21, optionally, transmissive polarized light (e.g., 45 degree polarized, linear polarized) passes through polarizer 24; and/or 5) reflective 45 degree polarized light passes back through polarizer 26 and polarization rotator 25 to become 90 degree rotated linear polarized (e.g., horizontal polarized), which is then blocked by polarizer 22.

Another example embodiment illustrated in FIG. 9C is:
1) input light passes through polarizer 22 to become linear polarized (e.g., vertical polarized);
2) linear polarized light is converted to 45 degree linear polarized light by half waveplate 25 (e.g., 22.5 degree slow axis);
3) 45 degree polarized light is then rotated 45 degree by polarization rotator 26 (e.g., Farady rotator) to become 90 degree rotated (e.g., horizontal polarized);
4) after linear polarized light passes through NOR 21, optionally, transmissive polarized (e.g., linear) output light passes through waveplate or polarizer 24;
5) reflective horizontal polarized output light passes through polarization rotator 26 to become 45 degree linear polarized, which is then rotated 45 degree by half waveplate 25 to become horizontal polarized;
6) horizontal polarized light is then blocked by polarizer 22.

FIG. 9D illustrates an example embodiment in which:
1) optionally, input light passes through polarizer 22a to become linear polarized (e.g., vertical polarized);
2) linear polarized light passes through PBS 27 and is then converted to circular polarized light (e.g., RCP) by quarter waveplate 23;
3) after circular polarized light passes through NOR 21, optionally, transmissive polarized (e.g., circular [e.g., RCP], linear) output light passes through waveplate 24 (eg quarter waveplate, quarter+half waveplate) or polarizer 24 to become linear polarized;
4) reflective circular polarized (e.g., LCP) output light is converted to 90 degree rotated linear polarized light (eg. horizontal polarized) by quarter waveplate 23, which is then deflected by PBS 27 to a direction which is different (e.g., perpendicular) from direction of input light;
5) optionally, the deflected reflective light may be either blocked (e.g., by quarter waveplate+polarizer) or used for other purpose (e.g., redirected to other part/layer/block/branch of optical neural network, detected by PD, emitted to environment).

FIG. 9E illustrates an example embodiment in which 1) optionally, input light passes through polarizer 22a to become linear polarized (e.g., vertical polarized); 2) linear polarized light passes through PBS 27 and is then converted to 45 degree linear polarized light by half waveplate 28 (e.g., 22.5 degree slow axis); 3) 45 degree polarized light is then rotated 45 degree by polarization rotator 29 (e.g., Farady rotator) to become 90 degree rotated (e.g., horizontal polarized); 4) after linear polarized light passes through NOR 21, optionally, transmissive polarized (e.g., linear) output light passes through waveplate or polarizer 24; 5) reflective horizontal polarized output light passes through polarization rotator 29 to become 45 degree linear polarized, which is then rotated 45 degree by half waveplate 28 to become horizontal polarized; 6) horizontal polarized light is then deflected by PBS 27 to a direction that is different (e.g., perpendicular) from the direction of input light; and/or 7) optionally, the deflected reflective light may be either blocked (e.g., by quarter waveplate+polarizer) or used for other purpose (e.g., redirected to other part/layer/block/branch of optical neural network, detected by PD, emitted to environment).

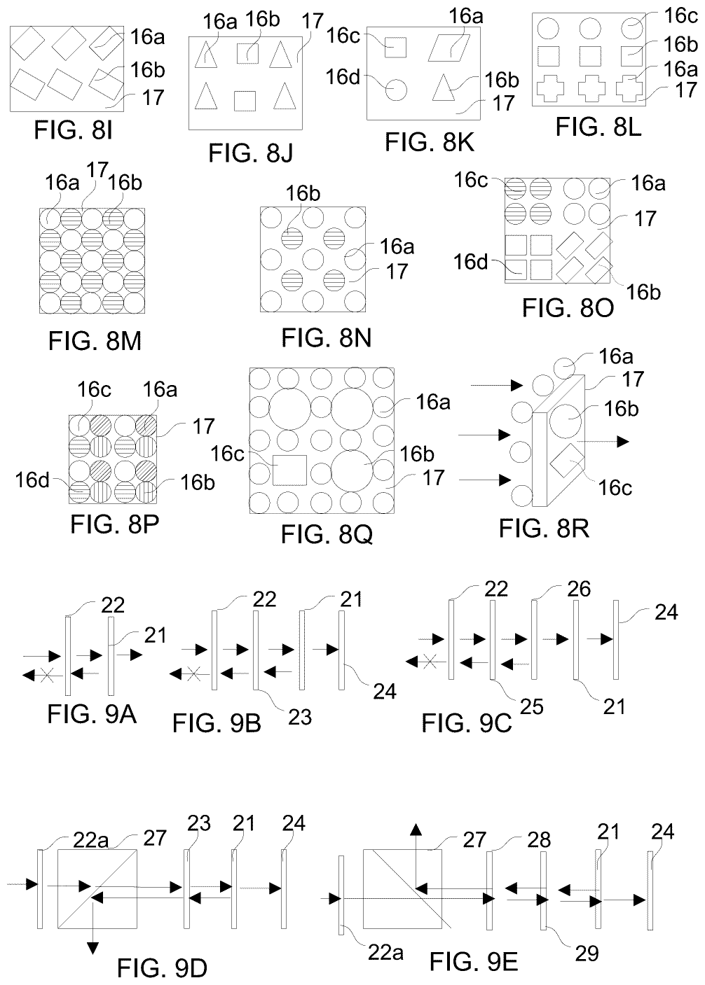

FIGS. 10A-10C illustrate 3 example embodiments of anti-reflective design for reflective OED 31, in which output light reflected from OED 31 is deflected or redirected to another direction that is different from input light. As will be appreciated by those skilled in the art, in some embodiments, 1) OED 31 may be, IBNLT, CW or spiking NOR, modulator (e.g., SLM), PD, mirror, lens; 2) OED 31 may be GD (e.g., single pixel), 1D (e.g., line or curve or sequence of pixels), 2D (e.g., array of pixels, planar or non-planar), or 3D (e.g., group or sequence of 2D layers over Z and/or X-Y axis).

FIG. 10A illustrates an example embodiment in which 1) optionally, input light passes through OED 32 (e.g., NOR, modulator, polarizer); 2) light passes through OED 33 (e.g., optical circulator) and is directed toward OED 31; 3) reflected light from OED 31 is deflected or redirected to another direction by OED 33; and/or 4) optionally, deflected or redirected light passes through OED 32 (e.g., NOR, modulator, polarizer).

FIG. 10B illustrates an example embodiment in which 1) optionally, input light passes through polarizer 22a to become linear polarized (e.g., vertical polarized); 2) linear polarized light passes through PBS 27 and is then converted to circular polarized light (e.g., RCP) by quarter waveplate 23; and/or 3) reflective circular polarized (e.g., LCP) output light from OED 31 is converted to 90 degree rotated linear polarized light (eg. horizontal polarized) by quarter waveplate 23, which is then deflected or redirected by PBS 27 to a direction that is different (e.g., perpendicular) from the direction of input light.

FIG. 10C illustrates an example embodiment in which 1) optionally, input light passes through polarizer 22a to become linear polarized (e.g., vertical polarized); 2) linear polarized light passes through PBS 27 and is then converted to 45 degree linear polarized light by half waveplate 28 (e.g., 22.5 degree slow axis); 3) 45 degree polarized light is then rotated 45 degree by polarization rotator 29 (e.g., Farady rotator) to become 90 degree rotated (e.g., horizontal polarized); 4) reflective horizontal polarized output light from OED 31 passes through polarization rotator 29 to become 45 degree linear polarized, which is then rotated 45 degree by half waveplate 28 to become horizontal polarized; and/or 5) horizontal polarized light is then deflected by PBS 27 to a direction that is different (eg perpendicular) from the direction of input light.

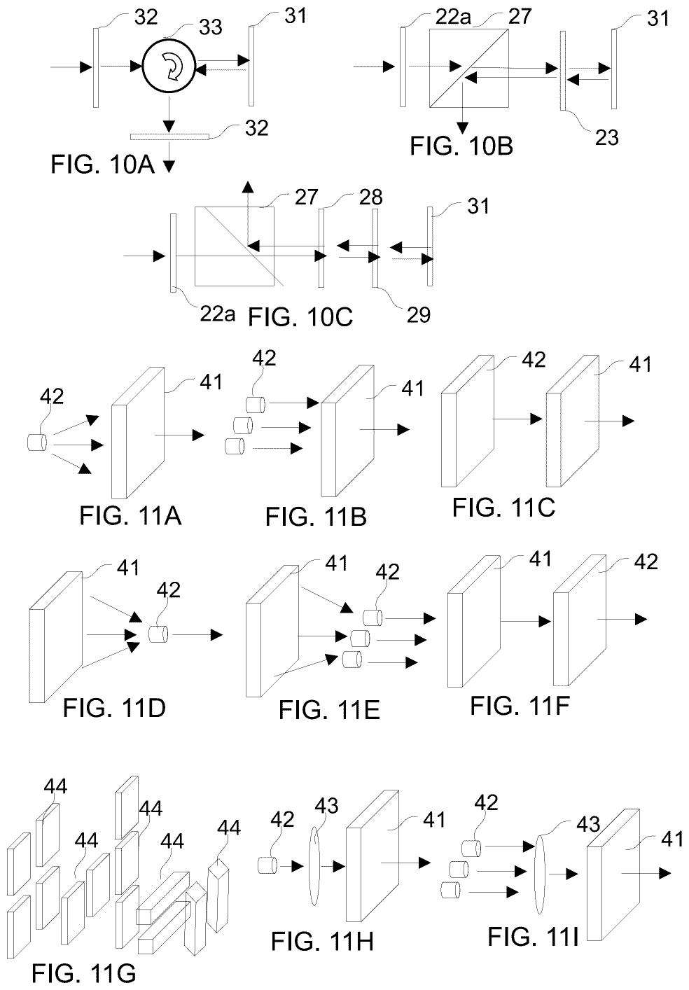

FIGS. 11A-11N illustrate 14 example embodiments of spatial arrangement between 2D/3D transmissive NOR as CW or spiking NOR 41 and other OED. As will be appreciated by those skilled in the art, in some embodiments:
1) 2D/3D transmissive NOR 41 has group of same or different type and/or design of pixels (e.g., CW and/or spiking NOR, modulator, PD, lens, MEMS) spatially arranged on 2D/3D substrate/block/layer as illustrated in FIG. 8A-8R and FIG. 9A-9E;
2) OED 42 may be 0D (e.g., single pixel or device or component) or 1D arrangement (e.g., line or curve or sequence or ring) or 2D arrangement (e.g., 2D array, metasurface, planar or non-planar) or 3D arrangement (e.g., group or sequence of 2D layers over Z and/or X-Y axis) of >=1 OED or material which includes but is not limited to, laser, fiber, 1D/2D/3D waveguide, geometric waveguide, diffractive optical element, diffractive waveguide, beam splitter or PBS, prism, optical circulator, polarizer, microRing, MZI, directional coupler, grating coupler, CW and/or spiking NOR, modulator, PD, MEMS, metamaterial (e.g., metasurface, mataline), etc; OED 43 may be 0D or 1D or 2D or 3D of >=1 OED or material which includes but is not limited to, lens (e.g., lens, Fresnel lens, microlens, metalens, liquid lens) or lens array, fiber, 1D/2D/3D waveguide, geometric waveguide, diffractive optical element, diffractive waveguide, beam splitter or PBS, prism, optical circulator, polarizer, microRing, MZI, directional coupler, grating coupler, modulator, metamaterial, etc;
3) similar spatial arrangement between 2D/3D reflective NOR 31 and other OEDs (e.g., 42, 43) may be implemented by using appropriate OED (e.g., optical circulator) as illustrated in FIG. 10A-10C;
4) pixels on same OED (e.g., 41, 42, 43) may have same or different type and/or design and/or 2D/3D geometry (e.g., shape, size, rotation, width, length, height or depth or thickness);
5) top and bottom apertures of pixel on same OED (e.g., 41, 42, 43) may have same or different 2D/3D geometry (e.g., size, shape, width, length, height or depth or thickness);
6) pixels on different OED (e.g., 41, 42, 43) may have same or different type and/or design and/or 2D/3D geometry (e.g., size, shape, width, length, height or depth or thickness) and/or spatial arrangement and/or number of pixels; and/or
7) 3D arrangement among different OED (e.g., 41, 42, 43) may be either fixed or dynamically adjustable (e.g., tunable, movable).

FIGS. 11A-11C illustrate 3 example embodiments in which light goes from 0D/1D/2D/3D OED 42 to 2D/3D transmissive NOR 41.

FIGS. 11D-11F illustrate 3 example embodiments of in which light goes from 2D/3D transmissive NOR 41 to 0D/1D/2D/3D OED 42.

FIG. 11G illustrate 5 example embodiments of spatial arrangement of OED 44, which may be 0D/1D/2D/3D OED 42 or 2D/3D transmissive NOR 41 or 0D/1D/2D/3D OED 43.

FIG. 11H-11M illustrate 6 example embodiments of spatial arrangement of OED 43 between OED 42 and transmissive NOR 41. As will be appreciated by those skilled in the art, in some embodiments, OED 43 may be 0D or 1D or 2D or 3D arrangement of >=1 OED or material which includes but is not limited to, lens (e.g., lens, Fresnel lens, microlens, metalens, liquid lens), fiber, 1D/2D/3D waveguide, geometric waveguide, diffractive optical element, diffractive waveguide, prism, beam splitter, optical circulator, polarizer, microRing, MZI, directional coupler, grating coupler, modulator, PD, MEMS, metamaterial.

FIG. 11N illustrates an example embodiment of spatial arrangement of 3D OED 42 and transmissive NOR 41 or reflective NOR 31, in which OED 42 contains 3D arrangement of 1D/2D/3D OED 45. As will be appreciated by those skilled in the art, in some embodiments, 1) type of OED 45 may be fiber, waveguide, microRing, MZI, directional coupler; 2) OED 45 may be 1D (e.g., line or curve or ring) or 2D or 3D; 3) OED 42 may contain same or different type and/or design of OED 45; and/or 4) >=1 OED 45 may connect/link/correspond/map to >=1 transmissive pixels on NOR 41 and/or reflective pixels on NOR 31.

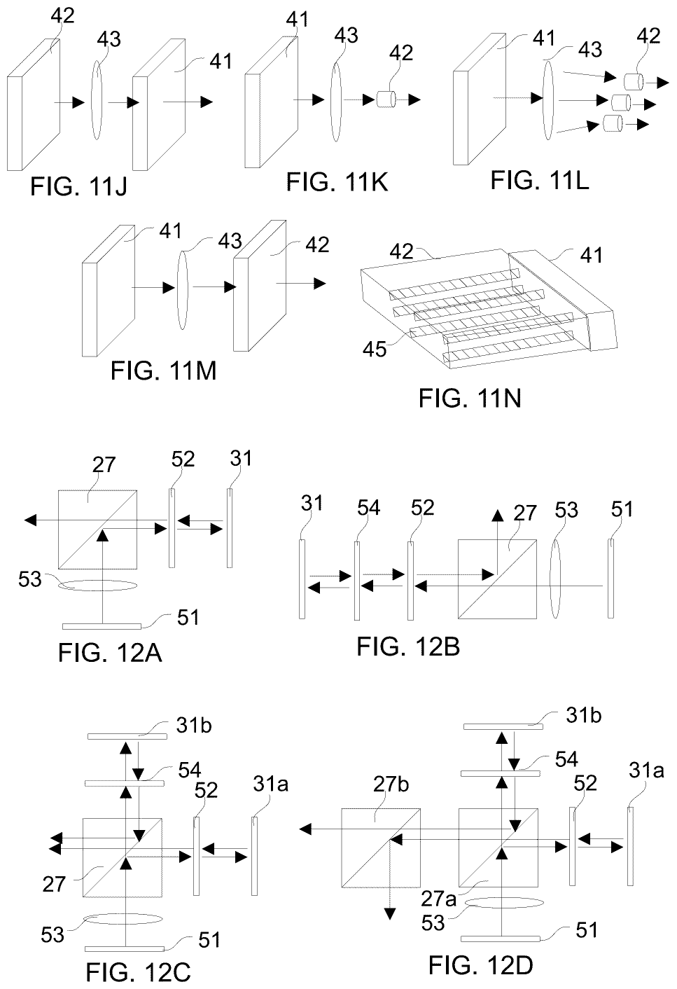

FIGS. 12A-12D illustrate 4 example embodiments of spatial arrangement between reflective OED 31 or 31a/31b and other OED. As will be appreciated by those skilled in the art, in some embodiments, 1) reflective OED 31, 31a and 31b may be same or different type of OED, IBNLT, CW or spiking NOR, modulator, PD, mirror, lens; 2) reflective OED 31 or 31a or 31b may be 0D (e.g., single pixel), 1D (e.g., line or curve or sequence of pixels), 2D (e.g., array of pixels, planar or non-planar), 3D (e.g., group or sequence of 2D layers over Z and/or X-Y axis); 3) OED 51 may be, IBNLT, laser, CW or spiking NOR, modulator, PD, polarizer, lens; 4) OED 52 may be quarter waveplate or half waveplate; 5) OED 53 may be, IBNLT, lens, polarizer, or combination of lens and polarizers; 6) OED 54 may be polarization rotator or quarter waveplate; and/or 7) OED 51 or 53 may be 0D (e.g., single pixel), 1D (e.g., line or curve or sequence of pixels), 2D (e.g., array of pixels, planar or non-planar), or 3D (e.g., group or sequence of 2D layers over Z and/or X-Y axis).

FIG. 12A illustrates an example embodiment in which 1) linear polarized (e.g., vertical polarized) light from OED 51 is reflected by PBS 27 and is then converted to circular polarized light (e.g., RCP) by quarter waveplate 52; 2) reflective circular polarized (e.g., LCP) output light from OED 31 is converted to 90 degree rotated linear polarized light (eg. horizontal polarized) by quarter waveplate 52, which then passes through PBS 27 to a direction that is different (e.g., perpendicular or non-perpendicular) from direction of input light; and/or 3) optionally, OED 53 may be used between OED 51 and 27.

FIG. 12B illustrates an example embodiment in which 1) linear polarized light (e.g., vertical polarized) from OED 51 passes through PBS 27 and is then converted to 45 degree linear polarized light by half waveplate 52 (e.g., 22.5 degree slow axis); 2) 45 degree polarized light is then rotated 45 degree by polarization rotator 54 (e.g., Farady rotator) to become 90 degree rotated (e.g., horizontal polarized); 3) reflective horizontal polarized output light from OED 31 passes through polarization rotator 54 to become 45 degree linear polarized, which is then rotated 45 degree by half waveplate 52 to become horizontal polarized; 4) horizontal polarized light is then deflected or redirected by PBS 27 to a direction that is different (e.g., perpendicular or non-perpendicular) from direction of input light; and/or 5) in some embodiments, OED 53 may be used between OED 51 and 27.

FIG. 12C illustrates an example embodiment in which 1) light from OED 51 may be without polarization control or relatively accurate polarization control, and is decomposed by PBS 27 to orthogonal polarization; 2) some portion of decomposed light (e.g., vertical polarized) from OED 51 is reflected by PBS 27 and is then converted to circular polarized light (e.g., RCP) by quarter waveplate 52; 3) reflective circular polarized (e.g., LCP) output light from OED 31a is converted to 90 degree rotated linear polarized light (eg. horizontal polarized) by quarter waveplate 52, which then passes through PBS 27 to a direction that is different (eg perpendicular or non-perpendicular) from direction of input light; 4) other portion of decomposed light (e.g., horizontal polarized) passes through PBS 27 and is then converted to circular polarized light (e.g., RCP) by quarter waveplate 54; 5) reflective circular polarized (e.g., LCP) output light from OED 31b is converted to 90 degree rotated linear polarized light (eg. vertical polarized) by quarter waveplate 54, which then reflected by PBS 27 to a direction that is different (e.g., perpendicular or non-perpendicular) from direction of input light; 6) in some embodiments, OED 53 may be used between OED 51 and 27; and/or 7) in some embodiments, OED 52, 31a, 54 and 31b may be placed with an angle relative to PBS 27 so that light reflected from OED 31a and 31b may not overlap.

FIG. 12D illustrates an example embodiment in which:
1) light from OED 51 may be without polarization control or relatively accurate polarization control, and is decomposed by PBS 27a to orthogonal polarization;
2) some portion of decomposed light (e.g., vertical polarized) from OED 51 is reflected by PBS 27a and is then converted to circular polarized light (e.g., RCP) by quarter waveplate 52;
3) reflective circular polarized (e.g., LCP) output light from OED 31 is converted to 90 degree rotated linear polarized light (eg. horizontal polarized) by quarter waveplate 52, which then passes through PBS 27a and is deflected by PBS 27b to a direction that is same as or different from the direction of input light;
4) other portion of decomposed light (e.g., horizontal polarized) passes through PBS 27a and is then converted to circular polarized light (e.g., RCP) by quarter waveplate 54;
5) reflective circular polarized (e.g., LCP) output light from OED 31b is converted to 90 degree rotated linear polarized light (eg. vertical polarized) by quarter waveplate 54, which then reflected by PBS 27a and pass through PBS 27b to a direction that is different (e.g., perpendicular or non-perpendicular) from direction of input light;
6) in some embodiments, OED 53 may be used between OED 51 and 27a;
7) in some embodiments, OED 52, 31a, 54 and 31b may be placed with an angle relative to PBS 27a so that light reflected from OED 31a and 31b may not overlap; and/or
8) in some embodiments, PBS 27b may be placed with an angle relative to PBS 27a.

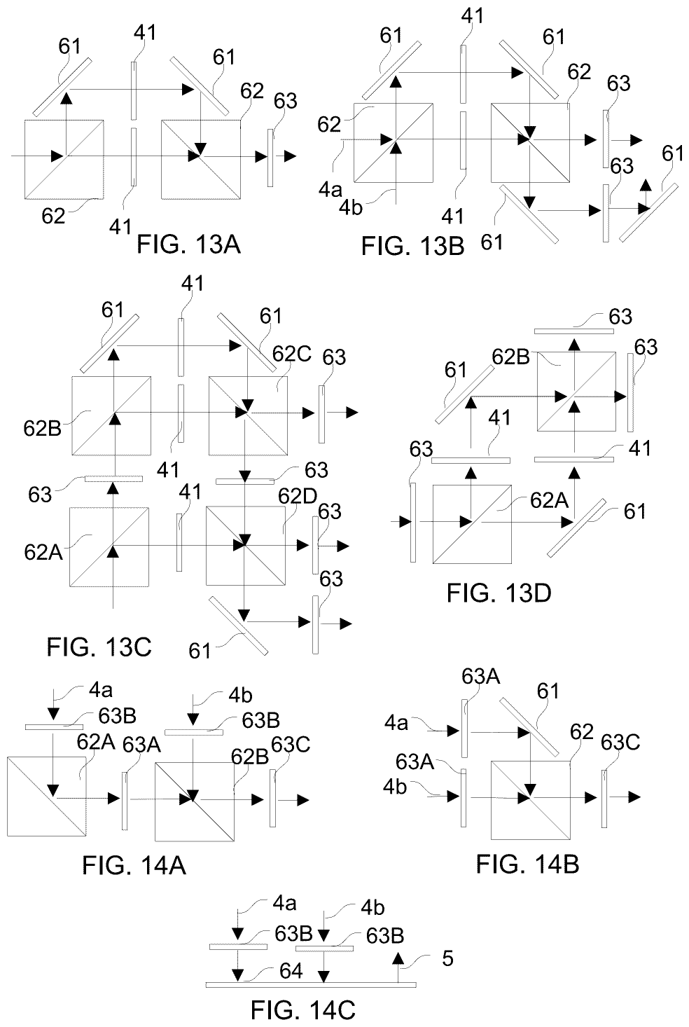

FIGS. 13A-13D illustrate 4 example embodiments of spatial arrangement to split and combine light beam passing through OED 41 and other OED. As will be appreciated by those skilled in the art, in some embodiments, 1) OED 41, 61, and 63 may be same or different type of OED, IBNLT, freespace (ie. vacuum, air, empty), CW or spiking NOR, modulator, PD, mirror, lens, polarizer, waveplate, 1D/2D/3D waveguide, geometric waveguide, diffractive waveguide, beam splitter, diffractive optical element; 2) OED 41, 61, and 63 may be GD (e.g., single pixel), 1D (e.g., line or curve or sequence of pixels, 2D (e.g., array of pixels, metasurface, planar or non-planar), 3D (e.g., group or sequence of 2D layers over Z and/or X-Y axis); 3) OED 41, 61, and 63 may be composed of multiple same or different type of OEDs spatially arranged over Z and/or X-Y axis; 4) OED 62 or 62A/62B/63C/62D may be beam splitter (BS) or PBS; and/or 5) OED 63 may be, IBNLT, NOR, modulator, lens, PD, group of modulator and/or NOR and/or lens.

FIG. 13A illustrates an example embodiment in which 1) incoming light is decomposed by PBS 62 to orthogonal polarization; 2) some portion of decomposed light (e.g., vertical polarized) passes through PBS 62, optionally through OED 41 (e.g., NOR, modulator, lens, group of modulator and/or NOR and/or lens), and through PBS 62; 3) other portion of decomposed light (e.g., horizontal polarized) is deflected by PBS 62, is reflected by OED 61 (e.g., mirror, NOR, modulator), optionally passes through OED 41, is reflected by OED 61, then is deflected by second PBS 62; and/or 4) optionally, overlapped light passes through OED 63.

FIG. 13B illustrates an example embodiment in which 1) incoming light 4a (and optionally incoming light 4b) is split by BS or PBS 62 to two beams; 2) first horizontal beam optionally passes through OED 41 (e.g., NOR, modulator, lens, group of modulator and/or NOR and/or lens), and is split again by BS or PBS 62; 3) second vertical beam is reflected by OED 61 (e.g., mirror, NOR, modulator), optionally passes through OED 41, is reflected by OED 61, then is split by second BS or PBS 62; 4) overlapped horizontal beam from second BS or PBS 62 optionally passes through or interacts with OED 63 (e.g., NOR, modulator, lens, PD, group of modulator and/or NOR and/or lens); and/or 5) overlapped vertical beam from second BS or PBS 62 is reflected by OED 61, optionally passes through OED 63, and optionally is reflected by OED 61 (e.g., mirror, NOR, modulator).

FIG. 13C illustrates an example embodiment in which 1) incoming light is split by BS or PBS 62A to two beams, with horizontal beam optionally passes through OED 41 (e.g., NOR, modulator, lens, PD, group of modulator and/or NOR and/or lens) and is split again by BS/PBS 62D; 2) vertical beam from BS or PBS 62A optionally passes through OED 63 (e.g., NOR, modulator, lens, group of modulator and/or NOR and/or lens), and is split by BS/PBS 62B to another two beams which interacts with OED 61 (e.g., mirror, NOR, modulator), optionally OED 41, then is split by BS/PBS 62C; 3) horizontal beam from BS/PBS 62C optionally interacts with OED 63 (e.g., NOR, modulator, lens, PD, group of modulator and/or NOR and/or lens), and vertical beam from BS/PBS 62C optionally passes through OED 63, then is split again by BS/PBS 62D; and/or 4) horizontal beam from BS/PBS 62D optionally interacts with OED 63, and vertical beam from BS/PBS 62D is reflected by OED 61 and optionally interacts with OED 63.

FIG. 13D illustrates an example embodiment in which 1) incoming light optionally passes through OED 63 (e.g., NOR, modulator, lens, group of modulator and/or NOR and/or lens), and is split by BS/PBS 62A to two beams; 2) horizontal beam is reflected by OED 61 (e.g., mirror, NOR, modulator), optionally passes through OED 41 (NOR, modulator, lens, group of modulator and/or NOR and/or lens), and is split again by BS/PBS 62B to two beams; 3) vertical beam from BS/PBS 62A optionally passes through OED 41, is reflected by OED 61, then is split again by BS/PBS 62B to two beams; and/or 4) overlapped two beams interacts with OED 63 (NOR, modulator, PD, lens, group of modulator and/or NOR and/or lens and/or PD).

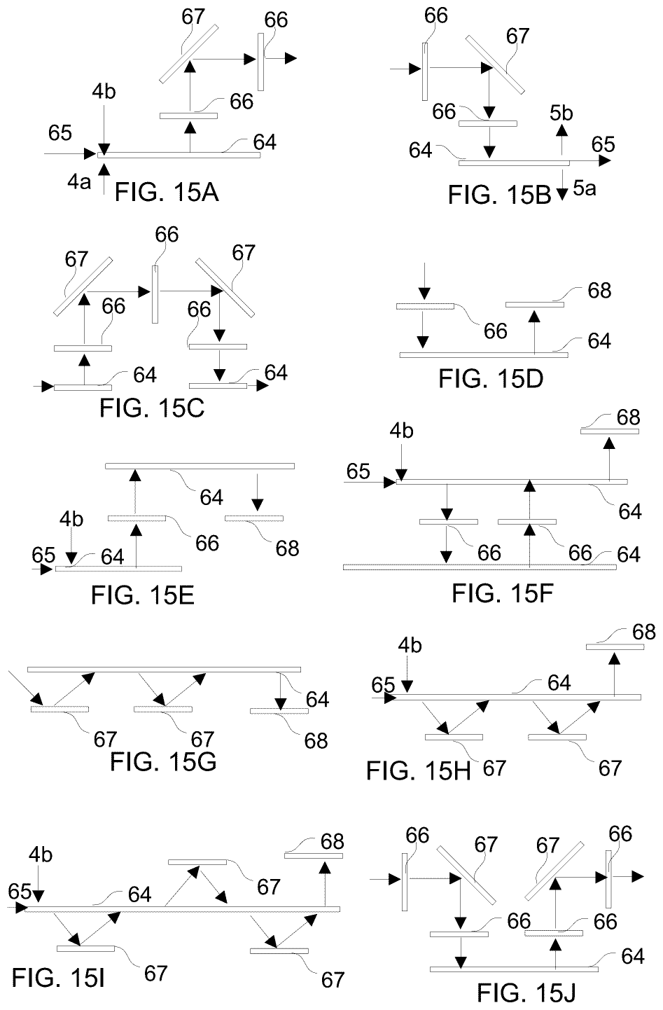

FIG. 14A-14C illustrate 3 example embodiments of spatial arrangement of OED to combine multiple beams. As will be appreciated by those skilled in the art, in some embodiments:
1) OED 61, 63A, 63B, and 63C may be same or different type of OED, IBNLT, NOR, modulator, PD, mirror, lens, polarizer, 1D/2D/3D waveguide, waveplate, diffractive optical element, geometric waveguide, diffractive waveguide (e.g., surface relief grating, volume holographic grating), grating coupler, fiber, microRing, metamaterial;
2) OED 61, 63A, 63B, and 63C may be 0D (e.g., single pixel), 1D (e.g., line or curve or sequence of pixels, 2D (e.g., array of pixels, metasurface, planar or non-planar), 3D (e.g., group or sequence of 2D layers over Z and X-Y axis);
3) OED 62 may be beam splitter (BS) or PBS;
4) OED 64 may be composed of >=1 OED, IBNLT, grating coupler, 1D/2D grating, transflective mirror, 1D/2D/3D waveguide, fiber, geometric waveguide, diffractive waveguide (e.g., surface relief grating, volume holographic grating);
5) OED 61, 63A, 63B, 63C and 64 may be composed of >=1 same or different type of OEDs spatially arranged over Z and/or X-Y axis;
6) OED 64 may be used to not only transmit light but also process optical signal using some components (e.g., microRing, MZI, directional coupler, NOR, PD, modulator, lens, metamaterial) of OED 64 when light transmit inside itself; and/or
7) certain properties (e.g., wavelength, polarization, intensity, phase, pulse [e.g., shape, duration, interval]) of multiple input light beams (>=2) may be same or different.

FIG. 14A illustrates an example embodiment in which 1) input light beam 4a and 4b optionally passes through OED 63B (e.g., NOR, modulator, lens, group of modulator and/or NOR and/or lens), and is reflected or split by BS or PBS 62A and 62B; 2) horizontal beam from BS/PBS 62A optionally passes through OED 63A (e.g., NOR, modulator, lens, group of modulator and/or NOR and/or lens), and passes through or is split by BS/PBS 62B, which is then overlapped with light from beam 4b; and/or 3) horizontal beam from BS/PBS 62B optionally passes through OED 63C (e.g., NOR, modulator, lens, group of modulator and/or NOR and/or lens).

FIG. 14B illustrates an example embodiment in which 1) light beam 4a and 4b optionally passes through OED 63A (e.g., NOR, modulator, lens, group of modulator and/or NOR and/or lens); 2) light beam 4a is reflected by OED 61 (e.g., mirror, NOR, modulator, group of modulator and/or NOR and/or mirror), then is deflected or split by BS or PBS 62; 3) light beam 4b passes through or is split by BS/PBS 62; and/or 4) overlapped horizontal beam from BS/PBS 62 optionally passes through OED 63C (e.g., NOR, modulator, lens, group of modulator and/or NOR and/or lens).

FIG. 14C illustrates an example embodiment in which: incoming light beam 4a and 4b optionally passes through OED 63B (e.g., NOR, modulator, lens, group of modulator and/or NOR and/or lens), is coupled into and combined by OED 64, optionally optical signal may be processed by some components (e.g., microRing, MZI, directional coupler, NOR, PD, modulator, lens, metamaterial) of OED 64, then light emits as output light beam 5. As will be appreciated by those skilled in the art, in some embodiments, 1) OED 64 may output multiple light beams; and/or 2) input and output light of OED 64 may be in any possible direction (e.g., upward, downward, 45 degree), and at any possible location over 1D (eg line, curve) or 2D plane of OED 64.

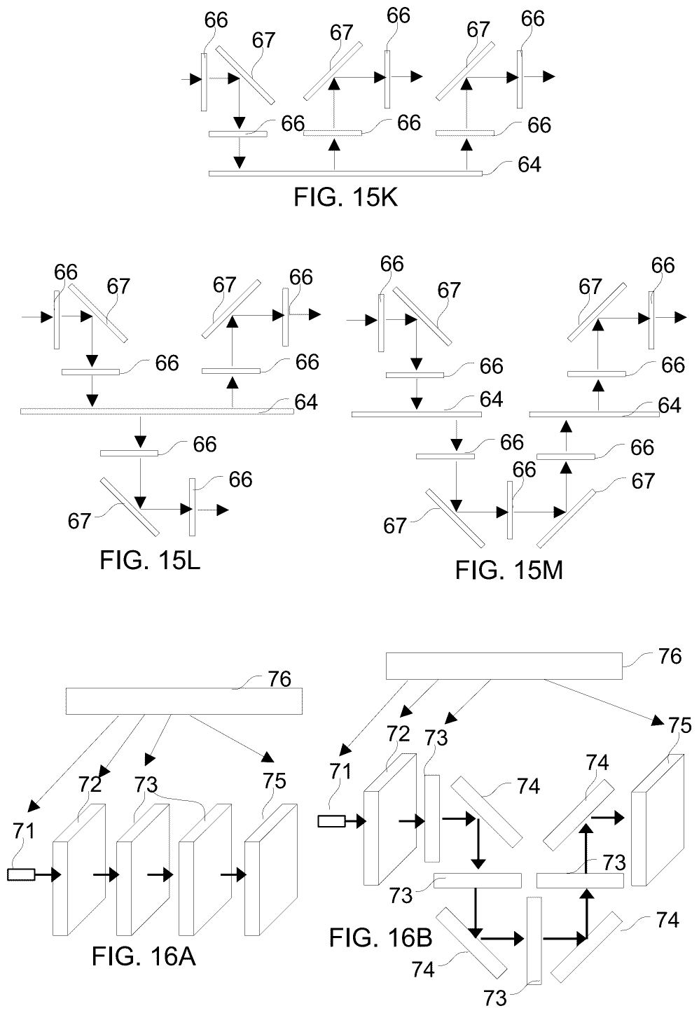

FIGS. 15A-15M illustrate 13 example embodiments of spatial arrangement of OED to route one or more light beams from one or more 1D or 2D or 3D optical components to one or more 1D or 2D or 3D optical components. As will be appreciated by those skilled in the art, in some embodiments:
1) OED 66 may be same or different type of transmissive OED (IBNLT, NOR, modulator, lens, polarizer, diffractive optical element, waveplate, metamaterial, BS or PBS); OED 67 may be same or different type of reflective OED (IBNLT, NOR, modulator, mirror, diffractive optical element, metamaterial); OED 68 may be same or different type of OED (IBNLT, NOR, modulator, PD, mirror, lens, polarizer, diffractive optical element, grating coupler, waveplate, metamaterial, BS or PBS);
2) OED 66, 67, and 68 may be 0D (e.g., single pixel), 1D (e.g., line or curve or sequence of pixels, 2D (e.g., array of pixels, metasurface, planar or non-planar), 3D (e.g., group or sequence of 2D layers over Z and X-Y axis);
3) OED 64 may be composed of >=1 OED, IBNLT, grating coupler, 1D/2D grating, transflective mirror, 1D/2D/3D waveguide, fiber, microRing, MZI, directional coupler, geometric waveguide, diffractive waveguide (e.g., surface relief grating, volume holographic grating);
4) OED 66, 67, 64 and 68 may be composed of >=1 same or different type of OEDs spatially arranged over Z and/or X-Y axis;
5) OED 64 may be used to not only transmit light but also process optical signal using some components (e.g., microRing, MZI, directional coupler, NOR, PD, modulator, lens, metamaterial) of OED 64 when light transmit inside itself;
6) input and output light of OED 64 may be in any possible direction (e.g., upward, downward, 45 degree), and at any possible location over 1D (eg line, curve) or 2D plane of OED 64; and/or
7) multiple light beams may emit from OED 64 at different locations over 1D or 2D plane of OED 64.

FIG. 15A illustrates an example embodiment to route light from 1D/2D to 3D space, in which 1) light transmits inside (e.g., light 65) and/or is coupled into (e.g., light 4a, 4b) OED 64; 2) optical signal transmits inside OED 64, optionally optical signal may be processed by some components of OED 64, then emits from OED 64, optionally passes through OED 66; and/or 3) output light is reflected by OED 67 and optionally passes through OED 66.

FIG. 15B illustrates an example embodiment to route light from 3D to 1D/2D space, in which 1) optionally light passes through OED 66, then is reflected by OED 67, optionally light passes through OED 66; 2) light is coupled into OED 64, then light transmit inside OED 64, optionally optical signal may be processed by some components of OED 64; and/or 3) light transmit inside (e.g., light 65) and/or optionally output (eg. light 5a, 5b) from OED 64.

FIG. 15C illustrates an example embodiment to route light from 1D/2D to 3D then back to 1D/2D space, in which 1) light transmits inside OED 64, optionally optical signal may be processed by some components of OED 64; 2) light emits from OED 64, optionally passes through OED 66, then is reflected by OED 67 and optionally passes through OED 66; 3) light is reflected by OED 67, optionally passes through OED 66; 4) light is coupled into second OED 64 and transmits inside second OED 64, optionally optical signal may be processed by some components of second OED 64; and/or 5) in some embodiments, first and second OED 64 may be just different segment or portion or part or component of same OED 64.

FIG. 15D illustrates an example embodiment to route light from 1D/2D to 3D then back to 1D/2D space, in which 1) optionally light passes through OED 66, and is coupled into OED 64; 2) light transmits inside OED 64, optionally optical signal may be processed by some components of OED 64; and/or 3) light emits from OED 64 at >=1 location, optionally light passes through or is received by >=1 OED 68.

FIG. 15E illustrates an example embodiment to route light from 1D/2D to 3D then back to 1D/2D space, in which 1) light transmits inside (e.g., light 65) and/or optionally is coupled into (e.g., light 4b) first OED 64, optionally optical signal may be processed by some components of first OED 64; 2) light emits from first OED 64 at >=1 location, optionally light passes through >=1 OED 66, then is coupled into second OED 64, optionally optical signal may be processed by some components of second OED 64; and/or 3) light emits from second OED 64 at >=1 location, optionally light passes through or is received by >=1 OED 68.

FIG. 15F illustrates an example embodiment to route light from 1D/2D to 3D then back to 1D/2D space, in which 1) light transmits inside (e.g., light 65) and/or optionally is coupled into (e.g., light 4b) first OED 64, optionally optical signal may be processed by some components of first OED 64; 2) light emits from first OED 64, optionally light passes through OED 66, then is coupled into second OED 64, optionally optical signal may be processed by some components of second OED 64; 3) light emits from second OED 64, optionally light passes through OED 66, then is coupled into first OED 64, optionally optical signal may be processed by some components of first OED 64; 4) light emits from first OED 64, optionally light passes through or is received by OED 68; and/or 5) step 1 to 3 may be repeated multiple times.

FIG. 15G illustrates an example embodiment to route light from 1D/2D to 3D then back to 1D/2D space, in which 1) light is reflected by OED 67, then is coupled into OED 64, optionally optical signal may be processed by some components of OED 64; 2) light emits from OED 64, then is reflected by OED 67, then is coupled into OED 64, optionally optical signal may be processed by some components of OED 64; 3) light emits from OED 64 at >=1 location, optionally light passes through or is received by >=1 OED 68; and/or 4) step 1 to 2 may be repeated multiple times.

FIGS. 15H and 15I illustrate 2 example embodiments to route light from 1D/2D to 3D then back to 1D/2D space, in which 1) light transmits inside (e.g., light 65) and/or optionally is coupled into (e.g., light 4b) OED 64, optionally optical signal may be processed by some components of OED 64; 2) light emits from OED 64, then is reflected by OED 67, then is coupled into OED 64, optionally optical signal may be processed by some components of OED 64; 3) step 2 may be repeated several times; and/or 4) light emits from OED 64 at >=1 location, optionally light passes through or is received by >=1 OED 68.

FIGS. 15J, 15K and 15L illustrate 3 example embodiments to route light from 1D/2D to 3D then back to 1D/2D space, in which 1) optionally light passes through OED 66, is reflected by OED 67, optionally light passes through OED 66; 2) light is coupled into OED 64, optionally optical signal may be processed by some components of OED 64; 3) light emits from OED 64, optionally light passes through OED 66, then is reflected by OED 67, optionally light passes through OED 66; and/or 4) multiple light beams may emit from OED 64 at different locations over 1D (line, curve) or 2D plane of OED 64, by repeating step 3.

FIG. 15M illustrates an example embodiment to route light from 1D/2D to 3D then back to 1D/2D space, in which 1) optionally light passes through OED 66, is reflected by OED 67, optionally light passes through OED 66; 2) light is coupled into first OED 64, optionally optical signal may be processed by some components of first OED 64; 3) light emits from first OED 64, optionally light passes through OED 66, then is reflected by OED 67, optionally light passes through OED 66; 4) light is reflected by OED 67, optionally light passes through OED 66, then light is coupled into second OED 64, optionally optical signal may be processed by some components of second OED 64; 5) light emits from second OED 64, optionally light passes through OED 66, then is reflected by OED 67, optionally light passes through OED 66; 6) multiple light beams may emit from second OED 64 at different locations over 1D (line, curve) or 2D plane of second OED 64, by repeating step 5; and/or 7) in some embodiments, first and second OED 64 may be just different section/segment/part/component of same OED 64.

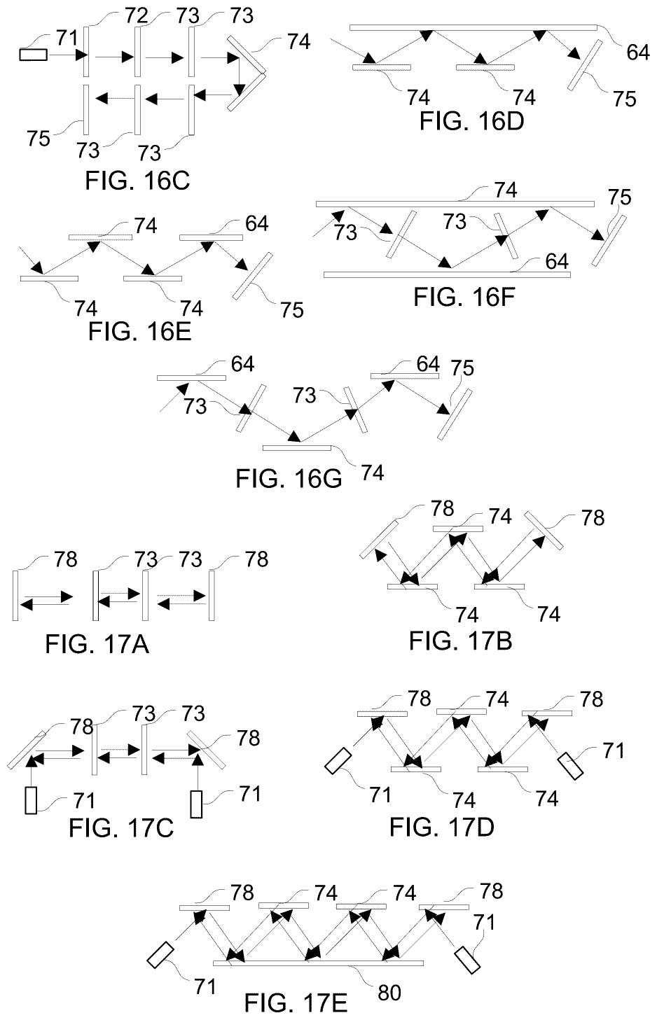

FIGS. 16A-16G illustrate 7 example embodiments of transmissive and/or reflective designs for optical sensing and computing (OSC, e.g., optical neural network [ONN], hybrid optical-electric neural network, optical matrix multiplication [OMM], optical convolution, optical computer [e.g., optical transistor, optical logic gate], quantum computing, optical sensing [e.g., Lidar, structural light], machine vision, imaging [e.g., super-resolution, microscopy], AR, VR, hologram, spatial computing, optical communication [e.g., beam steering, beam forming, encoding, decoding, switch, routing, freespace, on-chip, chip-to-chip], etc). As will be appreciated by those skilled in the art, in some embodiments:
1) OED 71 (optionally) may be any type of light source, IBNLT, sunlight, light reflected or transmitted from some objects (macro or micro), CW or pulse laser, LED, VCSEL, laser+optical amplifier (e.g., linear or nonlinear CW or spiking NOR, VCSOA), fluorescent light or lamps;
2) light from OED 71 may be continuous wave or pulse, single frequency or multiple frequencies, coherent or incoherent, polarized or non-polarized, OAM or not, frequency detuned or not, injection-locked or not, plane wave or non-plane wave, visible or invisible, patterned (e.g., 1D/2D/3D structure light, hologram, temporal and/or spatial patterned light) or not;
3) >=1 OED 72 (e.g., modulator, VCSEL, LED, CW and/or spiking NOR, with or without injection lock) is input block to encode input information (e.g., in optical domain, or from electric domain to optical domain) by spatially (e.g., over X-Y axis) and/or temporally modulating certain properties (e.g., phase, amplitude, frequency, polarization, OAM, pulse [e.g., shape, duration, interval, duration, width, position, intensity, repetition rate, pulse number]) of input light from OED 72 and/or emitted light from OED 72 itself;
4) Transmissive OED 73 and reflective OED 74 may be composed of same or different types of OEDs for optical information processing or transmitting, IBNLT, NOR, modulator (e.g., electro-optic modulator, acousto-optic modulator, plasmonic modulator, electroabsorption modulator, interferometric modulator, micromechanical modulator [e.g., nanofabricated deformable or movable mirror], metamaterial/metasurface modulator, SLM, magneto-optic modulator, MQW modulator, liquid crystal modulator, Lithium Niobate modulator, VCSEL modulator, graphene modulator, passive modulator [e.g., 3D printed, metasurface, metaline], microRing modulator, waveguide modulator, MZI modulator, phase and/or amplitude and/or polarization modulator, or a combination of amplitude and/or phase and/or polarization modulators), mirror, lens (e.g., fresnel lens, micro-lens, meta-lens, liquid lens), polarizer, waveplate, mirror, BS or PBS, optical circulator, prism, grating coupler, 1D/2D grating, transflective mirror, 1D/2D/3D waveguide, fiber, microRing, MZI, geometric waveguide, diffractive waveguide (e.g., surface relief grating, volume holographic grating), diffractive optical element, metamaterial;
5) >=1 OED 75 (e.g., CMOS or CCD image sensor, PD, avalanche PD, photomultiplier, PD+VCSEL/LED) is used to convert/decode optical information to electric domain and optionally post-process and/or store/transmit received relevant information;
6) OED 71, 72, 73, 75 and 74 may be GD (e.g., single pixel), 1D (e.g., line or curve or sequence of pixels), 2D (e.g., array of same or different type of pixels, metasurface, planar or non-planar), 3D (e.g., group or sequence of 2D layers over Z and/or X-Y axis);
7) OED 71, 72, 73, 75, and 74 may be composed of >=1 same or different type of OEDs spatially arranged over Z and/or X-Y axis;
8) controller 76 (containing >=1 component which includes but is not limited to, digital and/or analog computing devices [e.g., computer, server, inter-connect, GPU, cpu, TPU, DPU, FPGA, AI chips, chip, co-processor], memory, driver, digital-to-analog converter [DAC], analog-to-digital converter [ADC], etc) is used to control and coordinate (e.g., transmit/receive/process/store/relay/communicate information to/from) relevant OEDs (e.g., 71, 72, 73, 74, 75, 64);
9) controller 76 and/or its components may be integrated with OEDs (e.g., 71, 72, 73, 74, 75, 64) for faster information processing (e.g., in-memory computing, in-sensor or near-sensor computing, analog computing);
10) multiple set or group of OED 64, 71, 72, 73, 74 and 75 may be controlled by >=1 OED 76 to collaborate either sequentially or in parallel;
11) any possible spatial arrangement (e.g., over Z and X-Y axis, X-Y-Z axis) of a group of OED 71, 72, 73 and 75 may be used for OSC, for example (if Las for light source 71, Inp for input block OED 72, Mod for modulator, Act for NOR, Len for Lens, Fre for freespace between two consecutive layer with certain distance, Oam for optical amplifier [e.g., VCSOA, NOR], PD for sensor), Las|Fre|Inp|Fre|Mod|Fre|Act|Fre|Mod|Fre|PD, or Las|Fre|Inp|Len|Mod|Len|Act|Len|Mod|PD, or Las|Fre|Oam|Fre|Inp|Len|Mod|Len|Act|Fre|Mod|Fre|Act|Fre|PD;
12) number of pixels in same and/or different type of OEDs (e.g., 71, 72, 73, 74, 75 and 64) may be different;
13) information may be processed by some integrated computing or modulating components/blocks [e.g., microRing, MZI, modulator, NOR, PD, in-memory computing] of relevant OEDs [e.g., 72, 73, 74, 75, 76, 64] when light passes through or is reflected;
14) relevant OEDs [e.g., 71, 72, 73, 74, 75] may update its status (e.g., tunable parameters or variables or parts or components, position, angle, distance) according to relevant information (e.g., information from light source 71 and/or controller 76, information received by read-out pixels/block of OED 73/72/74/75, information post-processed by computing block/component of relevant OED [e.g., 72, 73, 74, 75, 76, 64]);
15) pixels on same layer of OED (e.g., 71, 72, 73, 75 and 74) may have same or different type and/or size and/or 2D/3D geometry (e.g., shape, width, length, height or depth or thickness);
16) top and bottom apertures of pixel on same transmissive layer of OED (e.g., 72, 73) may have same or different 2D/3D geometry (e.g., shape, size, width, length, height or depth or thickness) and/or same or different polarization control;
17) pixels on different layer of OEDs (e.g., 71, 72, 73, 75 and 74) may have same or different type and/or 2D/3D geometry and/or spatial arrangement and/or number of pixels in the same design;
18) 3D arrangement (e.g., over X-Y and Z-axis) among different OED (e.g., 71, 72, 73, 75, 64 and 74) may be either fixed or dynamically adjustable (e.g, movable, rotatable, deformable);
19) different type of NORs (e.g., transmissive NOR for layer 2/4 and reflective NOR for other layers, VCSOA NOR for layer 5/8 and RCLED for other layers, NOR1 for layer 5/9 and NOR2 for other layers) and/or modulators (e.g., SLM for layer 1/3/5 and passive modulator [e.g., 3D print, metasurface] for other layers, reflective modulator for layer 2/4 and transmissive modulator for other layers) may be used for different layer of OEDs (e.g., 73, 74) in the same design;
20) layers of OEDs (e.g., 71, 72, 73, 75, 74, 64) may be either fixed or dynamically adjustable (e.g., certain layers may be removed, certain layer of OEDs may be replaced with new OEDs of same or different type, new layers may be inserted, certain layers may be movable/rotatable/deformable); and/or
21) pixels of OEDs (e.g., 71, 72, 73, 75, 74) may be either fixed or dynamically adjustable (e.g., movable, tunable, rotatable, deformable).

FIG. 16A illustrates an example embodiment of transmissive design for optical sensing and computing, in which:
1) optionally light source 71 and/or OED 73 may update its status (e.g., tunable parameters or variables or parts or components, position, angle, distance) according to relevant information (e.g., information from controller 76, information received by read-out pixels/block of OED 73, information post-processed by computing block/component [e.g., in-memory computing] of relevant OED [e.g., 73, 75, 76]), optionally light from light source 71 may encode information from objects, optionally light may be amplified by certain component (e.g., VCSOA, NOR) of light source 71, and optionally light passes through OED 72;
2) optionally input block 72 may encode input information from electric domain to optical domain by modulating either input light from light source 71 and/or emitted light from input block 72 itself;
3) light passes through >=1 OED 73; 4) OED 75 convert/decode information from optical domain to electric domain, optionally post-process optical and/or electric signal (e.g., in-memory or in-sensor or near-sensor computing), and relevant information is retrieved or communicated to controller 76;
4) controller 76 make decision and/or communicate relevant information with OED 71, 72, 73, 75 and/or environment (e.g., graphic user interface, 3^{rd} party, another ONN); and/or
5) step 1 to 4 may be repeated multiple times.

FIG. 16B illustrates an example embodiment of transmissive and/or reflective design for optical sensing and computing, in which:
1) optionally light source 71 and/or OED 73 or 74 may update its status (e.g., tunable parameters or variables or parts or components, position, angle, distance) according to relevant information (e.g., information from controller 76, information received by read-out pixels/block of OED 73 or 74, information post-processed by computing block/component [e.g., in-memory computing] of relevant OED [e.g., 73, 74, 75, 76]), optionally light from light source 71 may encode information from objects, optionally light may be amplified by certain component (e.g., VCSOA, NOR) of light source 71, and optionally light passes through OED 72;
2) optionally input block 72 may encode input information from electric domain to optical domain by modulating either input light from light source 71 and/or emitted light from input block 72 itself;
3) light passes through (optionally) >=1 OED 73 and is reflected by >=1 OED 74; 4) OED 75 convert information from optical domain to electric domain, optionally post-process optical and/or electric signal (e.g., in-memory or in-sensor or near-sensor computing), and relevant information is retrieved or communicated to controller 76;
4) controller 76 make decision and/or communicate relevant information with OED 71, 72, 73, 74, 75 and/or environment (e.g., graphic user interface, 3^{rd} party, another ONN); and/or
5) step 1 to 4 may be repeated multiple times.

FIG. 16C illustrates an example embodiment of transmissive and reflective design for optical sensing and computing, in which:
1) optionally OED 73 and/or OED 74 may update its status (e.g., tunable parameters or variables or parts or components, position, angle, distance) according to relevant information (e.g., information from controller 76 [not shown here], information received by read-out pixels/block of OED 73 and/or OED 74, information post-processed by computing block/component [e.g., in-memory computing] of relevant OED [e.g., 73, 75, 74]), optionally light from light source 71 may encode information from objects, optionally light may be amplified by certain component (e.g., VCSOA, CW or spiking NOR) of light source 71, and optionally passes through OED 72;
2) optionally input block 72 may encode input information from electric domain to optical domain by modulating either input light from light source 71 and/or emitted light from input block 72 itself;
3) light passes through >=1 OED 73 and is reflected by OED 74 (e.g., mirror, right angle prism, geometric waveguide, diffractive waveguide, OED 73 [e.g., modulator, NOR]), optionally information may be post-processed by computing block/component [e.g., in-memory computing, MZI, microRing, directional coupler, NOR, PD] of OED 74;
4) OED 75 converts information from optical domain to electric domain, optionally post-processes optical and/or electric signal (e.g., in-memory or in-sensor or near-sensor computing), and relevant information is retrieved or communicated to controller 76; and/or
4) controller 76 makes decision and/or communicate relevant information with OED 71, 72, 73, 75 and 74.

FIGS. 16D-16E illustrates two example embodiments of reflective design for optical sensing and computing, in which:
1) optionally OED 74 may update its status (e.g., tunable parameters or variables or parts or components, position, angle, distance) according to relevant information (e.g., information from controller 76 [not shown here], information received by read-out pixels/block of OED 74, information post-processed by computing block/component [e.g., in-memory computing] of relevant OED [e.g., 74, 75, 76]), light is reflected by OED 74, then is either reflected by OED 74 (e.g., mirror, modulator, NOR) or coupled into OED 64 (e.g., geometric waveguide, diffractive waveguide), optionally light transmit inside OED 64 may be processed by computing block/component [e.g., in-memory computing, microRing, MZI, NOR]) of OED 64;
2) optionally light reflected by or emitted from OED 74 or 64 may repeat step 1 multiple times;
3) OED 75 convert light reflected by or emitted from OED 74 or 64 to electric domain, optionally post-process optical and/or electric signal (e.g., in-memory or in-sensor or near-sensor computing), and relevant information is retrieved or communicated to controller 76; and/or
4) controller 76 make decision and/or communicate relevant information with OED 74, 64 and 75.

FIGS. 16F-16G illustrates two example embodiment of transmissive and reflective design for optical sensing and computing, in which:
1) optionally OED 73 and/or OED 74 and/or OED 64 may update its status (e.g., tunable parameters or variables or parts or components, position, angle, distance) according to relevant information (e.g., information from controller 76 [not shown here], information received by read-out pixels/block of OED 73 and/or OED 74 and/or OED 64, information post-processed by computing block/component [e.g., in-memory computing] of relevant OED [e.g., 73, 74, 75, 76, 64]), light is either reflected by OED 74 (e.g., mirror, modulator, NOR) or coupled into OED 64 (e.g., geometric waveguide, diffractive waveguide), optionally light transmit inside OED 64 may be processed by computing block/component [e.g., in-memory computing, microRing, MZI, CW or spiking NOR]) of OED 64, and light reflected by OED 74 or emitted from OED 64 passes through OED 73;
2) optionally step 1 may be repeated multiple times;
3) OED 75 converts light reflected by OED 74 or emitted from OED 64 to electric domain, optionally post-processes optical and/or electric signal (e.g., in-memory or in-sensor or near-sensor computing), and relevant information is retrieved or communicated to controller 76; and/or
4) controller 76 makes decision and/or communicate relevant information with OED 73, 74, 75 and 64.

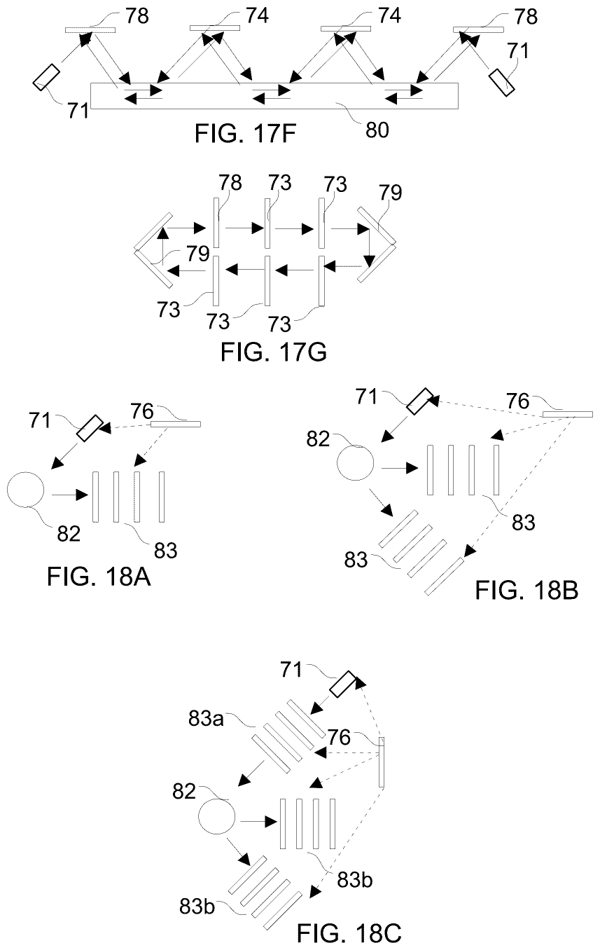

FIGS. 17A-17G illustrate 7 example embodiments of symmetric or loop-like designs for optical sensing and computing (OSC, e.g., ONN, hybrid optical-electric neural network, OMM, optical convolution, optical computer, quantum computing, optical sensing, machine vision, imaging, AR, VR, hologram, spatial computing, optical communication, etc). As will be appreciated by those skilled in the art, in some embodiments:
1) OED 71 (optionally) may be any type of light source, IBNLT, sunlight, light reflected or transmitted from some objects (macro or micro), laser, LED, VCSEL, laser+optical amplifier, fluorescent light or lamps;
2) light from light source may be continuous wave or pulse, single frequency or multiple frequency, coherent or incoherent, polarized or non-polarized, OAM or not, frequency detuned or not, injection-locked or not, plane wave or non-plane wave, visible or invisible, patterned (e.g., 1D/2D/3D structure light, hologram) or not;
3) OED 78 may be hybrid block with both input block and readout block integrated together (e.g., modulator/VCSEL/LED/NOR+PD/APD/photomultiplier/CMOS/CCD sensors), with or without injection lock, which is used to, e.g., encode input information (e.g., in optical domain, or from electric domain to optical domain) by spatially (e.g., over X-Y axis) and/or temporally modulating certain properties (e.g., phase, amplitude, frequency, polarization, OAM, pulse [e.g., shape, duration, interval, width, repetition rate, pulse number, intensity, phase, position]) of input light or emitted light from OED 78 itself, convert optical information to electric domain and optionally post-process and/or store/transmit received information;
4) OED 73, 74, 78, 79 and 80 may be composed of same or different types of OEDs for optical information processing or transmitting, IBNLT, CW or spiking NOR, modulator, mirror, lens, polarizer, mirror, BS or PBS, optical circulator, prism, grating coupler, 1D/2D grating, transflective mirror, 1D/2D/3D waveguide, fiber, microRing, MZI, geometric waveguide, diffractive waveguide; OED 73 is transmissive OED, OED 74 is reflective OED;
5) OED 71, 78, 73, 74, 79 and 80 may be GD (e.g., single pixel), 1D (e.g., line or curve or sequence of pixels), 2D (e.g., array of same or different type of pixels, metasurface, planar or non-planar), 3D (e.g., group or sequence of 2D layers over Z and/or X-Y axis);
6) OED 71, 78, 73, 74, 79 and 80 may be composed of >=1 same or different type of OEDs spatially arranged over Z and/or X-Y axis;
7) controller 76 (not shown in FIG., containing >=1 component which includes but is not limited to, digital and/or analog computing devices [e.g., computer, server, inter-connect, GPU, cpu, TPU, DPU, FPGA, AI chips, chip, co-processor], memory, driver, digital-to-analog converter [DAC], analog-to-digital converter [ADC], etc) is used to control and coordinate (e.g., transmit/receive/process/store/relay/communicate information to/from) relevant OEDs (e.g., 71, 78, 73, 74, 79, 80);
8) controller 76 and/or its components may be integrated with OEDs (e.g., 71, 78, 73, 74, 79, 80) for faster information processing (e.g., in-memory computing, in-sensor or near-sensor computing, analog computing);
9) multiple set or group of OED 71, 78, 73, 74, 79 and 80 may be controlled by >=1 OED 76 to collaborate either sequentially or in parallel;
10) number of pixels in same and/or different type of OEDs (e.g., 71, 78, 73, 74, 79, 80) may be different;
11) information may be processed by some integrated computing or modulating components/blocks [e.g., microRing, MZI, modulator, NOR, PD, in-memory computing] of relevant OEDs [e.g., 71, 78, 73, 74, 79, 80, 76] when light passes through or is reflected; and/or
12) relevant OEDs [e.g., 71, 78, 73, 74, 79, 80] may update its status (e.g., tunable parameters or variables or parts or components, position, angle, distance) according to relevant information (e.g., information from light source 71 and/or controller 76, information received by read-out pixels/block of OED 73/74/78/79/80, information post-processed by computing block/component of relevant OED [e.g., 78, 73, 74, 76, 79, 80]).

FIGS. 17A-17B illustrates 2 example embodiments of symmetric transmissive or reflective optical sensing and computing, in which:
1) optionally OED 78 73 and 74 and may update its status (e.g., tunable parameters or variables or parts or components, position, angle, distance) according to relevant information (e.g., information from controller 76 [not shown here], information received by read-out pixels/block of OED 73/74/78, information post-processed by computing block/component [e.g., in-memory computing] of relevant OED [e.g., 78, 73, 74, 76]), OED 78 emits light encoded with relevant information from electric domain (e.g., information from OED 76, information received from read-out pixels/blocks of OED 78/73/74, information post-processed by computing block/component pf OED 78/73/74);
2) light passes through OED 73 or is reflected by OED 74 multiple times, optionally information may be processed by some components [e.g., microRing, MZI, modulator, CW or spiking NOR, PD] of OED 73/74, OED 78 convert light to electric domain, optionally OED 78 post-process optical and/or electric signal (e.g., in-memory or in-sensor or near-sensor computing), optionally relevant information is retrieved or communicated to relevant OEDs (e.g., 76, 73, 74, 78);
3) optionally OED 78 and 73/74 may update its status (e.g., tunable parameters or variables or parts or components, position, angle, distance) according to relevant information (e.g., information from OED 76, information received from read-out pixels/blocks of OED 78/73/74, information post-processed by computing block/component pf OED 78/73/74), OED 78 emits light encoded with relevant information from electric domain (e.g., information from OED 76, information received from read-out pixels/blocks of OED 78/73/74, information post-processed by computing block/component pf OED 78/73/74);
4) light passes through OED 73 or is reflected by OED 74 multiple times, optionally information may be processed by some components of OED 73/74; 5) OED 78 convert light to electric domain, optionally post-process optical and/or electric signal (e.g., in-memory or in-sensor or near-sensor computing), optionally relevant information is retrieved or communicated to relevant OEDs (e.g., 76, 73, 74, 78); 6) step 1 to 5 may be repeated multiple times.

FIG. 17C-17D illustrates 2 example embodiments of symmetric transmissive or reflective optical sensing and computing, in which:
1) optionally OED 71, 78 and 73/74 may update its status (e.g., tunable parameters or variables or parts or components, position, angle, distance) according to relevant information (e.g., information from OED 71 and controller 76 [not shown here], information received by read-out pixels/block of OED 73/74/78, information post-processed by computing block/component [e.g., in-memory computing] of relevant OED [e.g., 78, 73/74, 76]), optionally light from light source 71 may encode information from objects, optionally light may be amplified by certain component (e.g., VCSOA, CW or spiking NOR) of light source 71, light is reflected by OED 78 which encode light with relevant information from electric domain (e.g., information from OED 76, information received from read-out pixels/blocks of OED 78/73/74, information post-processed by computing block/component [e.g., in-memory computing] of relevant OED [e.g., 78, 73/74, 76]);
2) light passes through OED 73 or is reflected by OED 74 multiple times, optionally information may be processed by some components [e.g., microRing, MZI, modulator, CW or spiking NOR, PD] of OED 73/74, OED 78 convert light to electric domain, optionally post-process optical and/or electric signal (e.g., in-memory or in-sensor or near-sensor computing), optionally relevant information is retrieved or communicated to relevant OEDs (e.g., 76, 71, 73/74, 78);
3) optionally OED 71, 78 and 73/74 may update its status according to relevant information, optionally light from light source 71 may encode information from objects, optionally light may be amplified by certain component of light source 71, light is reflected by OED 78 which encode light with relevant information from electric domain;
4) light passes through OED 73 or is reflected by OED 74 multiple times, optionally information may be processed by some components of OED 73/74;
5) OED 78 converts light to electric domain, optionally post-processes optical and/or electric signal (e.g., in-memory or in-sensor or near-sensor computing), optionally relevant information is retrieved or communicated to relevant OEDs (e.g., 76, 71, 73/74, 78); and/or
6) step 1 to 5 may be repeated multiple times.

FIG. 17E-17F illustrates 2 example embodiments of symmetric reflective optical sensing and computing, in which:
1) optionally OED 71, 78, 74 and 80 may update its status (e.g., tunable parameters or variables or parts or components, position, angle, distance) according to relevant information (e.g., information from OED 71 and controller 76 [not shown here], information received by read-out pixels/block of OED 74/78, information post-processed by computing block/component [e.g., in-memory computing, MZI, microRing, modulator, CW or spiking NOR] of relevant OED [e.g., 78, 74, 76, 80]), optionally light from light source 71 may encode information from objects, optionally light may be amplified by certain component (e.g., VCSOA, CW or spiking NOR) of light source 71, light is reflected by OED 78 which encode light with relevant information from electric domain (e.g., information from OED 76, information received from read-out pixels/blocks of OED 78/74, information post-processed by computing block/component [e.g., in-memory computing, MZI, microRing, modulator, CW or spiking NOR] of relevant OED [e.g., 78, 74, 76, 80]);
2) light is reflected or coupled into OED 80 (e.g., modulator, NOR, mirror, geometric waveguide, diffractive waveguide), optionally information may be processed by some components [e.g., microRing, MZI, modulator, NOR, PD] of OED 80, optionally OED 80 may communicate relevant information to relevant OEDs (e.g., 76, 71, 78, 74,), light reflected or emitted from OED 80 is reflected by OED 74 and 80 multiple times, optionally information may be processed by some components [e.g., microRing, MZI, modulator, NOR, PD] of OED 74/80, OED 78 convert light to electric domain, optionally OED 78 post-process optical and/or electric signal (e.g., in-memory or in-sensor or near-sensor computing), optionally OED 78 may communicate relevant information to relevant OEDs (e.g., 76, 71, 78, 74, 80);
3) optionally OED 71, 78, 74 and 80 may update its status according to relevant information, optionally light from light source 71 may encode information from objects, optionally light may be amplified by certain component of light source 71, light is reflected by OED 78 which encode light with relevant information from electric domain;
4) light is reflected or coupled into OED 80, optionally information may be processed by some components of OED 80, light reflected or emitted from OED 80 is reflected by OED 74 and 80 multiple times, optionally information may be processed by some components of OED 74/80;
5) OED 78 converts light to electric domain, optionally post-processes optical and/or electric signal (e.g., in-memory or in-sensor or near-sensor computing), optionally OED 78 may communicate relevant information to relevant OEDs (e.g., 76, 71, 78, 74, 80); and/or
6) step 1 to 5 may be repeated multiple times.

FIG. 17G illustrates an example embodiments of loop-like transmissive and reflective optical sensing and computing, in which:
1) optionally OED 78, 73, 79 may update its status (e.g., tunable parameters or variables or parts or components, position, angle, distance) according to relevant information (e.g., information from controller 76 [not shown here], information received by read-out pixels/block of OED 73/78/79, information post-processed by computing block/component [e.g., in-memory computing] of relevant OED [e.g., 78, 73, 79, 76]), OED 78 emits light encoded with relevant information from electric domain (e.g., information from OED 76, information received by read-out pixels/block of OED 73/78/79, information post-processed by computing block/component [e.g., in-memory computing] of relevant OED [e.g., 78, 73, 79, 76]);
2) light passes through OED 73 multiple times, optionally information may be processed by some components [e.g., microRing, MZI, modulator, NOR, PD] of OED 73, light is reflected or coupled into OED 79 (e.g., mirror, right-angle prism, geometric waveguide, 2D waveguide, diffractive waveguide, OED 73 [e.g., modulator, NOR]), optionally information may be processed by some components [e.g., microRing, MZI, modulator, CW or spiking NOR, PD] of OED 79, light reflected or emitted from OED 79 passes through OED 73 multiple times, optionally information may be processed by some components of OED 73, optionally OED 73/79 may communicate relevant information to relevant OEDs (e.g., 76, 78, 73, 79);
3) OED 78 converts light reflected or emitted from OED 79 to electric domain, optionally post-processes optical and/or electric signal (e.g., in-memory or in-sensor or near-sensor computing), optionally relevant information is retrieved or communicated to relevant OEDs (e.g., 76, 78, 73, 79); and/or
4) step 1 to 3 may be repeated multiple times.

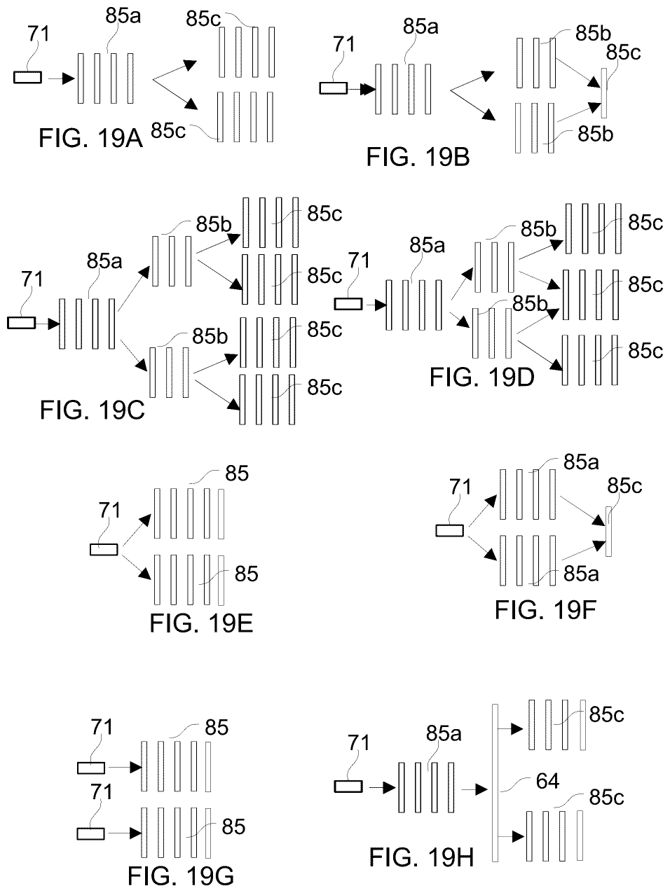

FIG. 18A-18C schematically illustrate 3 example embodiments of design for optical sensing and computing (OSC, e.g., ONN, hybrid optical-electric neural network, OMM, optical convolution, optical computer, quantum computing, optical sensing, machine vision, imaging, AR, VR, hologram, spatial computing, optical communication, etc). As will be appreciated by those skilled in the art, in some embodiments:
1) OED 71 may be any type of light source, IBNLT, sun light, laser, LED, VCSEL, laser+optical amplifier, fluorescent light or lamps;
2) light from light source may be continuous wave or pulse, single frequency or multiple frequency, coherent or incoherent, polarized or non-polarized, OAM or not, frequency detuned or not, injection-locked or not, plane wave or non-plane wave, visible or invisible, patterned (e.g., 1D/2D/3D structure light, hologram) or not;
3) scene 82 may be composed of >=1 macro-sized and/or micro-sized, steady and/or non-steady (e.g., moving, rotating, deforming, interacting) objects;
4) OSC 83, 83a and 83b are same or different type of OSCs, which may be composed of same or different types of OEDs for optical information encoding or processing or computing or decoding or transmitting, IBNLT, NOR, modulator, mirror, lens, micro-lens, meta-lens, polarizer, mirror, BS or PBS, optical circulator, prism, grating coupler, 1D/2D grating, transflective mirror, 1D/2D/3D waveguide, fiber, microRing, MZI, geometric waveguide, diffractive waveguide;
5) OEDs used in OSC 83, 83a and 83b may be 0D (e.g., single pixel), 1D (e.g., line or curve or sequence of pixels), 2D (e.g., array of same or different type of pixels, metasurface, planar or non-planar), 3D (e.g., group or sequence of 2D layers over Z and/or X-Y axis);
6) OEDs used in OSC 83/83a/83b may be composed of >=1 same or different type of OEDs spatially arranged over Z and/or X-Y axis;
7) optionally optical amplifier (eg. VCSOA, NOR) and/or sensor (e.g., PD, APD, CMOS, CCD, camera, time-of-flight camera) may be used to either amplify light from object or convert light from optical to electric domain, before supplied to OSC 83 or 83a or 83b;
8) controller 76 (e.g., digital and/or analog computing devices [e.g., computer, server, inter-connect, GPU, cpu, FPGA, AI chips, chip, co-processor, ONN] is used to control and coordinate (e.g., transmit/receive/process/store/encode/decode information to/from) relevant OEDs (OED 71, OEDS of OSC 83/83a/83b);
9) controller 76 or its components may be integrated with relevant OEDs (OED 71, OSC of ONN 83/83a/83b) for faster information processing (e.g., in-memory computing, in-sensor or near-sensor computing, analog computing); and/or
10) multiple set of OED 71, OSC 83/83a/83b may be controlled by >=1 OED 76 to collaborate either sequentially or in parallel.

FIGS. 18A and 18B illustrate 2 example embodiments in which:
1) optionally OSC 83 may update its status (e.g., tunable parameters or variables or parts or components, position, angle, distance) according to relevant information (e.g., environmental info [e.g., position, speed, time], information from light source 71 and/or controller 76, information received by ONN 83, information post-processed by computing block/component [e.g., in-memory computing] of OSC 83), optionally scene 82 may update its status (e.g., position, angle, distance, shape, speed, components);
2) optionally, light source 71 may update its status (e.g., tunable parameters or variables or parts or components, position, angle, distance, speed) according to relevant information (e.g., environmental info [e.g., position, speed, time], information from controller 76, information received by OSC 83, information post-processed by computing block/component of OSC 83), directs light to scene 82, and light transmits and/or is reflected from scene 82;
3) optionally light emitted and/or transmitted and/or reflected from scene 82 may be amplified optically by optical amplifier (e.g., VCSOA, NOR, ONN) and/or converted to electric domain by sensor (e.g., PD, APD, CMOS, CCD, time-of-flight camera), before supplied to OSC 83;
4) information encoded in light is then processed by >=1 OSC 83, optionally relevant information is retrieved or communicated with controller 76, optionally controller 76 make decision and/or communicate relevant information with light source 71, OSC 83 and/or environment (e.g., graphic user interface, 3^{rd} party, another OSC); and/or
5) step 1 to 4 may be repeated multiple times.

FIG. 18C illustrate an example embodiment in which:
1) optionally OSC 83a and 83b may update its status (e.g., tunable parameters or variables or parts or components, position, angle, distance) according to relevant information (e.g., environmental info [e.g., position, speed, time], information from light source 71 and/or controller 76, information received by OSC 83a and 83b, information post-processed by computing block/component of OSC 83a and 83b), optionally scene 82 may update its status (e.g., position, angle, distance, shape, speed, components);
2) optionally light source 71 may be used and update its status according to relevant information, optionally light from light source 71 may be amplified optically by optical amplifier (e.g., VCSOA, NOR, ONN) and/or converted to electric domain by sensor (e.g., PD, APD, CMOS, CCD, time-of-flight camera), before supplied to OSC 83a/83b;
3) optionally >=1 OSC 83a may be used, optionally >=1 OSC 83a encode and direct light to scene 82, and light transmits and/or is reflected from scene 82;
4) optionally light emitted and/or transmitted and/or reflected from scene 82 may be amplified optically by optical amplifier and/or converted to electric domain by sensor, before supplied to OSC 83b;
5) information encoded in light is then processed by >=1 OSC 83b, optionally relevant information is retrieved or communicated with controller 76, optionally controller 76 make decision and/or communicate relevant information with light source 71, OSC 83a, 83b and/or environment (e.g., graphic user interface, 3^{rd} party, another OSC); and/or
6) step 1 to 5 may be repeated multiple times.

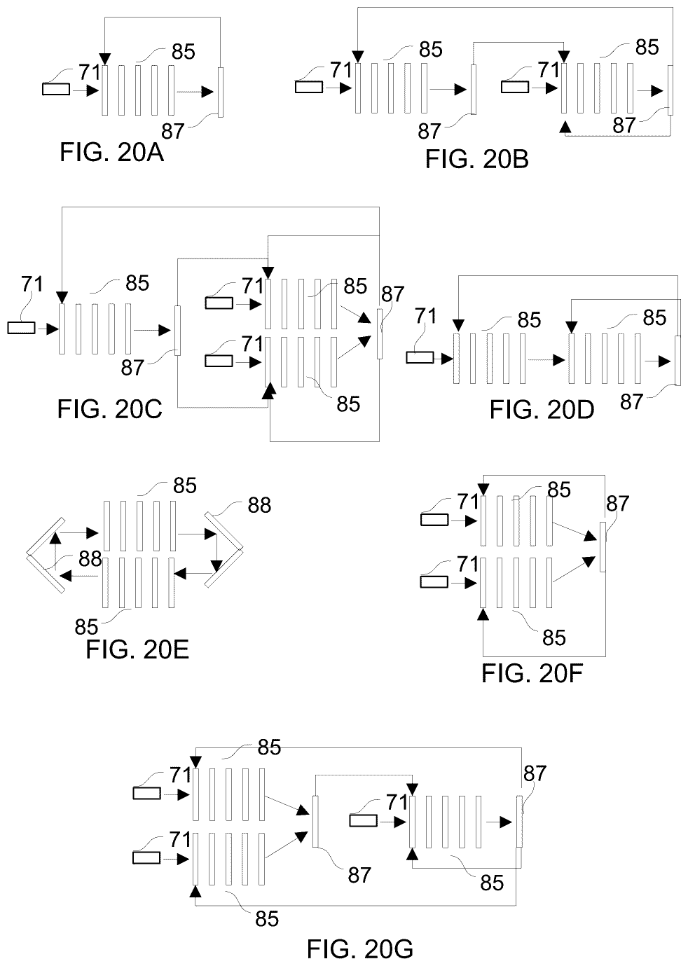

FIG. 19A-19H schematically illustrates 8 example embodiments of a parallel or tree or graph like design for single or multiple optical neural networks. As will be appreciated by those skilled in the art, in some embodiments:
1) OED 71 may be any type of light source, IBNLT, sun light, light transmitted or reflected or emitted from object or scene, laser, LED, VCSEL, laser+optical amplifier, fluorescent light or lamps;
2) light from light source may be continuous wave or pulse, single frequency or multiple frequency, coherent or incoherent, polarized or non-polarized, OAM or not, frequency detuned or not, injection-locked or not, plane wave or non-plane wave, visible or invisible, patterned (e.g., 1D/2D/3D structure light, hologram) or not, optionally object or scene may exist between OED 71 and block 85 or 85a;
3) block 85, 85a, 85b and 85c may be same or different type of OEDs or ONNs, which may be composed of same or different types of OEDs for optical information encoding or processing or decoding or transmitting, IBNLT, VCSEL, LED, NOR, modulator (e.g., SLM), mirror, lens, micro-lens, meta-lens, polarizer, mirror, BS or PBS, optical circulator, prism, grating coupler, 1D/2D grating, transflective mirror, 1D/2D/3D waveguide, fiber, microRing, MZI, geometric waveguide, diffractive waveguide (e.g., surface relief grating, volume holographic grating);
4) OEDs used in block 85, 85a, 85b and 85c and 64 may be 0D (e.g., single pixel), 1D (e.g., line or curve or sequence of pixels), 2D (e.g., array of same or different type of pixels, metasurface, planar or non-planar);
5) OEDs used in block 85, 85a, 85b and 85c and 64 may be composed of multiple same or different type of OEDs spatially arranged over Z and/or X-Y axis;
6) optionally optical amplifier (eg. VCSOA, CW or spiking NOR) and/or sensor (e.g., PD, APD, CMOS, CCD, camera) may be used to either amplify light or convert light to electric domain, before supplied to block 85, 85a, 85b and 85c and 64;
7) controller 76 (not shown here, e.g., digital and/or analog computing devices [e.g., computer, server, inter-connect, GPU, cpu, FPGA, AI chips, chip, co-processor, ONN] is used to control and coordinate (e.g., transmit/receive/process/store/encode/decode information to/from) relevant OEDs (OED 71, OEDS of block 85, 85a, 85b and 85c);
8) controller 76 or its components may be integrated with relevant OEDs (OED 71, OEDS of block 85, 85a, 85b and 85c) for faster information processing, e.g., in-memory computing, in-sensor or near-sensor computing, analog computing; and/or
9) multiple set of OED 71, block 85, 85a, 85b and 85c may be controlled by >=1 OED 76 to collaborate either sequentially or in parallel.

FIG. 19A illustrates an example embodiment in which 1) optionally block 85a and 85c may update its status (e.g., tunable parameters, position, angle) according to relevant information (e.g., environmental info [e.g., position, speed, time], information from controller 76, information received by block 85a and 85c, information post-processed by computing block [e.g., in-memory computing] of block 85a and 85c), optionally light source 71 may be used and update its status (e.g., tunable parameters, position, angle) according to relevant information (e.g., environmental info [e.g., position, speed, time], information from controller 76, information received by block 85a and 85c, information post-processed by computing block [e.g., in-memory computing] of block 85a and 85c); 2) block 85a receives and processes input light (e.g., light from light source 71, light transmitted/reflected/emitted from object or scene) and output light to block 85c, optionally relevant information is retrieved or communicated with controller 76, optionally controller 76 may make a decision; and/or 3) step 1 to 2 may be repeated multiple times.

FIG. 19B-19D illustrates 3 example embodiments in which 1) optionally block 85a, 85b and 85c may update its status (e.g., tunable parameters, position, angle) according to relevant information (e.g., environmental info [e.g., position, speed, time], information from controller 76, information received by block 85a, 85b and 85c, information post-processed by computing block [e.g., in-memory computing] of block 85a, 85b and 85c), optionally light source 71 may be used and update its status (e.g., tunable parameters, position, angle) according to relevant information (e.g., environmental info [e.g., position, speed, time], information from controller 76, information received by block 85a, 85b and 85c, information post-processed by computing block [e.g., in-memory computing] of block 85a, 85b and 85c); 2) block 85a receives and processes input light (e.g., light from light source 71, light transmitted/reflected/emitted from object or scene) and output light to block 85b which then processes and output light to block 85c, optionally relevant information is retrieved or communicated with controller 76, optionally controller 76 may make a decision; and/or 3) step 1 to 2 may be repeated multiple times.

FIGS. 19E-19F illustrate 2 example embodiments in which 1) optionally block 85, 85a, and 85c may update its status (e.g., tunable parameters, position, angle) according to relevant information (e.g., environmental info [e.g., position, speed, time], information from controller 76, information received by block 85, 85a, and 85c, information post-processed by computing block [e.g., in-memory computing] of block 85, 85a, and 85c), optionally light source 71 may be used and update its status (e.g., tunable parameters, position, angle) according to relevant information (e.g., environmental info [e.g., position, speed, time], information from controller 76, information received by block 85, 85a, and 85c, information post-processed by computing block [e.g., in-memory computing] of block 85, 85a, and 85c); 2) block 85 or 85a receives and processes input light (e.g., light from light source 71, light transmitted/reflected/emitted from object or scene) and optionally output light to block 85c, optionally relevant information is retrieved or communicated with controller 76, optionally controller 76 may make a decision; and/or 3) step 1 to 2 may be repeated multiple times.

FIG. 19G illustrates an example embodiment in which 1) optionally block 85 may update its status (e.g., tunable parameters, position, angle) according to relevant information (e.g., environmental info [e.g., position, speed, time], information from controller 76, information received by block 85, information post-processed by computing block [e.g., in-memory computing] of block 85), optionally light source 71 may be used and update its status (e.g., tunable parameters, position, angle) according to relevant information (e.g., environmental info [e.g., position, speed, time], information from controller 76, information received by block 85, information post-processed by computing block [e.g., in-memory computing] of block 85); 2) optionally light source 71 may be injection-locked, block 85 receives and processes input light (e.g., light from light source 71, light transmitted/reflected/emitted from object or scene), optionally relevant information is retrieved or communicated with controller 76, optionally controller 76 may make a decision; and/or 3) step 1 to 2 may be repeated multiple times.

FIG. 19H illustrates an example embodiment in which 1) optionally block 85a and 85c may update its status (e.g., tunable parameters, position, angle) according to relevant information (e.g., environmental info [e.g., position, speed, time], information from controller 76, information received by block 85a and 85c, information post-processed by computing block [e.g., in-memory computing] of block 85a and 85c), optionally light source 71 may be used and update its status (e.g., tunable parameters, position, angle) according to relevant information (e.g., environmental info [e.g., position, speed, time], information from controller 76, information received by block 85a and 85c, information post-processed by computing block [e.g., in-memory computing] of block 85a and 85c); 2) block 85a receives and processes input light (e.g., light from light source 71, light transmitted/reflected/emitted from object or scene) and output light to be coupled into block 64 (e.g., grating coupler, 1D/2D waveguide, geometric waveguide, diffractive waveguide, optionally information may be processed by some components [e.g., microRing, MZI, NOR, PD] inside block 64), which then output light to block 85c for processing, optionally relevant information is retrieved or communicated with controller 76, optionally controller 76 may make a decision; and/or 3) step 1 to 2 may be repeated multiple times.

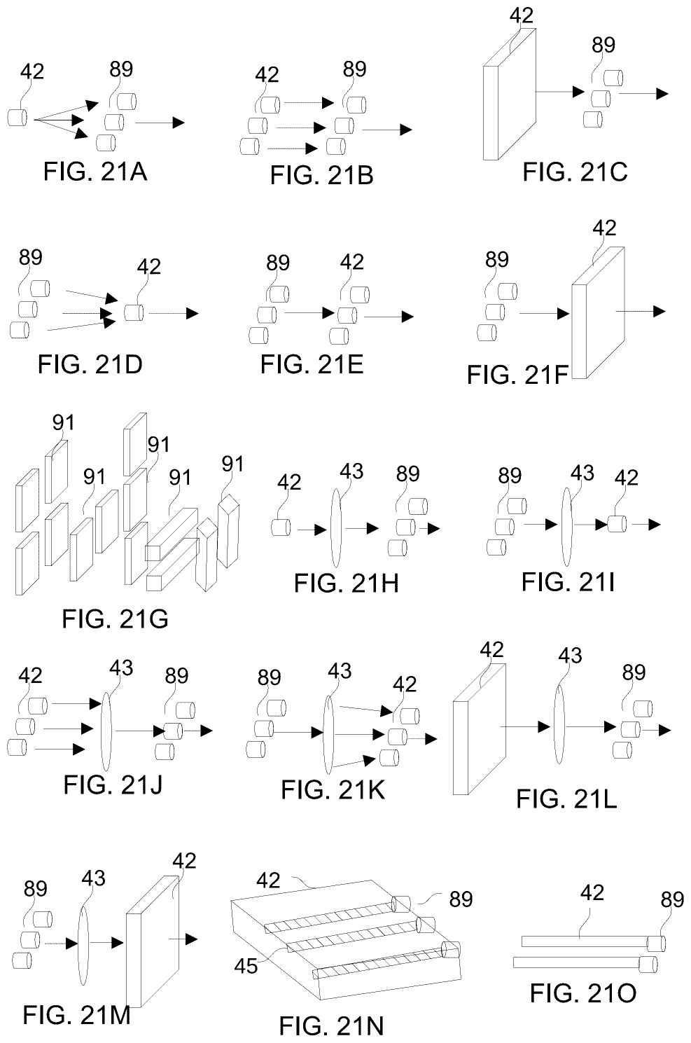

FIG. 20A-20G schematically illustrate 7 example embodiments of topological layout or design (e.g., sequential, parallel, symmetric or loop-like, tree, cyclic, acyclic) for interactions or collaborations among >=1 optical neural networks. As will be appreciated by those skilled in the art, in some embodiments:
1) OED 71 may be any type of light source, IBNLT, sun light, light transmitted or reflected or emitted from object or scene, laser, LED, VCSEL, laser+optical amplifier, fluorescent light or lamps;
2) light from light source may be continuous wave or pulse, single frequency or multiple frequency, coherent or incoherent, polarized or non-polarized, OAM or not, frequency detuned or not, injection-locked or not, plane wave or non-plane wave, visible or invisible, patterned (e.g., 1D/2D/3D structure light, hologram) or not, optionally object or scene 82 may exist between OED 71 and ONN 85;
3) ONN 85 may be same or different type of ONNs, which may be composed of same or different types of OEDs for optical information encoding or processing or decoding or transmitting, IBNLT, VCSEL, LED, NOR, modulator (e.g, active [e.g., SLM] or passive [e.g., 3D print, metasurface], phase and/or amplitude modulation), mirror, lens, micro-lens, meta-lens, polarizer, mirror, BS or PBS, optical circulator, prism, grating coupler, 1D/2D grating, transflective mirror, 1D/2D/3D waveguide, fiber, microRing, MZI, geometric waveguide, diffractive waveguide (e.g., surface relief grating, volume holographic grating); block 88 may be composed of same or different types of OEDs (e.g., mirror, modulator [e.g., SLM], NOR, right-angle prism, grating coupler, 2D waveguide, geometric waveguide, diffractive waveguide, interconnect, optionally information may be processed by computing block [e.g., in-memory computing] of block 88);
4) block 87 (e.g., mirror, lens, micro-lens, meta-lens, polarizer, mirror, BS or PBS, optical circulator, prism, grating coupler, 1D/2D grating, transflective mirror, 1D/2D/3D waveguide, fiber, microRing, MZI, geometric waveguide, diffractive waveguide, interconnect) is used to interconnect same or different ONN 85, optionally under the direction or control of controller 76 (not shown here), optionally information may be processed by some components [e.g., microRing, MZI, NOR, PD] inside block 87;
5) OEDs used in ONN 85, block 87 and 88 may be GD (e.g., single pixel), 1D (e.g., line or curve or sequence of pixels), 2D (e.g., array of same or different type of pixels, metasurface, planar or non-planar);
6) OEDs used in ONN 85, block 87 and 88 may be composed of multiple same or different type of OEDs spatially arranged over Z and/or X-Y axis;
7) optionally optical amplifier (eg. VCSOA, NOR) and/or sensor (e.g., PD, APD, CMOS, CCD, camera) may be used to either amplify light or convert light to electric domain, before supplied to ONN 85, block 87 and 88;
8) controller 76 (not shown here, e.g., digital and/or analog computing devices [e.g., computer, server, inter-connect, GPU, cpu, FPGA, AI chips, chip, co-processor, ONN, ENN] is used to control and coordinate (e.g., transmit/receive/process/store/encode/decode information to/from) relevant OEDs (OED 71, OEDs of ONN 85, block 87 and 88);
9) controller 76 or its components may be integrated with relevant OEDs (OED 71, OEDS of ONN 85, block 87 and 88) for faster information processing, e.g., in-memory computing, in-sensor or near-sensor computing, analog computing; and/or
10) multiple set of OED 71, ONN 85, block 87 and 88 may be controlled by >=1 OED 76 to collaborate either sequentially or in parallel.

FIG. 20A illustrate an example embodiment of loop-like interaction using single ONN, in which:
1) optionally ONN 85 and block 87 may update its status (e.g., tunable parameters, position, angle) according to relevant information (e.g., environmental info [e.g., position, speed, time], information from OED 76 (not shown here), information received by ONN 85 and block 87, information post-processed by computing block [e.g., in-memory computing] of ONN 85 and block 87), optionally light source 71 may be used and update its status (e.g., tunable parameters, position, angle) according to relevant information (e.g., environmental info [e.g., position, speed, time], information from OED 76, information received by ONN 85 and block 87, information post-processed by computing block [e.g., in-memory computing] of ONN 85 and block 87), optionally object or scene 82 (not shown here) may update is status (e.g., position, shape, speed, components);
2) ONN 85 receives and processes input light (e.g., light from light source 71, light transmitted/reflected/emitted from object or scene 82);
3) block 87 (e.g., fiber, microRing, grating coupler, 1D/2D waveguide, geometric waveguide, diffractive waveguide, optionally information may be processed by some components [e.g., microRing, MZI, NOR, PD] inside block 87) receive and transmit relevant information (e.g., optical signal, electric signal) back to ONN 85, optionally relevant information is communicated with or processed by controller 76, optionally controller 76 may make a decision; and/or
4) step 1 to 3 may be repeated multiple times.

FIGS. 20B and 20C illustrate 2 example embodiment of interaction among multiple ONNs, in which:
1) optionally ONN 85 and block 87 may update its status (e.g., tunable parameters, position, angle) according to relevant information (e.g., environmental info [e.g., position, speed, time], information from OED 76 (not shown here), information received by ONN 85 and block 87, information post-processed by computing block [e.g., in-memory computing] of ONN 85 and block 87), optionally light source 71 may be used and update its status (e.g., tunable parameters, position, angle) according to relevant information (e.g., environmental info [e.g., position, speed, time], information from OED 76, information received by ONN 85 and block 87, information post-processed by computing block [e.g., in-memory computing] of ONN 85 and block 87), optionally object or scene 82 (not shown here) may update is status (e.g., position, shape, speed, components);
2) ONN 85 receives and processes input light (e.g., light from light source 71, light transmitted/reflected/emitted from object or scene 82);
3) block 87 (e.g., fiber, microRing, grating coupler, 1D/2D waveguide, geometric waveguide, diffractive waveguide, optionally information may be processed by some components [e.g., microRing, MZI, NOR, PD] inside block 87) receive and transmit relevant information (e.g., optical signal, electric signal) to other >=1 ONN 85, optionally relevant information is communicated with or processed by controller 76, optionally controller 76 may make a decision;
4) ONN 85 receives and processes relevant information from block 87, then block 87 receive and transmit relevant information (e.g., optical signal, electric signal) back to first ONN 85, optionally relevant information is communicated with or processed by controller 76, optionally controller 76 may make a decision; and/or
5) step 1 to 4 may be repeated multiple times.

FIG. 20D illustrates an example embodiment of interaction among multiple ONNs, in which:
1) optionally ONN 85 and block 87 may update its status (e.g., tunable parameters, position, angle) according to relevant information (e.g., environmental info [e.g., position, speed, time], information from OED 76 (not shown here), information received by ONN 85 and block 87, information post-processed by computing block [e.g., in-memory computing] of ONN 85 and block 87), optionally light source 71 may be used and update its status (e.g., tunable parameters, position, angle) according to relevant information (e.g., environmental info [e.g., position, speed, time], information from OED 76, information received by ONN 85 and block 87, information post-processed by computing block [e.g., in-memory computing] of ONN 85 and block 87), optionally object or scene 82 (not shown here) may update is status (e.g., position, shape, speed, components);
2) ONN 85 receives and processes input light (e.g., light from light source 71, light transmitted/reflected/emitted from object or scene 82);
3) ONN 85 transmit relevant information (e.g., optical signal, electric signal) directly to other >=1 ONN 85, optionally relevant information is communicated with or processed by controller 76, optionally controller 76 may make a decision;
4) block 87 receive and transmit relevant information (e.g., optical signal, electric signal) back to first and/or other ONN 85, optionally relevant information is communicated with or processed by controller 76, optionally controller 76 may make a decision; and/or
5) step 1 to 4 may be repeated multiple times.

FIG. 20E illustrates an example embodiment of interaction among multiple ONNs, in which:
1) optionally ONN 85 and block 88 may update its status (e.g., tunable parameters, position, angle) according to relevant information (e.g., environmental info [e.g., position, speed, time], information from OED 76 (not shown here), information received by ONN 85 and block 88, information post-processed by computing block [e.g., in-memory computing] of ONN 85 and block 88), optionally object or scene 82 (e.g., between ONN 85 and block 88, not shown here) may update is status (e.g., position, shape, speed, components);
2) ONN 85 receives relevant information (e.g., information from controller 76), and processes input light (e.g., light from block 88, light transmitted/reflected/emitted from object or scene 82), input light may be converted to electric domain by some component (e.g., PD, hybrid PD+VCSEL/LED) of first layer of ONN 85 in some embodiments; ONN 85 may encode and emit light by its input block (e.g., VCSEL/LED, PD+VCSEL/LED) in some embodiments;
3) block 88 (e.g., mirror, modulator [e.g., SLM], NOR, right-angle prism, grating coupler, 2D waveguide, geometric waveguide, diffractive waveguide, interconnect, optionally information may be processed by computing block [e.g., in-memory computing] of block 88) transmits relevant information (e.g., optical signal, electric signal) from first ONN 85 to other >=1 ONN 85, optionally relevant information is communicated with or processed by controller 76, optionally controller 76 may make a decision;
4) block 88 transmits relevant information (e.g., optical signal, electric signal) from other ONN 85 to first ONN 85, optionally relevant information is communicated with or processed by controller 76, optionally controller 76 may make a decision; and/or
5) step 1 to 4 may be repeated multiple times.

FIG. 20F illustrates an example embodiment of interaction among multiple ONNs, in which:
1) optionally ONN 85 and block 87 may update its status (e.g., tunable parameters, position, angle) according to relevant information (e.g., environmental info [e.g., position, speed, time], information from controller 76 (not shown here), information received by ONN 85 and block 87, information post-processed by computing block [e.g., in-memory computing] of ONN 85 and block 87), optionally light source 71 may be used and update its status (e.g., tunable parameters, position, angle) according to relevant information (e.g., environmental info [e.g., position, speed, time], information from controller 76, information received by ONN 85 and block 87, information post-processed by computing block [e.g., in-memory computing] of ONN 85 and block 87), optionally object or scene 82 (not shown here) may update is status (e.g., position, shape, speed, components);
2) ONN 85 receives and processes input light (e.g., light from light source 71, light transmitted/reflected/emitted from object or scene 82);
3) block 87 (e.g., fiber, microRing, grating coupler, 1D/2D waveguide, geometric waveguide, diffractive waveguide, interconnect, optionally information may be processed by some components [e.g., microRing, MZI, NOR, PD] inside block 87) receives and transmits relevant information (e.g., optical signal, electric signal) back to ONN 85, optionally relevant information is communicated with or processed by controller 76, optionally controller 76 may make a decision; and/or

4) step 1 to 3 may be repeated multiple times.

FIG. 20G illustrates an example embodiment of interaction among multiple ONNs, in which:
1) optionally ONN 85 and block 87 may update its status (e.g., tunable parameters, position, angle) according to relevant information (e.g., environmental info [e.g., position, speed, time], information from controller 76 (not shown here), information received by ONN 85 and block 87, information post-processed by computing block [e.g., in-memory computing] of ONN 85 and block 87), optionally light source 71 may be used and update its status (e.g., tunable parameters, position, angle) according to relevant information (e.g., environmental info [e.g., position, speed, time], information from OED 76, information received by ONN 85 and block 87, information post-processed by computing block [e.g., in-memory computing] of ONN 85 and block 87), optionally object or scene 82 (not shown here) may update is status (e.g., position, shape, speed, components);
2) ONN 85 receives and processes input light (e.g., light from light source 71, light transmitted/reflected/emitted from object or scene 82);
3) block 87 (e.g., fiber, microRing, grating coupler, 1D/2D waveguide, geometric waveguide, diffractive waveguide, interconnect, optionally information may be processed by some components [e.g., microRing, MZI, NOR, PD] inside block 87) receive and transmit relevant information (e.g., optical signal, electric signal) to other >=1 ONN 85, optionally relevant information is communicated with or processed by controller 76, optionally controller 76 may make a decision;
4) ONN 85 receives and processes relevant information from first block 87, then other block 87 receive and transmit relevant information (e.g., optical signal, electric signal) back to first and/or other ONN 85, optionally relevant information is communicated with or processed by controller 76, optionally controller 76 may make a decision; and/or
5) step 1 to 4 may be repeated multiple times.

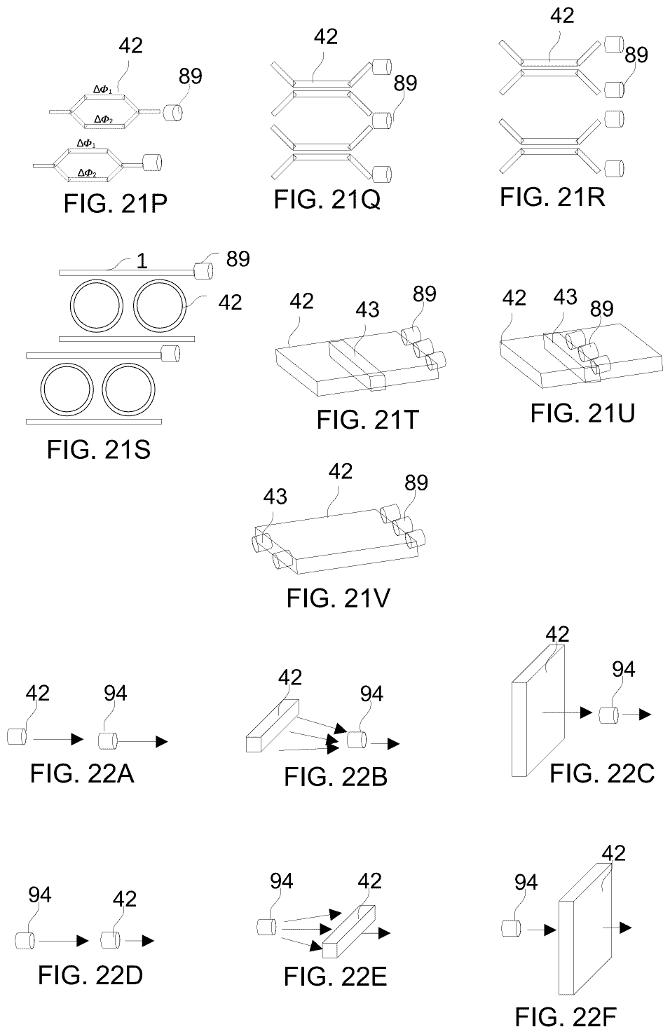

FIGS. 21A-21V illustrate 22 example embodiments of spatial arrangement between 1D transmissive nonlinear optical resonator as CW and/or spiking NOR 89 and other OED. As will be appreciated by those skilled in the art, in some embodiments, 1) 1D transmissive NOR 89 has group or array of same or different type of NOR pixels spatially arranged on 1D line or curve or sequence or ring; 1) OED 42 or 43 may be 0D (e.g., single pixel or device) or 1D arrangement (e.g., line or curve or sequence or ring) or 2D arrangement (e.g., 2D array, metasurface, planar or non-planar) or 3D arrangement (e.g., group or sequence of 2D layers over Z and X-Y axis) of >=1 OED or material which includes but is not limited to, laser, fiber, 1D/2D/3D waveguide, geometric waveguide, diffractive waveguide, prism, optical circulator, polarizer, microRing, MZI, directional coupler, grating coupler, modulator (e.g, active [e.g., SLM] or passive [e.g., 3D print, metasurface], phase and/or amplitude modulation), CW or spiking NORs, PD, lens or lens array, metamaterial.

FIGS. 21A-21C illustrate 3 example embodiments in which light goes from 0D/1D/2D OED 42 to 1D transmissive NOR 89.

FIGS. 21D-21F illustrate 3 example embodiments in which light goes from 1D transmissive NOR 89 to 0D/1D/2D OED 42.

FIG. 21G illustrate 5 example embodiments of spatial arrangement of OED 91, which may be 0D/1D/2D OED 42 or 1D transmissive NOR 89 or 0D/1D/2D OED 43.

FIG. 21H-21M illustrate 6 example embodiments of spatial arrangement of OED 43 between OED 42 and transmissive NOR 89. As will be appreciated by those skilled in the art, in some embodiments, 1) OED 43 may be 0D or 1D or 2D or 3D arrangement of >=1 OED or material which includes but is not limited to, fiber, 1D/2D/3D waveguide, geometric waveguide, diffractive waveguide, prism, optical circulator, polarizer, microRing, MZI, directional coupler, grating coupler, modulator, PD, lens (e.g., lens, Fresnel lens, microlens, metalens, liquid lens), metamaterial.

FIG. 21N illustrates an example embodiments of spatial arrangement of 2D/3D OED 42 and 1D transmissive NOR 89, in which OED 42 contains 2D/3D arrangement of 1D OED 45. As will be appreciated by those skilled in the art, in some embodiments, 1) type of OED 45 may be fiber, waveguide, microRing, MZI, directional coupler; 2) OED 45 may be 1D (e.g., line, curve, ring) or 2D or 3D of same or different type of OED; 3) OED 42 may contain same or different type of OED 45; 4) >=1 OED 45 may connect/link/correspond to >=1 transmissive pixels on NOR 89.

FIG. 21O illustrates an example embodiments of spatial arrangement of 1D array of OED 42 (e.g., fiber, waveguide, line or curve) and 1D transmissive NOR 89.

FIG. 21P illustrates an example embodiments of spatial arrangement of 1D array of OED 42 (e.g., scalar MZI) and 1D transmissive NOR 89.

FIGS. 21Q and 21R illustrate 2 example embodiments of spatial arrangement of 1D array of OED 42 (e.g., directional coupler) and 1D transmissive NOR 89.

FIG. 21S illustrates an example embodiments of spatial arrangement of 1D array of OED 42 (e.g., microRing) and 1D transmissive NOR 89.

FIGS. 21T and 21U illustrate 2 example embodiments of spatial arrangement of 2D/3D OED 42 and 1D transmissive NOR 89, in which OED 42 contains 2D/3D arrangement of 1D OED 43. As will be appreciated by those skilled in the art, in some embodiments, 1) type of OED 43 may be fiber, waveguide, microRing, MZI, directional coupler, lens; 2) OED 43 may be 1D line or curve or ring; 3) OED 42 may contain same or different type of OED 43 and/or OED 89; 4) >=1 OED 43 may connect/link/correspond to >=1 transmissive pixels on NOR 89.

FIG. 21V illustrates an example embodiment of spatial arrangement of 1D OED 43, 2D/3D OED 42 and 1D transmissive NOR 89. As will be appreciated by those skilled in the art, in some embodiments, 1) type of OED 43 may be fiber, waveguide, microRing, MZI, directional coupler, lens; 2) OED 43 may be 1D line or curve or ring of same or different type of OED; 3) OED 42 may be 2D/3D waveguide; 4) >=1 OED 43 may connect/link/correspond to >=1 transmissive pixels on NOR 89.

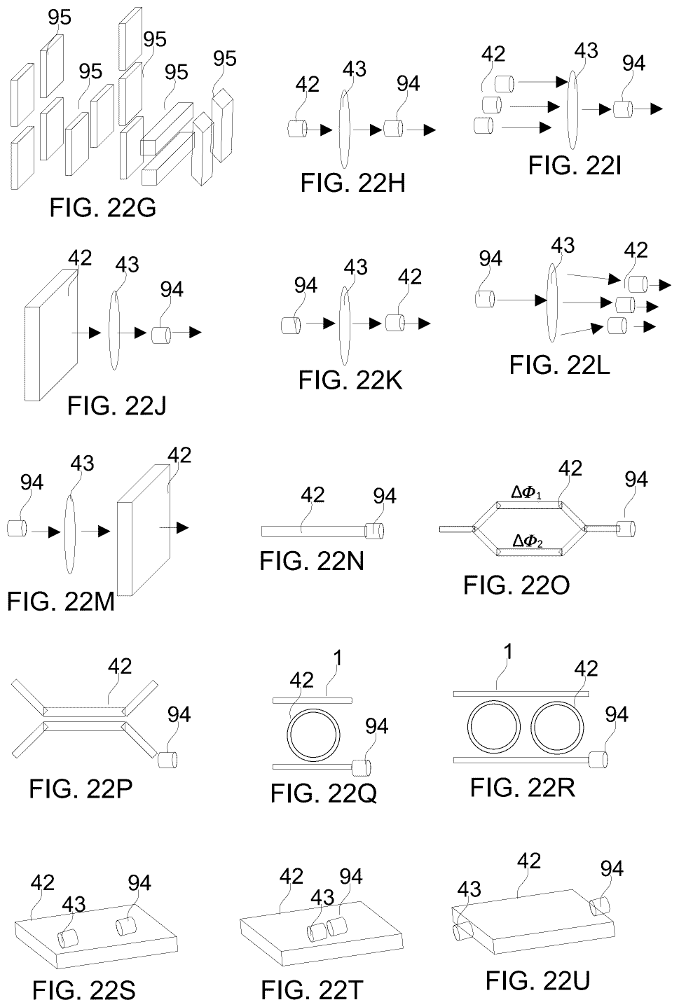

FIG. 22A-22U illustrate 21 example embodiments of spatial arrangement between 0D transmissive or reflective nonlinear optical resonator as CW or spiking NOR 94 and other OED. As will be appreciated by those skilled in the art, in some embodiments, 1) 0D NOR 94 may be transmissive or reflective (transmissive NOR 94 is shown here, reflective NOR 94 may be used similarly); 2) OED 42 or 43 may be 0D (e.g., single pixel or device) or 1D arrangement (e.g., line or curve or sequence or ring) or 2D arrangement (e.g., 2D array, metasurface, planar or non-planar) or 3D arrangement (e.g., group or sequence of 2D layers over Z and X-Y axis) of >=1 OED or material which includes but is not limited to, laser, fiber, 1D/2D/3D waveguide, geometric waveguide, diffractive waveguide, prism, optical circulator, polarizer, microRing, MZI, directional coupler, grating coupler, modulator (e.g, active [e.g., SLM] or passive [e.g., 3D print, metasurface], phase and/or amplitude modulation), PD, lens (e.g., lens, Fresnel lens, microlens, metalens, liquid lens), metamaterial.

FIGS. 22A-22C illustrate 3 example embodiments in which light goes from 0D/1D/2D OED 42 to 0D transmissive NOR 94.

FIGS. 22D-22F illustrate 3 example embodiments in which light goes from 0D transmissive NOR 94 to 0D/1D/2D OED 42.

FIG. 22G illustrates 5 example embodiments of spatial arrangement of OED 95, which may be 0D/1D/2D OED 42 and/or 0D/1D/2D OED 43 or 0D NOR 94.

FIG. 22H-22M illustrate 6 example embodiments of spatial arrangement of OED 43 between OED 42 and 0D transmissive NOR 94. As will be appreciated by those skilled in the art, in some embodiments, 1) OED 43 may be 0D or 1D or 2D or 3D arrangement of >=1 OED or material which includes but is not limited to, fiber, 1D/2D/3D waveguide, geometric waveguide, diffractive waveguide, prism, optical circulator, polarizer, microRing, MZI, directional coupler, grating coupler, modulator, PD, lens (e.g., lens, Fresnel lens, microlens, metalens, liquid lens), metamaterial.

FIG. 22N illustrates an example embodiments of spatial arrangement of 0D OED 42 (e.g., fiber, waveguide, line or curve) and 0D transmissive NOR 94.

FIG. 22O illustrates an example embodiments of spatial arrangement of 0D OED 42 (e.g., scalar MZI) and 0D transmissive NOR 94.

FIG. 22P illustrates an example embodiments of spatial arrangement of 0D OED 42 (e.g., directional coupler) and 0D transmissive NOR 94.

FIGS. 22Q and 22R illustrate 2 example embodiments of spatial arrangement of 0D OED 42 (e.g., microRing) and 0D transmissive NOR 94.

FIGS. 22S and 22T illustrate 2 example embodiments of spatial arrangement of 2D/3D OED 42 and 0D transmissive NOR 94, in which OED 42 contains 0D OED 43. As will be appreciated by those skilled in the art, in some embodiments, 1) type of OED 43 may be fiber, waveguide, microRing, MZI, directional coupler; 2) OED 42 may contain same or different type of OED 43 and/or OED 94; 4) >=1 OED 43 may connect/link/correspond to >=1 transmissive NOR 94;

FIG. 22U illustrates an example embodiments of spatial arrangement of 0D OED 43, 2D/3D OED 42 and 0D transmissive NOR 94. As will be appreciated by those skilled in the art, in some embodiments, 1) type of OED 43 may be fiber, waveguide, microRing, MZI, directional coupler; 2) OED 42 may be 2D/3D waveguide; 3) >=1 OED 43 may connect/link/correspond to >=1 transmissive NOR 94.

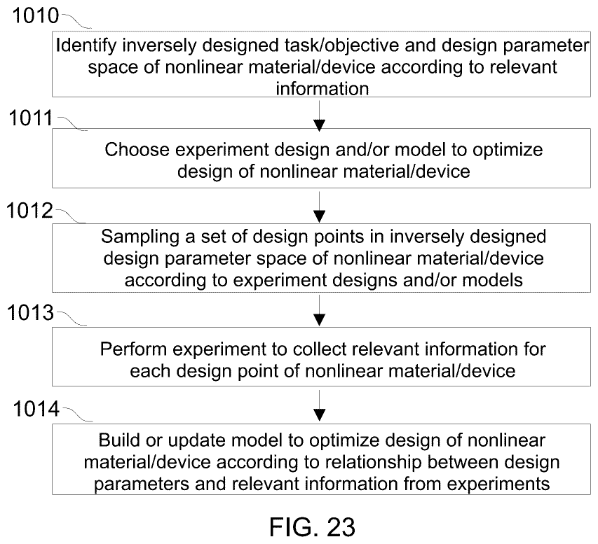

FIG. 23 illustrates a flowchart of an example embodiment of operations/processes/steps to indirectly and inversely design optimal nonlinear optical material/element/device (e.g., 0D [i.e., single pixel] or 1D array or 2D array of nonlinear optical resonator as CW and/or spiking NORs) to meet inversely designed objectives (e.g., target or expected nonlinear output response curve shape, wide or large nonlinear range for input light and/or output light, low input light intensity to generate nonlinear output response, low output reflective light intensity for transmissive CW or spiking NOR, low electric current/voltage applied to NOR to generate nonlinear output response, small aperture size of NOR to generate nonlinear output response, polarization control for output transmissive light and/or output reflective light, single output pulse number for spiking NOR, short refractory period for spiking NOR, etc) in order to be integrated as optical nonlinear activation functions or components in a nonlinear all optical machine learning system so that the integrated nonlinear all optical machine learning system can function properly to meet target objectives or criteria (e.g., high accuracy, good performance, low power consumption, low optical noise [e.g., optical noise due to the output reflective light of transmissive CW or spiking NORs], etc) for target tasks or functions (e.g., classification, generative task, large language model, etc), when the integrated nonlinear all optical machine learning systems are used for optical sensing and computing (OSC, e.g., ONN, neuromorphic computing, hybrid optical-electric neural network, OMM, optical convolution, optical computer, quantum computing, optical sensing, machine vision, imaging, AR, VR, hologram, spatial computing, optical communication, etc).

As shown in operation 1010 of FIG. 23, step 1 is to identify >=1 inversely designed tasks and/or objectives to be optimized and >=1 inversely designed design parameter spaces of nonlinear material/device/element (e.g., 0D CW or spiking NOR) according to relevant information. As will be appreciated by those skilled in the art, in some embodiments:
1) one or more inversely designed design parameter spaces include but are not limited to, appropriate parameters relevant to specific spiking/pulse generating mechanism/technology/device (e.g., gain-switch, Q-switch, mode-lock, cavity dump, opto-electronic oscillator, four-wave mixing, self-phase modulation, group-velocity dispersion, saturable absorption, soliton-assisted time-lens compression, pulsed pumping electrically and/or optically, external pulse carving), appropriate parameters relevant to models used to simulate nonlinear material/device/element (e.g., rate equations [e.g., laser rate equations, Fabry-Perot rate equations, spin-flip model, multimode rate equations, LIF model, yamada model, circuit model, hybrid model or rate equations, etc] or finite-difference time-domain method [FDTD] or finite element method [FEM] or finite difference method [FDM] or eigenmode expansion method [EEM] or method of lines [MoL] to simulate nonlinear material/device/element [e.g., VCSEL, VCSOA, VCSEL-SA, VCSOA-SA, RCLED, RCLED-SA, pulse laser], multi-physics simulation models, thermal and/or electric and/or optical simulation models), certain properties (e.g., intensity, phase, polarization, frequency or wavelength, single frequency vs multiple frequencies, frequency detuned or not, coherent vs incoherent, continuous wave vs pulse, pulse duration, pulse shape, pulse interval, OAM, polarization of input light and/or output transmissive light and/or output reflective light, pulse number and/or width and/or shape and/or intensity and/or duration and/or interval of >=1 input pulses) and/or modulating methods/patterns of input and/or output light to nonlinear material, certain properties (e.g., amplitude, phase, frequency) and/or modulating methods and/or patterns for electric current/voltage/signal applied to gain medium and/or loss material and/or PCM and/or modulating element/device, certain expected properties and/or design parameters of nonlinear material/device/element that is critical for downstream tasks (e.g., expected properties or design parameters for gain medium and/or loss material and/or PCM and/or active or passive modulating component/device, expected range or pattern or design parameter for electric current or voltage or signal applied to gain medium and/or loss material and/or PCM and/or active or passive modulating component/device, input and/or output aperture 2D/3D geometry [e.g., shape, size, depth/length], the number of layers of top/middle/bottom mirrors or reflectors [e.g., DBR, 1D/2D/3D grating, 1D/2D/3D semiconductor photonic crystal], thickness of each layer of top and/or bottom mirrors or reflectors, refractive index of each layer of top and/or bottom mirrors or reflectors, cavity 2D/3D geometry [e.g., length, shape, size], the number of cavities [e.g., composite cavity, cascaded cavities, external cavity], the number of quantum wells and/or loss material and/or PCM and/or modulating element/device, spatial arrangement and 2D/3D geometry of configurable components [e.g., mirrors or reflectors, cavity, gain medium, saturable absorber] of NOR, transmissive vs reflective, the number of layers of top DBR, the number of layers of bottom DBR, aperture size, resonant wavelength, refractive index of each pair of top DBR layer, refractive index of each pair of bottom DBR layer, thickness of each layer of top DBR, thickness of each layer of bottom DBR, number and thickness of layers of bottom DBR, refractive index of cavity, cavity length, cavity geometry, electric current or voltage or signal applied to gain medium, electric current or voltage or signal applied to modulating component/device, electric current applied to loss material, electric current or voltage or signal applied to SA region, cavity length of gain medium, cavity length of loss material, cavity length of SA region, refractive index of cavity for gain medium, refractive index of cavity for loss material, refractive index of cavity for SA region, coupling efficiency for input and output light);
2) one or more inversely designed tasks or objectives include but are not limited to, type of nonlinear material/element/device (e.g., standing wave cavity, traveling wave cavity, photonic crystal cavity, plasmonic cavity, hybrid cavity, VCSOA, RCLED, VCSEL-SA, RCLED-SA, microRing, reflective vs transmissive, gain-switch, Q-switch, mode-lock, cavity dump, opto-electronic oscillator, four-wave mixing, self-phase modulation, group-velocity dispersion, saturable absorption, soliton-assisted time-lens compression, pulsed pumping electrically and/or optically, external pulse carving), certain targets or expected properties of nonlinear material/device/element (e.g., low lasing threshold current, low electric current and/or voltage applied to gain medium and/or loss material and/or PCM and/or modulating device to generate nonlinear output response, small size for input and/or output aperture to generate nonlinear output response, certain geometry of input and/or output aperture for polarization control of output reflective and/or transmissive light), certain targets or expected properties (e.g., expected nonlinear range [e.g., low input power to start triggering nonlinear response of output light, high input power to maintain nonlinear response of output light, wide or large nonlinear range for input lights and/or output lights], expected frequency detuning range to generate nonlinear output response, specific or target or expected nonlinear response or curve shape [e.g., single-piece piecewise constant function or Heaviside step function like curve shape for spiking NOR as illustrated in FIG. 5O, exponential like curve shape for CW NOR as illustrated in FIG. 5M, sigmoid or logistic function like curve shape for transmissive output light of transmissive CW NOR, a line shape with very small slope for reflective output light of transmissive CW NOR], high ratio of output transmissive optical intensity to input intensity over certain range of input optical intensity for transmissive NOR, high ratio of output transmissive optical intensity to output reflective optical intensity over certain range of input optical intensity for transmissive NOR, low output reflective optical intensity over certain range of input optical intensity for transmissive NOR, low ratio of output reflective optical intensity to input intensity for transmissive NOR, high output transmissive or reflective optical intensity over certain range of input optical intensity for transmissive or reflective NOR, polarization, wavelength, frequency detuning, OAM, low or fast spiking response time for spiking NOR, low threshold optical intensity to generate spike [i.e., low spiking threshold for input pulse optical intensity], short absolute and/or relative refractory period, short duration or small peak width for output spike, single spike output over certain range of input optical intensity, constant or near constant optical intensity for output spike over certain range of input optical intensity for spiking NOR [e.g., by maximizing similarity/correlation or minimizing loss/distance between optical intensities of output reflective or transmissive spike over certain range of input optical intensity and Heaviside step function as illustrated in FIG. 5O], low optical intensity of output transmissive spike over certain range of input intensity for transmissive spiking NOR, low optical intensity of output reflective spike over certain range of input intensity for reflective spiking NOR, low ratio of optical intensity of output transmissive spike to input intensity over certain range of input optical intensity for transmissive spiking NOR, low ratio of optical intensity of output reflective spike to input intensity over certain range of input optical intensity for reflective spiking NOR) of input light and/or output light (e.g., output transmissive intensity or phase or phase_shift or polarization or wavelength or pulse or OAM, output reflective intensity or phase or phase_shift or polarization or wavelength or pulse or OAM) of nonlinear material/element/device and/or relationships between output light and input light, certain optimization objectives for nonlinear optical resonator-based CW or spiking NORs (e.g., minimize output reflective intensity and/or maximize output transmissive intensity and/or maximize aggregated [e.g., averaged, median, ratio for certain {e.g., highest} input intensity] ratio of output transmissive intensity to output reflective intensity and/or maximize aggregated ratio of output transmissive intensity to input intensity and/or minimize aggregated ratio of output reflective intensity to input intensity over >=1 set of input intensity range for transmissive CW or spiking NORs, maximize output reflective intensity and/or maximize aggregated ratio of output reflective intensity to input intensity over >=1 set of input intensity range for reflective CW or spiking NORs, maximize nonlinearity between output transmissive or reflective intensity and input intensity over >=1 set of input intensity range {e.g., minimize correlation [e.g., pearson correlation] and/or maximize curvature between output transmissive or reflective intensity and input intensity over >=1 set of input intensity range, maximize similarity [e.g., trajectory similarity] and/or maximize correlation [e.g, pearson correlation] and/or minimize loss [e.g., mean squared error, absolute error, hinge loss] and/or minimize distance [e.g., spatial distance, Jensen-Shannon distance, Canberra distance, Bray-Curtis distance, Chebyshev distance, Cosine distance, Euclead distance, Manhattan distance, Minkowski distance, Wasserstein distance, energy distance, sum of minkowski distance between neighboring points along curve] between output response curve [e.g., normalized output reflective or transmissive intensity vs input intensity] and target shape/function [e.g., exponential, logistic, sigmoid shape, Heaviside step function or single piece piecewise constant function as illustrated in FIG. 5O] over >=1 set of input intensity range}, minimize output reflective and/or transmissive spike intensity aggregated [e.g., averaged] over >=1 set of input intensity range for spiking NORs, limit or constrain all or subset of output reflective and/or transmissive spike intensities [over >=1 set of input intensity range] to certain range [e.g., by hinge loss, similarity, distance or loss function] for spiking NORs [e.g., by maximizing similarity/correlation or minimizing loss/distance between optical intensities of output reflective and/or transmissive spike over certain range of input optical intensity and Heaviside step function as illustrated in FIG. 5O, maximizing similarity/correlation or minimizing loss/distance between Heaviside step function and ratio of output reflective and/or transmissive spike intensity to spiking threshold for input pulse intensity over certain range of input intensity, maximizing similarity/correlation or minimizing loss/distance between Heaviside step function and ratio of output reflective and/or transmissive spike intensity over certain range of input intensity to output reflective and/or transmissive spike intensity at spiking threshold for input pulse intensity, hinge loss to constrain output reflective and/or transmissive spike intensity to target range over certain range of input intensity, hinge loss to constrain ratio of output reflective and/or transmissive spike intensity to output reflective and/or transmissive spike intensity at spiking threshold for input pulse intensity to target range over certain range of input intensity], minimize spiking threshold for input pulse optical intensity [i.e., no output spike/pulse if input pulse intensity is less than this spiking threshold] for spiking NORs, constrain to a certain range [e.g., 1, by hinge loss, maximize similarity or minimize loss/distance from a target function such as Heaviside step function] or minimize spiking response time and/or output pulse width and/or output pulse number [e.g., single output pulse number] aggregated [e.g., averaged] over >=1 set of input intensity range for spiking NORs); certain objectives (e.g, accuracy, relevant quality or metric) for certain tasks (e.g., optical neural network or neuromorphic computing or hybrid optical-electric neural network for discriminative or generative or reinforcement learning task for image/text/video/audio, optical sensing [e.g., Lidar, structural light], machine vision, imaging [e.g., super-resolution, microscopy], optical computing [e.g., convolution, matrix multiplication], optical computer [e.g., optical transistor, optical logic gate], optical communication [e.g., beam steering, beam forming, encoding, decoding, switch, routing, freespace, on-chip, chip-to-chip]) using nonlinear material/element/device; and/or
3) in some embodiment, more than one inversely designed tasks and/or objectives are chosen.

As shown in operation 1011 of FIG. 23, step 2 is to choose appropriate experiment design and/or model to optimize design of nonlinear material/element/device (e.g., 0D CW or spiking NOR) according to relevant information from operation 1010 and domain knowledges. As will be appreciated by those skilled in the art, in some embodiments:
1) experiment designs for inversely designed design parameter space include but are not limited to, random design, simplex, orthogonal design, factorial design, response surface method, mixture design, sequential analysis, bayesian experiment design, any other relevant experiment designs, domain knowledge;
2) models include but are not limited to, unsupervised learning (e.g., analysis of variance, principle component analysis, clustering), supervised learning (e.g., gradient boosting, random forest, generalized additive model, regression), hyperparameter optimization (e.g., grid search, random search, bayesian optimization), global optimization (e.g., simulated annealing [e.g, dual annealing], evolutionary algorithm [e.g., genetic algorithm, evolution strategies, differential evolution], ant colony optimization, tabu search, differential evolution, swarm-based optimization), basin-hopping algorithm, simplicial homology, monte carlo method (e.g., monte carlo tree search, importance sampling, markov chain monte carlo, gibbs sampling, stochastic gradient descent), reinforcement learning, machine learning, deep learning (neural network, AutoML, Neural architecture search, large language model, diffusion model, generative adversarial network, generative AI);
3) >=1 experiment designs and/or >=1 models may be used;
4) any relevant computing language (e.g., fortran, python, matlab, R, c, c++, java, pytorch, tensorflow, jax), software (e.g., Lumerical, Matlab), library or package (e.g., scipy, numpy, pytorch, tensorflow, jax), service (e.g., API, cloud service) and computing device (e.g., GPU, TPU, cpu, AI-chip, FPGA, ASICs) may be used for experiment designs and models; and/or
5) in some embodiments, more than one experiment designs and/or models are chosen.

As shown in operation 1012 of FIG. 23, step 3 is to sample a set of design points in inversely designed design parameters space according to one or more experiment designs and/or one or more models. As will be appreciated by those skilled in the art, in some embodiments, 1) models include but are not limited to, cold-start model, pretrained model, model built on data from previous experiments; 2) >=1 design points may be sampled in design parameters space; 3) a set of random design points may be used as input to models to predict its performance or quality for design objectives or tasks, then subset of those random design points (with highest predicted performance or quality or metric) is selected for next step; 4) a set of design points may include but not limited to, any combination (e.g., union, intersect) of design points from >=1 experiment designs by >=1 experiment design methods, and those from >=1 models.

As shown in operation 1013 of FIG. 23, step 4 is to perform one or more experiments to collect relevant information for each design point of nonlinear material/element/device. As will be appreciated by those skilled in the art, in some embodiments:
1) experiments may be either real experiments and/or virtual experiments (e.g., simulations);
2) >=1 experiments may be performed on, IBNLT, single pixel of CW or spiking NOR, 1D/2D/3D ONN with 0D/1D/2D CW or spiking NOR, 1D/2D/3D optical sensing and/or computing with CW or spiking NOR, 1D/2D/3D optical communication with CW or spiking NOR;
3) >=1 differentiable and/or non-differentiable models (e.g., curve fitting [cubic spline, polynomial fit], machine learning, deep learning [e.g., neural network, autoML neural architecture search, diffusion model, generative adversarial network, large language model], differential equation [e.g., rate equations [e.g., laser rate equations, Fabry-Perot rate equations, spin-flip model, multimode rate equations, LIF model, yamada model, circuit model, hybrid model or rate equations, etc], neural ordinary differential equation, neural partial differential equation], FDTD or neural FDTD, EEM or neural EEM, FEM or neural FEM, multi-physics simulations, comprehensive optical+electrical+thermal simulation, multi-wavelength simulation, monte carlo simulation, reinforcement learning, any other suitable simulation models) for relationship between input and output of GD single pixel nonlinear material may be used during simulations;
4) any relevant computing language (e.g., python, matlab, c, c++, java, pytorch, tensorflow, jax), software, library or package (e.g., scipy, numpy), service (e.g., API, cloud service) and computing device (e.g., GPU, TPU, cpu, AI-chip, FPGA) may be used for simulations; and/or
5) in some embodiment, more than one experiments are performed.

As shown in operation 1014 of FIG. 23, step 5 is to build or update one or more models to optimize design of nonlinear material/element/device according to relationship between design parameters and relevant information collected from experiments. As will be appreciated by those skilled in the art, in some embodiments:
1) relevant information includes but is not limited to, type of nonlinear material/element/device (e.g., VCSOA, RCLED, microRing, reflective vs transmissive, gain-switch, Q-switch, mode-lock, cavity dump), parameters and/or hyperparameters relevant to models (e.g., rate equations, neural ODE, FDTD, EEM, FEM, multi-physics simulations, multi-wavelength simulation, machine learning, deep learning, reinforcement learning, any other suitable simulation models), certain properties of input light to nonlinear material (e.g., intensity, phase, polarization, frequency or wavelength, single frequency vs multiple frequencies, frequency detuned or not, coherent vs incoherent, CW vs pulse, pulse duration, pulse shape, pulse intervals), certain properties of nonlinear material/element/device (e.g., gain medium, loss material, modulating element/device, electric current or voltage or signal applied to gain medium and/or loss material and/or modulating element/device, input and/or output aperture 2D/3D geometry [e.g., shape, size, depth/length], the number of layers of top and/or middle and/or bottom mirrors or reflectors [e.g., DBR, 1D/2D/3D grating, 1D/2D/3D semiconductor photonic crystal], thickness of each layer of top and/or bottom mirrors or reflectors, refractive index of each layer of top and/or bottom mirrors or reflectors, cavity 2D/3D geometry [e.g., volume, length, shape, size], the number of cavities [e.g., single/double/composite/cascaded/external cavities], the number of quantum wells, carrier lifetime for gain and/or SA region, photon lifetime, spatial arrangement and 2D/3D geometry of configurable components [e.g., mirrors or reflectors, cavity, gain medium, saturable absorber] of CW or spiking NOR, transmissive vs reflective), certain properties (e.g., nonlinear range, nonlinear response or curve shape, ratio of transmissive to input intensity, ratio of transmissive to reflective intensity, polarization, wavelength, OAM, spiking response time, threshold optical intensity to generate spike, absolute or relative refractory period, duration or peak width for output spike, number of output spike, optical intensity for >=1 output spike) of output light (e.g., output transmissive intensity/phase/polarization/wavelength/pulse/OAM, output reflective intensity/phase/polarization/wavelength/pulse/OAM) of nonlinear material and/or relationships between output light and input light, measured objectives (e.g, accuracy, relevant quality or metric) for certain tasks using nonlinear material, any other information needed for selected models;
2) based on relationship between design parameters and relevant information collected from one or more real or virtual experiments, one or more models may update relevant model parameters (e.g., neural network parameters, hyperparameters), and/or optimize design of nonlinear material (e.g., update or propose better design parameters) according to relevant algorithms (eg. gradient search, stochastic gradient descent, backpropagation, bayesian optimization, global optimization, supervised learning, deep learning, machine learning, reinforcement learning); and/or
3) in some embodiment, more than one models are built or updated.

Operation 1012 to 1014 may be repeated multiple times until certain criteria are met, IBNLT, optimal design of nonlinear material is achieved, repeat runs exceed a threshold number, or the like.

As an example, in order to design an optimal transmissive CW NOR (e.g., VCSOA, VCSEL, RCLED, VCSOA-SA, VCSEL-SA, RCLED-SA) to improve classification accuracy of Cifar10 dataset by ONN with NOR, in some embodiments:
1) design parameters of NOR may include but are not limited to, the number of layers of top DBR, the number of layers of bottom DBR, aperture size, the number of quantum wells, electric current or voltage or signal applied to gain medium, refractive index of each pair of top DBR layer, refractive index of each pair of bottom DBR layer, refractive index of cavity, cavity length;
2) objective may be classification accuracy of Cifar10 dataset by ONN with NOR;
3) N design points are chosen based on domain knowledge and multiple orthogonal designs;
4) optical simulation (e.g., pytorch-based or python-based rate equations model for CW NOR) is used to generate output curve (transmissive and reflective output intensity and phase_shift for input light with different intensity, as illustrated in FIG. 5M-5N for example) for each design point of NOR;
5) differentiable cubic spline (e.g., pytorch/tensorflow/jax-based) is used to model the relationship between input intensity and output transmissive/reflective intensity/phase_shift for each design point of NOR;
6) pytorch-based ONN (with differentiable cubic spline model for each design point of NOR) may be used to classify Cifar10 dataset and classification accuracy for each design point of NOR is collected, in another word, N classification accuracies are collected for N design points of NOR;
7) random forest is used to build prediction model to predict classification accuracy (ie, N classification accuracies from pytorch-based ONN) from design parameters (of N design points of NOR) using cross-validation (90% for training, 10% for validation), with R² for training/validation;
8) random forest based prediction model may be used to predict classification accuracy from a set of random design points, and subset of random design points with high classification accuracies may be selected for next step; and/or
9) step 3 to step 8 may be repeated for multiple times until an optimal design is found.

As another example, to design an optimal transmissive CW NOR (e.g., VCSOA, VCSEL, RCLED, VCSOA-SA, VCSEL-SA, RCLED-SA) to minimize output reflective optical intensity or maximize overall ratio of output transmissive optical intensity to output reflective optical intensity for certain range of input optical intensity, in some embodiments:
1) design parameters of NOR may include but are not limited to, number of layers of top DBR, number of layers of bottom DBR, aperture size, number of quantum wells, electric current or voltage or signal applied to gain, electric current or voltage or signal applied to SA region, refractive index of each pair of top DBR layers, refractive index of each pair of bottom DBR layer, cavity length of gain, cavity length of SA region, refractive index of cavity for gain and SA region, any other parameters relevant to models (e.g., rate equations [e.g., laser rate equations, Fabry-Perot rate equations, spin-flip model, multimode rate equations, hybrid model or rate equations, etc] or FDTD or FEM or EEM for VCSOA-SA) which are used to simulate NOR;
2) objective is to minimize output reflective optical intensity and/or maximize output transmissive optical intensity and/or maximize overall ratio of output transmissive optical intensity to output reflective optical intensity for >=1 set of input intensity ranges;
3) N design points are chosen based on domain knowledge and multiple orthogonal designs;
4) optical simulation (e.g., rate equations or FDTD or FEM or EEM for VCSOA or RCLED) is used to generate output curve (transmissive and reflective output intensity for input light with different optical intensity) for each design point of NOR;
5) optionally, appropriate model (e.g., pytorch/tensorflow/jax-based differentiable neural network, rate equations) may be used to model the relationship between input intensity and output transmissive/reflective intensity for each design point of NOR;
6) certain distance or similarity metrics may be used to quantify or measure the difference between output transmissive intensity curve and output reflective intensity curve over certain range of input optical intensity, IBNLT, trajectory similarity, ratio of area under output transmissive intensity curve to area under output reflective intensity curve, aggregated (e.g., summed over certain input intensity range) difference or ratio of height of output transmissive intensity curve to height of output reflective intensity curve, spatial distance between output transmissive intensity curve and output reflective intensity curve (e.g., https://docs.scipy.org/doc/scipy/reference/generated/scipy.spatial.distance.cdist.html);
7) AI methods (e.g., random forest, XGBoost, neural network) is used to build the prediction model to predict distance metrics (e.g., N spatial distances calculated for each design point of NOR) between output transmissive intensity curve and output reflective intensity curve from design parameters (of N design point of NOR) using cross-validation (90% for training, 10% for validation), with R² as quality metric for training/validation;
8) AI based prediction model may be used to predict distance metrics from a set of random design points, and subset of random design points with appropriate distance metrics may be selected for next step; and/or
9) step 3 to step 8 may be repeated for multiple times until an optimal design is found.

As another example, in order to use hyperparameter optimization to optimize design parameters of transmissive CW NOR (e.g., VCSEL, VCSEL-SA, VCSOA, VCSOA-SA, RCLED, RCLED-SA, EEL, MicroRing) to minimize output reflective optical intensity or maximize overall ratio of output transmissive intensity to output reflective intensity over certain range of input optical intensity, in some embodiments:
1) hyperparameters to be optimized are design parameters of NOR, IBNLT, number and thickness of layers of top DBR, number and thickness of layers of bottom DBR, aperture size, number of quantum wells, electric current or voltage or signal applied to gain, electric current or voltage or signal applied to loss material or modulator, refractive index of each pair of top DBR layer, refractive index of each pair of bottom DBR layer, cavity length of gain, cavity length of loss material, refractive index of cavity for gain and/or loss material, any other parameters relevant to models (e.g., rate equations [e.g., laser rate equations, Fabry-Perot rate equations, spin-flip model, multimode rate equations, hybrid model or rate equations, etc] or FDTD or FEM or EEM for VCSOA or RCLED or VCSOA-SA) which are used to simulate NOR;
2) objective for hyperparameter optimization is to minimize output reflective intensity and/or maximize output transmissive intensity and/or maximize overall ratio of output transmissive intensity to output reflective intensity for certain range of input optical intensity;
3) initial set of >=1 design points are chosen based on domain knowledge and/or experiment design (e.g., random design, orthogonal design) and/or random search and/or grid search;
4) optical simulation (e.g., rate equations or FDTD or FEM or EEM for VCSOA-SA or RCLED-SA) is used to generate output curve (transmissive and reflective output intensity for input light with different optical intensity) for each design point of NOR;
5) optionally, model (e.g., pytorch/tensorflow/jax-based differentiable model or neural network, rate equations) is used to model the relationship between input intensity and output transmissive/reflective intensity for each design point of NOR;
6) certain distance or similarity metrics may be used to quantify or measure the difference between output transmissive intensity curve and output reflective intensity curve over certain range of input intensity, IBNLT, trajectory similarity, ratio of area under output transmissive intensity curve to area under output reflective intensity curve, aggregated (e.g., summed over certain input intensity range) difference or ratio of height of output transmissive intensity curve to height of output reflective intensity curve, spatial distance between output transmissive intensity curve and output reflective intensity curve;
7) hyperparameter optimization (e.g., bayesian optimization, autoML, tree parzen estimators, global optimization, gradient based optimization, sequential model-based optimization, halving randomized or grid search) may be used to build or update relevant model (e.g., probabilistic, Gaussian Process) from relevant information collected from above steps and to propose a new design point for next step;
8) step 4 to step 7 may be repeated for multiple times until certain criteria are met (e.g., >=1 optimal designs are found);
9) multiple runs of step 3 to step 8 may be used for optimal design using same or different optical simulation models and/or same or different hyperparameter optimization method for same or different objectives; For example, >=1 first models (e.g., simulation models, hyperparameter optimization method) are used to generate a first set of >=1 optimal design, then >=1 second models are used to generate a second set of >=1 optimal design based on relevant information or feedback (e.g., information or feedback from >=1 first models, performance of the nonlinear all optical machine learning system using >=1 optimal designs in first set); In one embodiment, >=1 coarse or less accurate but fast first models (e.g., rate equations, global optimization) may be used to generate a first set of optimal designs which are then used as initial input to more accurate but slow second models (e.g., FEM, FDTD) to generate a second set of more accurate designs; and/or
11) optionally, a first subset of optimal designs of NOR from previous steps may be chosen for a second subset of optimal designs according to certain criteria (e.g., ranking by quality of metrics, domain knowledge, more accurate simulation, more comprehensive simulation [e.g, multi-physics simulation models, thermal and/or electric and/or optical simulation models], fabrication and experiments, actual performance on the physical embodiments of the integrated nonlinear all optical machine learning systems for certain tasks).

As another example, in order to use hyperparameter optimization (e.g, global optimization [e.g., simulated annealing, dual annealing, genetic algorithm, differential evolution, basin-hopping algorithm, simplicial homology], experiment design [e.g., orthogonal design such as Taguchi Method, simplex method, factorial design, response surface methodology design, Doehlert Design, Mixture Design, sequential optimization method [e.g., Evolutionary Operation], grid search, random search, bayesian optimization, gradient based optimization, autoML, reinforcement learning) to optimize design parameters of reflective or transmissive CW NOR (e.g., VCSOA, VCSOA-SA, VCSEL, VCSEL-SA, RCLED, RCLED-SA, EEL, VECSEL, microRing, microDisk) for certain objectives, in some embodiments:
1) solution or state or population or levels or parameters to be optimized are design parameters of NOR, IBNLT, number and thickness of layers of top DBR, number and thickness of layers of bottom DBR, aperture size, number of quantum wells, electric current applied to gain region, electric current applied to loss material or modulator, refractive index of each pair of top DBR layer, refractive index of each pair of bottom DBR layer, cavity length or volume of gain region, refractive index of cavity for gain region, cavity length of loss material, refractive index of loss material, any other parameters relevant to models (e.g., rate equations [e.g., laser rate equations, Fabry-Perot rate equations, spin-flip model, multimode rate equations, hybrid model or rate equations, etc] or FDTD or FEM or EEM for VCSOA or RCLED or VCSEL or VCSEL-SA) which are used to simulate NOR;
2) objectives for hyperparameter optimization may be, including but not limited, relevant objectives for NOR (e.g, minimize output reflective intensity and/or maximize output transmissive intensity and/or maximize aggregated [e.g., averaged, median, ratio for certain {e.g., highest} input intensity] ratio of output transmissive intensity to output reflective intensity over >=1 set of input intensity range, maximize nonlinearity between output intensity and input intensity over >=1 set of input intensity range {e.g., minimize correlation [e.g., pearson correlation] and/or maximize curvature between output intensity and input intensity over >=1 set of input intensity range, maximize similarity [e.g., trajectory similarity] and/or maximize correlation [e.g, pearson correlation] and/or minimize loss [e.g., mean squared error, absolute error, hing loss] and/or minimize distance [e.g., spatial distance, Jensen-Shannon distance, Canberra distance, Bray-Curtis distance, Chebyshev distance, Cosine distance, Euclead distance, Manhattan distance, Minkowski distance, Wasserstein distance, energy distance, sum of minkowski distance between neighboring points along curve] between curve [e.g., normalized output reflective or transmissive intensity vs input intensity] and target shape/function [e.g., exponential, logistic, sigmoid shape] over >=1 set of input intensity range}, minimize output reflective and/or transmissive intensity aggregated [e.g., averaged] over >=1 set of input intensity range, limit all or subset of output reflective and/or transmissive intensities [over >=1 set of input intensity range] to certain range [e.g., hing loss]), relevant objectives of optical computing (e.g., optical neural network, neuromorphic computing, matrix multiplication, optical sensing) with NOR for certain tasks (e.g., classification, language model);
3) initial solution or state or population or levels or values may be chosen based on domain knowledge and/or experiment design (e.g., random design, orthogonal design) and/or random search and/or grid search and/or models (e.g., pretrain model, previous model);
4) optical simulation (e.g., rate equations or FDTD or FEM or EEM for VCSEL or VCSOA) is used to generate output curve (e.g., transmissive and reflective output optical intensity and phase shift over certain range of input optical intensity, as illustrated in FIG. 5M-5N for example) for each design point of NOR in solution or state or population or levels or parameters;
5) optionally, appropriate model (e.g., pytorch/tensorflow/jax-based differentiable model or neural network, rate equation) is used to model the relationship between input light and output light for each design point of NOR;
6) based on relevant information collected from above steps, >=1 hyperparameter optimization models may be used to propose a new solution or state or population for next step;
7) step 4 to step 6 may be repeated for multiple times until certain criteria are met (e.g., optimal designs are found);
8) multiple runs of step 3 to step 7 may be used for optimal designs using same or different optical simulation models (e.g., use coarse or less accurate but fast models [e.g., rate equations] to generate a set of optimal designs which are used as initial input to more accurate but slow models [e.g., FEM, FDTD, EEM] to generate another set of more accurate designs) and/or same or different hyperparameter optimization algorithms/models (e.g., bayesian optimization, global optimization, experiment design, grid search, random search) for same or different objectives; and/or
9) optionally, subset of optimal designs of NOR from previous steps may be further chosen according to certain criteria (e.g., ranking by quality of metrics and/or objectives, domain knowledge, using more accurate simulation, using more comprehensive simulation [e.g, optical+thermal+electrical], experiment results after fabrication), as illustrated in FIG. 5M-5N for one example of optimal design chosen by hyperparameter optimization.

As an example of using hyperparameter optimization to optimize transmissive VCSEL or VCSOA as CW NOR, in some embodiments:
1) objectives to be optimized include but is not limited to, maximizing nonlinearity between transmissive output intensity and input intensity over >=1 set of input intensity range (e.g., minimizing pearson correlation between transmissive output intensity and input intensity over certain range, maximizing curvature between transmissive output intensity and input intensity over certain range), minimizing reflective output intensity over >=1 set of input intensity range (e.g., minimizing ratio of reflective output intensity to transmissive output intensity over certain range);
2) well-known rate equation model for semiconductor laser amplifier (e.g., M. J. Adams et al, Analysis of semiconductor laser optical amplifiers, IEE Proc. J.-Optoelectronics, 1985, 132:58-63; S. Xiang et al, Numerical Implementation of Wavelength-Dependent Photonic Spike Timing Dependent Plasticity Based on VCSOA, IEEE Journal of Quantum Electronics, 2018, 54:1-7) is used to simulate VCSEL or VCSOA device and is solved by standard ordinary differential equation solver (e.g., RK45 for Runge-Kutta method of order 5[4]), in order to generate transmissive and reflective output intensity and phase shift for any input intensity;
3) hyperparameter or design parameters of NOR to be optimized include but are not limited to, aperture diameter, input wavelength for frequency detune, electric current injected to gain medium, group refractive index for cavity, number of top and bottom DBRs, refractive index for each pair of top DBRs, refractive index for each pair of bottom DBRs; and/or
4) hyperparameter or design parameters of NOR are then optimized by dual annealing global optimization algorithm via minimizing objectives outlined in step 1. One example optimal design chosen by hyperparameter optimization is illustrated in FIG. 5M-5N.

As another example, in order to use deep learning (e.g., neural network, AutoML) to optimize design parameters of CW NOR (e.g., VCSOA, VCSEL, VECSEL, EEL, microRing, microDisk):
1) learnable parameters (of deep learning) to be optimized include but are not limited to, learnable parameters of electric and/or optical neural network (e.g., weights) for certain tasks (e.g., classification, generative task, language model), design parameters of NOR (e.g., number and thickness of layers of top DBR, number and thickness of layers of bottom DBR, aperture size, number of quantum wells, electric current applied to gain and SA region, refractive index of each pair of top DBR layer, refractive index of each pair of bottom DBR layer, cavity length of gain and/or loss material, refractive index of cavity for gain and/or loss material, any other parameters relevant to models [e.g., rate equations [e.g., laser rate equations, Fabry-Perot rate equations, spin-flip model, multimode rate equations, hybrid model or rate equations, etc] or FDTD or FEM or EEM for VCSEL or VCSOA or RCLED] which are used to simulate NOR);
2) objective for deep learning may be IBNLT, relevant objectives for NOR (e.g, minimize output reflective intensity and/or maximize output transmissive intensity and/or maximize aggregated [e.g., averaged, median, ratio for certain {e.g., highest} input intensity] ratio of output transmissive intensity to output reflective intensity over >=1 set of input intensity range, maximize nonlinearity between output intensity and input intensity over >=1 set of input intensity range {e.g., minimize correlation [e.g., pearson correlation] and/or maximize curvature between output intensity and input intensity over >=1 set of input intensity range, maximize similarity or correlation [e.g., trajactory similarity, pearson correlation] and/or minimize loss (e.g., mean squared error, absolute error, hing loss) and/or minimize distance [e.g., spatial distance, Jensen-Shannon distance, Canberra distance, Bray-Curtis distance, Chebyshev distance, Cosine distance, Euclead distance, Manhattan distance, Minkowski distance, Wasserstein distance, energy distance, sum of minkowski distance between neighboring points along curve] between curve [e.g., normalized output reflective or transmissive intensity vs input intensity] and target shape/function [e.g., exponential, logistic, sigmoid shape] over >=1 set of input intensity range}, minimize output reflective and/or transmissive intensity aggregated [e.g., averaged] over >=1 set of input intensity range, limit all or subset of output reflective and/or transmissive intensities [over >=1 set of input intensity range] to certain range [e.g., hing loss]), relevant objectives of optical computing (e.g., optical neural network, neuromorphic computing, matrix multiplication, optical sensing) with NOR for certain tasks (e.g., classification, language model);
3) initial values for learnable design parameters may be chosen based on domain knowledge and/or experiment design (e.g., random design, orthogonal design) and/or random search (e.g., gaussian or uniform random distribution) and/or grid search;
4) differentiable optical simulation model (e.g., pytorch/tensorflow/jax-based differentiable rate equations for VCSOA or VCSEl) is used to generate output output light for input light for learnable design parameters of NOR;
5) differentiable (e.g., pytorch/tensorflow/jax-based) objective function for deep learning may be used to optimize differentiable optical simulation model and neural network;
6) based on relevant information collected from above steps, learnable design parameters may be updated according to certain algorithms (e.g., backpropagation, stochastic gradient descent), and the updated learnable design parameters are used for next step;
7) step 4 to step 7 may be repeated for multiple times until an optimal design is found;
8) multiple runs of step 3 to step 8 may be used for optimal design using same or different optical simulation models (e.g., use coarse or less accurate but fast models [e.g., rate equations] to generate a set of optimal designs which are used as initial input to more accurate but slow models [e.g., FEM, EEM, FDTD] to generate another set of more accurate designs) and/or same or different neural network for same or different tasks;
9) optionally, subset of optimal designs of NOR from previous steps may be chosen as according to certain criteria (e.g., ranking by quality of metrics, domain knowledge, more accurate simulation, more comprehensive simulation [e.g, optical+thermal+electrical], fabrication and experiments); and/or
10) non-differentiable discrete parameters or variables (e.g., categorical distribution or sampling, a discrete set of candidate values for a hyperparameter, a discrete set of candidate functions/models [e.g., for candidate designs of single pixel NOR] to be used for each/part/all pixels of same or different layers of ONN) may be transformed to differentiable by various methods, IBNLT, reparameterization trick (e.g., gumbel softmax), attention mechanism, neural architecture search, continuous relaxation methods, straight-through estimators, surrogate gradient methods, approximation with smooth differentiable functions, reinforcement learning.

As an example, in order to design an optimal reflective spiking NOR (e.g., VCSEL-SA, RCLED-SA) to improve classification accuracy of Cifar10 dataset by ONN with NOR, in some embodiments:
1) design parameters of NOR may include but are not limited to, number of layers of top DBR, number of layers of bottom DBR, aperture size, number of quantum wells, electric current applied to gain and SA region, refractive index of top DBR, refractive index of bottom DBR, cavity length of gain and SA region, refractive index of cavity for gain and SA region, any other parameters relevant to models (e.g., rate equations [e.g., LIF model, yamada model, spin-flip model, circuit model, hybrid model or rate equations, etc] or FDTD or FEM or EEM for VCSEL-SA) which are used to simulate NOR;
2) objective may be classification accuracy of Cifar10 dataset by ONN with NOR;
3) N design points are chosen based on domain knowledge and multiple orthogonal designs;
4) optical simulation (e.g., rate equations, FDTD, FEM, EEM) is used to generate output curve (e.g., like FIG. 5O) for each design point of NOR;
5) differentiable rate equations for VCSEL-SA based LIF spiking NOR (e.g., pytorch/tensorflow/jax-based) may be used to model the relationship between input light and output light for each design point of NOR;
6) differentiable ONN (with differentiable rate equations for VCSEL-SA based LIF spiking neuron model for each design point of NOR) is used to classify Cifar10 dataset and classification accuracy for each design point of NOR is collected, in another word, N classification accuracies are collected for N design points of NOR;
7) AI methods (e.g., random forest, extreme gradient boosting [XGBoost], neural network) is used to build prediction model to predict classification accuracy (ie, N classification accuracies from ONN) from design parameters (of N design points of NOR) using cross-validation (90% for training, 10% for validation), with R² as quality metric for training/validation;
8) AI based prediction model may be used to predict classification accuracy from a set of random design points, and subset of random design points with high classification accuracies may be selected for next step; and/or
9) step 3 to step 8 may be repeated for multiple times until an optimal design is found.

As another example, in order to design an optimal transmissive spiking NOR (e.g., VCSOA-SA, RCLED-SA) to minimize output reflective optical intensity or maximize overall ratio of output transmissive optical intensity to output reflective optical intensity for certain range of input optical intensity, in some embodiments:
1) design parameters of NOR may include but are not limited to, number of layers of top DBR, number of layers of bottom DBR, aperture size, number of quantum wells, electric current applied to gain and SA region, refractive index of top DBR, refractive index of bottom DBR, cavity length of gain and SA region, refractive index of cavity for gain and SA region, any other parameters relevant to models (e.g., rate equations [e.g., LIF model, yamada model, spin-flip model, circuit model, hybrid model or rate equations, etc] or FDTD or FEM or EEM for VCSOA-SA) which are used to simulate NOR;
2) objective is to minimize output reflective optical intensity or maximize overall ratio of output transmissive optical intensity to output reflective optical intensity for certain range of input optical intensity;
3) N design points are chosen based on domain knowledge and multiple orthogonal designs;
4) optical simulation (e.g., rate equations or FDTD or FEM or EEM for VCSOA-SA) is used to generate output curve (transmissive and reflective output intensity for input light with different optical intensity) for each design point of NOR;
5) optionally, appropriate model (e.g., pytorch/tensorflow/jax-based differentiable neural network, rate equations) may be used to model the relationship between input intensity and output transmissive/reflective intensity for each design point of NOR;
6) certain distance or similarity metrics may be used to quantify or measure the difference between output transmissive intensity curve and output reflective intensity curve over certain range of input optical intensity, IBNLT, trajectory similarity, ratio of area under output transmissive intensity curve to area under output reflective intensity curve, aggregated (e.g., summed over certain input intensity range) difference or ratio of height of output transmissive intensity curve to height of output reflective intensity curve, spatial distance between output transmissive intensity curve and output reflective intensity curve;
7) AI methods (e.g., random forest, XGBoost, neural network) is used to build the prediction model to predict distance metrics (e.g., N spatial distances calculated for each design point of NOR) between output transmissive intensity curve and output reflective intensity curve from design parameters (of N design point of NOR) using cross-validation (90% for training, 10% for validation), with R² as quality metric for training/validation;
8) AI based prediction model may be used to predict distance metrics from a set of random design points, and subset of random design points with appropriate distance metrics may be selected for next step; and/or
9) step 3 to step 8 may be repeated for multiple times until an optimal design is found.

As another example, in order to use hyperparameter optimization to optimize design parameters of transmissive spiking NOR (e.g., VCSOA, VCSEL-SA, RCLED-SA, mode-lock/gain-switch/Q-switch/cavity dump laser [EEL or VCSEL or VECSEL or microRing or microDisk] or RCLED) to minimize output reflective optical intensity or maximize overall ratio of output transmissive intensity to output reflective intensity over certain range of input optical intensity, in some embodiments:
1) hyperparameters to be optimized are design parameters of NOR, IBNLT, number and thickness of layers of top DBR, number and thickness of layers of bottom DBR, aperture size, number of quantum wells, electric current applied to gain and SA region, refractive index of top DBR, refractive index of bottom DBR, cavity length of gain and SA region, refractive index of cavity for gain and SA region, any other parameters relevant to models (e.g., rate equations [e.g., LIF model, yamada model, spin-flip model, circuit model, hybrid model or rate equations, etc] or FDTD or FEM or EEM for VCSOA-SA or RCLED-SA) which are used to simulate NOR;
2) objective for hyperparameter optimization is to minimize output reflective intensity or maximize overall ratio of output transmissive intensity to output reflective intensity for certain range of input optical intensity;
3) initial set of >=1 design points are chosen based on domain knowledge and/or experiment design (e.g., random design, orthogonal design) and/or random search and/or grid search;
4) optical simulation (e.g., rate equations or FDTD or FEM or EEM for VCSOA-SA or RCLED-SA) is used to generate output curve (transmissive and reflective output intensity for input light with different optical intensity) for each design point of NOR;
5) optionally, model (e.g., pytorch/tensorflow/jax-based differentiable model or neural network, rate equations) is used to model the relationship between input intensity and output transmissive/reflective intensity for each design point of NOR;
6) certain distance or similarity metrics may be used to quantify or measure the difference between output transmissive intensity curve and output reflective intensity curve over certain range of input intensity, IBNLT, trajectory similarity, ratio of area under output transmissive intensity curve to area under output reflective intensity curve, aggregated (e.g., summed over certain input intensity range) difference or ratio of height of output transmissive intensity curve to height of output reflective intensity curve, spatial distance between output transmissive intensity curve and output reflective intensity curve;
7) hyperparameter optimization (e.g., bayesian optimization, autoML, tree parzen estimators, global optimization, gradient based optimization, sequential model-based optimization, halving randomized or grid search) may be used to build or update relevant model (e.g., probabilistic, Gaussian Process) from relevant information collected from above steps and to propose a new design point for next step;
8) step 4 to step 7 may be repeated for multiple times until certain criteria are met (e.g., >=1 optimal designs are found);
9) multiple runs of step 3 to step 8 may be used for optimal design using same or different optical simulation models (e.g., use coarse or less accurate but fast models [e.g., rate equations] to generate a set of optimal designs which are used as initial input to more accurate but slow models [e.g., FEM, FDTD] to generate another set of more accurate designs) and/or same or different hyperparameter optimization method for same or different objectives; and/or
10) optionally, subset of optimal designs of NOR from previous steps may be chosen as according to certain criteria (e.g., ranking by quality of metrics, domain knowledge, more accurate simulation, more comprehensive simulation [e.g, optical+thermal+electrical], fabrication and experiments).

As another example, in order to use hyperparameter optimization (e.g, global optimization [e.g., simulated annealing, dual annealing, genetic algorithm, differential evolution, basin-hopping algorithm, simplicial homology], experiment design [e.g., orthogonal design such as Taguchi Method, simplex method, factorial design, response surface methodology design, Doehlert Design, Mixture Design, sequential optimization method [e.g., Evolutionary Operation], grid search, random search, bayesian optimization, gradient based optimization, autoML, reinforcement learning) to optimize design parameters of reflective or transmissive spiking NOR (e.g., VCSEL-SA, VCSOA-SA, RCLED-SA, mode-lock/gain-switch/Q-switch/cavity dump laser [EEL or VCSEL or VECSEL or microRing or microDisk] or RCLED) for certain objectives, in some embodiments:
1) solution or state or population or levels or parameters to be optimized are design parameters of NOR, IBNLT, number and thickness of layers of top DBR, number and thickness of layers of bottom DBR, aperture size, number of quantum wells, electric current applied to gain and SA region, refractive index of top DBR, refractive index of bottom DBR, cavity length or volume of gain and SA region, refractive index of cavity for gain and SA region, any other parameters relevant to models (e.g., rate equations [e.g., LIF model, yamada model, spin-flip model, circuit model, hybrid model or rate equations, etc] or FDTD or FEM or EEM for VCSEL-SA or gain-switch/mode-lock/Q-switch/cavity dump laser or RCLED) which are used to simulate NOR;
2) objective for hyperparameter optimization may be, including but not limited, relevant objectives for NOR (e.g, minimize spiking threshold for input pulse optical intensity [ie., no output spike/pulse if input pulse intensity is less than this threshold], minimize spiking response time and/or output pulse width and/or output pulse number aggregated [e.g., averaged] over >=1 set of input intensity range, minimize output reflective intensity and/or maximize output transmissive intensity and/or maximize aggregated [e.g., averaged, median, ratio for certain {eg, highest} input intensity] ratio of output transmissive intensity to output reflective intensity over >=1 set of input intensity range, maximize similarity [e.g., trajectory similarity] and/or maximize correlation [e.g, pearson correlation] and/or minimize loss (e.g., mean squared error, absolute error, hing loss) and/or minimize distance [e.g., spatial distance, Jensen-Shannon distance, Canberra distance, Bray-Curtis distance, Chebyshev distance, Cosine distance, Euclead distance, Manhattan distance, Minkowski distance, Wasserstein distance, energy distance, sum of minkowski distance between neighboring points along curve, any other suitable distance metrics] between curve [e.g, normalized output reflective and/or transmissive intensity vs input intensity] and target shape/function [e.g., Heaviside step function, piecewise constant function, sigmoid shape] over >=1 set of input intensity range, minimize output reflective or transmissive intensity aggregated [e.g., averaged] over >=1 set of input intensity range, limit all or subset of output reflective and/or transmissive intensities [over >=1 set of input intensity range] to certain range [e.g., hing loss]), relevant objectives of optical computing (e.g., optical neural network, neuromorphic computing, matrix multiplication, optical sensing) with NOR for certain tasks (e.g., classification, language model);
3) initial solution or state or population or levels or values may be chosen based on domain knowledge and/or experiment design (e.g., random design, orthogonal design) and/or random search and/or grid search and/or models (e.g., pretrain model, previous model);
4) optical simulation (e.g., rate equations or FDTD or FEM or EEM for VCSEL-SA) is used to generate output curve (e.g., reflective output optical intensity over certain range of input optical intensity, as illustrated in FIG. 5O for example) for each design point of NOR in solution or state or population or levels or parameters;
5) optionally, appropriate model (e.g., pytorch/tensorflow/jax-based differentiable model or neural network, rate equation) is used to model the relationship between input pulse and output pulse for each design point of NOR;
6) based on relevant information collected from above steps, >=1 hyperparameter optimization models may be used to propose a new solution or state or population for next step;
7) step 4 to step 6 may be repeated for multiple times until certain criteria are met (e.g., optimal designs are found);
8) multiple runs of step 3 to step 7 may be used for optimal designs using same or different optical simulation models (e.g., use coarse or less accurate but fast models [e.g., rate equations] to generate a set of optimal designs which are used as initial input to more accurate but slow models [e.g., FEM, FDTD, EEM] to generate another set of more accurate designs) and/or same or different hyperparameter optimization algorithms/models (e.g., bayesian optimization, global optimization, experiment design, grid search, random search) for same or different objectives; and/or
9) optionally, subset of optimal designs of NOR from previous steps may be further chosen according to certain criteria (e.g., ranking by quality of metrics and/or objectives, domain knowledge, using more accurate simulation, using more comprehensive simulation [e.g, optical+thermal+electrical], experiment results after fabrication), as illustrated in FIG. 5O for one example of optimal design chosen by hyperparameter optimization.

As another example of using hyperparameter optimization to optimize design parameters of spiking NOR (e.g., VCSEL-SA, VCSOA-SA), in some embodiments:
1) orthogonal experiment design (e.g., 6 factors with 4 or 5 levels per factor) may be used for 6 design parameters of NOR (e.g., VCSEL-SA), which includes but are not limited to, aperture diameter, electric current applied to gain medium, refractive index of gain region, electric current applied to SA region, cavity length of SA region, refractive index of SA region;
2) well-known two-section rate equations model (e.g., M. A. Nahmias et al, A Leaky Integrate-and-Fire Laser Neuron for Ultrafast Cognitive Computing, IEEE JOURNAL OF SELECTED TOPICS IN QUANTUM ELECTRONICS, 2013, 19:1800212; F. Selmi et al, Relative Refractory Period in an Excitable Semiconductor Laser, Physical Review Letters, 2014, 112:183902; Q. Li et al, Simulating the spiking response of VCSEL-based optical spiking neuron, Optics Communications, 2018, 407:327-332) is used to simulate VCSEL-SA device as LIF spiking neuron for each combination of design parameters chosen by orthogonal experiment design, which is solved by standard ordinary differential equation solver (e.g., RK45, Adams/BDF method) to generate output spike for single input pulse of different levels of intensity; and/or
3) certain objectives or criteria are used to select optimal or desired designs, which include but not limited to, low spiking threshold for input pulse optical intensity, low output intensity, fast spiking response time, small output pulse width. One example optimal design chosen by hyperparameter optimization is illustrated in FIG. 5O.

As another example, to use deep learning (e.g., neural network, AutoML) to optimize design parameters of spiking NOR (e.g., VCSEL-SA, RCLED-SA, mode-lock/gain-switch/Q-switch/cavity dump laser [EEL or VCSEL or VECSEL or microRing or microDisk] or RCLED):
1) learnable parameters (of deep learning) to be optimized include but are not limited to, learnable parameters of electric and/or optical neural network (e.g., weights) for certain tasks (e.g., classification, generative task, language model), design parameters of NOR (e.g., number and thickness of layers of top DBR, number and thickness of layers of bottom DBR, aperture size, number of quantum wells, electric current applied to gain and SA region, refractive index of top DBR, refractive index of bottom DBR, cavity length of gain and SA region, refractive index of cavity for gain and SA region, any other parameters relevant to models [e.g., rate equations [e.g., LIF model, yamada model, spin-flip model, circuit model, hybrid model or rate equations, etc] or FDTD or FEM or EEM for VCSEL-SA or gain-switch/mode-lock/Q-switch/cavity dump laser or RCLED] which are used to simulate NOR);
2) objective for deep learning may be IBNLT, relevant objectives for NOR (e.g, minimize spiking threshold for input pulse optical intensity [ie., no output spike/pulse if input pulse intensity is less than this threshold], minimize spiking response time and/or output pulse width and/or output pulse number aggregated [e.g., averaged] over certain range of input intensity, minimize output reflective intensity and/or maximize output transmissive intensity and/or maximize aggregated [e.g., averaged, median, ratio for highest input intensity] ratio of output transmissive intensity to output reflective intensity over certain range of input intensity, maximize similarity [e.g., correlation] and/or minimize distance [e.g., spatial distance, mean squared error, absolute error] between normalized output reflective/transmissive intensity curve and target shape/function [e.g., Heaviside step function, piecewise constant function, sigmoid shape] over certain range of input intensity, minimize output reflective/transmissive intensity aggregated [e.g., averaged] over certain range of input intensity, limit all or subset of output reflective/transmissive intensities [over certain range of input intensity] to certain range), relevant objectives of optical computing (e.g., optical neural network, neuromorphic computing, matrix multiplication, optical sensing) with NOR for certain tasks (e.g., classification, language model);
3) initial values for learnable design parameters may be chosen based on domain knowledge and/or experiment design (e.g., random design, orthogonal design) and/or random search (e.g., gaussian or uniform random distribution) and/or grid search;
4) differentiable optical simulation model (e.g., pytorch/tensorflow/jax-based differentiable rate equations for VCSEL-SA) is used to generate output output light for input light for learnable design parameters of NOR;
5) differentiable (e.g., pytorch/tensorflow/jax-based) objective function for deep learning may be used to optimize differentiable optical simulation model and neural network;
6) based on relevant information collected from above steps, learnable design parameters may be updated according to certain algorithms (e.g., backpropagation, stochastic gradient descent), and the updated learnable design parameters are used for next step;
7) step 4 to step 7 may be repeated for multiple times until an optimal design is found;
8) multiple runs of step 3 to step 8 may be used for optimal design using same or different optical simulation models (e.g., use coarse or less accurate but fast models [e.g., rate equations] to generate a set of optimal designs which are used as initial input to more accurate but slow models [e.g., FEM, EEM, FDTD] to generate another set of more accurate designs) and/or same or different neural network for same or different tasks;
9) optionally, subset of optimal designs of NOR from previous steps may be chosen as according to certain criteria (e.g., ranking by quality of metrics, domain knowledge, more accurate simulation, more comprehensive simulation [e.g, optical+thermal+electrical], fabrication and experiments); and/or
10) non-differentiable discrete parameters or variables (e.g., categorical distribution or sampling, a discrete set of candidate values for a hyperparameter, a discrete set of candidate functions/models [e.g., for candidate designs of single pixel NOR] to be used for each/part/all pixels of same or different layers of ONN) may be transformed to differentiable by various methods, IBNLT, reparameterization trick (e.g., gumbel softmax), attention mechanism, neural architecture search, continuous relaxation methods, straight-through estimators, surrogate gradient methods, approximation with smooth differentiable functions, reinforcement learning.

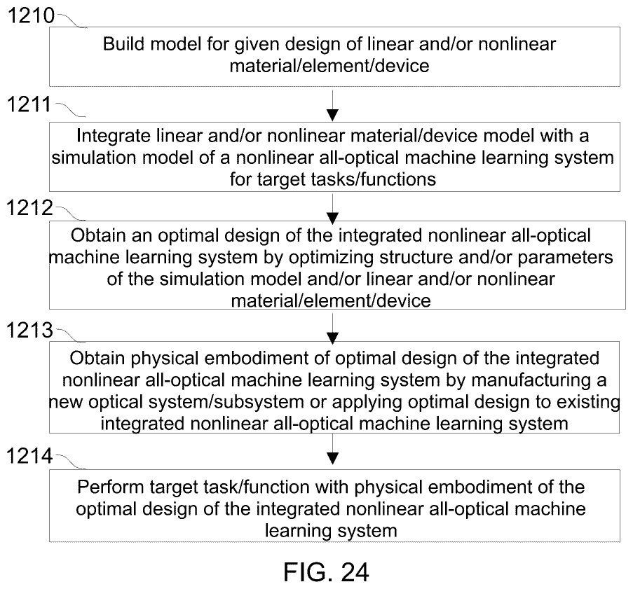

FIG. 24 illustrates a flowchart of an example embodiment of operations/processes/steps to directly integrate linear and/or nonlinear optical material/element/device (e.g., 0D/1D/2D linear or nonlinear CW and/or 0D/1D/2D nonlinear spiking NORs, metamaterial or metaline or metasurface) directly with a nonlinear all optical machine learning system, and directly and inversely design and/or optimize linear and/or nonlinear material/element/device and/or the integrated nonlinear all optical machine learning system together to meet target objectives or criteria (e.g., high accuracy, good performance, low power consumption, low optical noise, etc) for target tasks or functions (e.g., classification, generative task, large language model, etc). The inversely designed and/or optimized nonlinear optical resonator-based CW and/or spiking NORs and the optimized linear optical components or layers of the nonlinear all optical machine learning system collectively define various learnable mapping functions between the input lights and output lights of the system in order to meet target objectives or criteria for various target tasks or functions.

As shown in operation 1210 of FIG. 24, step 1 is to build one or more models for given designs of linear and/or nonlinear material/element/device (e.g., CW and/or spiking NORs, metamaterial). As will be appreciated by those skilled in the art, in some embodiments:
1) linear and/or nonlinear material/element/device includes but is not limited to, same or different types of metamaterial (e.g., metalens, metasurface, metaline), 0D or 1D or 2D array of same or different types of linear or nonlinear CW NORs (e.g., VCSEL, VECSEL, VCSOA, RCLED, EEL, microRing laser, microDisk laser, miroPillar laser, optical fiber), 0D or 1D or 2D array of same or different types of nonlinear spiking NORs (e.g., VCSEL-SA, VECSEL-SA, VCSOA-SA, RCLED-SA, EEL-SA, microRing-SA, microDisk-SA, pulse laser [e.g., mode-lock/gain-switch/Q-switch/cavity dump laser], mode locked VCSEL/VCSOA/VECSEL/EEL or microRing/microDisk/miroPillar laser);
2) >=1 non-differentiable and/or differentiable (e.g., compatible with pytorch or tensorflow or jax or auto-differentiation or gradient-based method) models (e.g., curve fitting [cubic spline, polynomial fit], supervised learning [e.g., gradient boosting, random forest], neural network, deep learning [e.g., neural architecture search, autoML], machine learning, reinforcement learning, ordinary and/or partial differential equations [e.g., rate equations for CW NOR {eg, laser rate equations, Fabry-Perot rate equations, spin-flip model, multimode rate equations, hybrid model or rate equations, etc}, rate equations for spiking NOR {eg, LIF model, yamada model, spin-flip model, circuit model, hybrid model or rate equations, etc}, neural ODE, neural partial differential equations], FDTD, FEM, EEM, Transition matrix method, multi-physics simulation models, thermal and/or electric and/or optical simulation models, multi-wavelength simulation, any other suitable simulation models) may be either directly used to predict/generate output light from input light, or built from input and output of 0D (single pixel) or 1D or 2D nonlinear material/device under different designs and/or input conditions (then used to predict/generate output for new input light), or a hybrid model with direct model as one part or component and built model as another part or component;
3) >=1 same or different type of models may be used for different designs of nonlinear materials/elements/devices to be used and/or optimized in the integrated nonlinear all optical machine learning system, for example, different types and/or designs of linear or nonlinear material material/device (e.g., CW and/or spiking NORs, metamaterial) on same layer of the integrated nonlinear all optical machine learning system, different types and/or designs of CW and/or spiking NORs on different layer of the integrated nonlinear all optical machine learning system, different types and/or designs of metamaterials on different layer of the integrated nonlinear all optical machine learning system, candidate list of different types and/or designs of CW and/or spiking NORs for pixels and/or layers of the integrated nonlinear all optical machine learning system;
4) experiments and/or simulations may be used to collect relevant information about output light (e.g., transmissive and/or reflective intensity/phase_shift/polarization/wavelength/OAM/pulse) of 0D single pixel linear and/or nonlinear material/element/device for different input condition (e.g., electric current/voltage/signal, optical intensity/phase, wavelength, polarization, OAM, pulse shape/duration/interval) and different designs of linear and/or nonlinear material/device (e.g., aperture shape/geometry/size, electric current applied to gain and/or loss material and/or modulating element/device, number and thickness of top/middle/bottom DBR, cavity, number of quantum well, refractive index of top/middle/bottom DBR, any other parameters relevant to design or simulation models); and/or
5) computing device for models include but is not limited to, CPU, GPU, TPU, AI chips, ASICS, FPGA, ONN.

As shown in operation 1211 of FIG. 24, step 2 is to integrate one or more differentiable and/or non-differentiable linear and/or nonlinear material/element/device models with a simulation model of a nonlinear all optical machine learning system for specific tasks/functions. As will be appreciated by those skilled in the art, in some embodiments:
1) The nonlinear all optical machine learning system includes but is not limited to, optical neural network (e.g., diffractive deep neural network, ONN based on optical matrix multiplication or optical convolution, neuromorphic or brain-like), optical-electric hybrid neural network, optical sensing and computing (e.g., transistor, logic gate, matrix multiply, convolution, optical amplifier), optical communication, quantum computing;
2) The nonlinear all optical machine learning system may be composed of all possible linear or nonlinear OEDs, IBNLT, linearly transformation OEDs (e.g., optical fiber, 1D/2D/3D waveguide, microRing, MZI, directional coupler, polarizer, BS, PBS, lens [e.g., fresnel lens, micro-lens, metalens, liquid lens], modulator [e.g, SLM, digital micromirror device, optical phase arrays], mirror, optical amplifiers, optical attenuators, optical filters, waveplate, diffractive optical element, prism, grating, gradient-index optics), optical vortex plate, metamaterial (e.g., metalens, 1D metaline, 2D metasurface), laser, 0D/1D/2D CW and/or spiking NORs, sensor (e.g., PD, APD);
3) tasks include but not limited to, ONN for discriminative or generative or reinforcement learning task for image/text/video/speech, optical sensing and computing (e.g., convolution, matrix multiplication, optical transistor), optical interconnect (e.g., routing, beam steering), 3D sensing (e.g., Lidar, structure light), computational photography, super-resolution;
4) simulation model may be either differentiable (e.g., based on tensorflow/pytorch/jax/maxnet, optimized by gradient-based method [e.g., stochastic gradient descent, deep learning, deep reinforcement learning]), or non-differentiable (e.g., optimized without using gradient [e.g., global optimization such as simulated annealing, genetic algorithm, reinforcement learning]);
5) simulation model may be running on CPU/GPU/FPGA/TPU/AI-Chip/ASICS/ONN; and/or
6) non-differentiable discrete parameters or variables (e.g., categorical distribution or sampling, a discrete set of candidate values for a hyperparameter, a discrete set of candidate functions/models [e.g., for candidate designs of single pixel CW and/or spiking NOR] to be used for each/part/all pixels of same or different layers of ONN) may be transformed to differentiable by various methods, IBNLT, reparameterization trick (e.g., gumbel softmax), attention mechanism, neural architecture search, continuous relaxation methods, straight-through estimators, surrogate gradient methods, approximation with smooth differentiable functions, reinforcement learning.

As shown in operation 1212 of FIG. 24, step 3 is to obtain an optimal design of the integrated nonlinear all optical machine learning system by optimizing structure and parameters of the simulation model and/or linear and/or nonlinear material/element/device. As will be appreciated by those skilled in the art, in some embodiments:
1) structure and parameters to be optimized include but are not limited to, architecture of ONN (e.g., number of total layers, sequence of different type of layers [e.g, SLM, lens, NOR, metasurface], 3D spatial arrangement of layers, number of pixels and pixel size per layer, types of pixels per layer, 2D/3D spatial arrangement of pixels per layer), relevant design parameters of >=1 design of same or different type of single pixel linear and/or nonlinear material/element/device to be used with each/all pixels (e.g., same or different type and/or design of metamaterial, same or different type and/or design of NORs for different pixel/row/column/group/section) of each/all layers (e.g., same or different type and/or design of CW and/or spiking NORs for different layer) of ONN, tunable parameters or weights for laser (e.g., power, spatial position relative to input layer, pulse intensity/duration/interval, frequency, OAM, beam shape/size) and/or modulator layer (e.g., SLM, DMD) and/or metamaterial layer (e.g., 1D metaline, 2D metasurface, metalens) and/or lens, quantization level for input/modulator/CW or spiking NOR/PD;
2) optimization method may be either gradient based (e.g., SGD, Adam, deep learning, neural architecture search, neural ODE, AutoML) or not gradient based (e.g., global optimization [e.g., simulated annealing, genetic algorithm], hyperparameter optimization, bayesian optimization, reinforcement learning); and/or
3) optionally, differentiable (e.g., pytorch/tensorflow/jax/auto-differentiation based) or non-differentiable solvers for differential equations used in simulation (e.g., rate equations for CW or spiking NORs) include but not limited to, fixed step solver (e.g., Euler, Midpoint, RK4, RK23, Adams-Bashforth, Adams-Bashforth-Moulton), adaptive step solver (e.g., Dopri5, Dopri8, Bosh3, Fehlberg2, Adaptive Heun), adjoint method.

As shown in operation 1213 of FIG. 24, step 4 is to obtain physical embodiment of optimal design of the integrated nonlinear all optical machine learning system by manufacturing >=1 new integrated nonlinear all optical machine learning system/subsystem or applying optical design to >=1 existing integrated nonlinear all optical machine learning system. As will be appreciated by those skilled in the art, in some embodiments:
1) optimal design may be used to manufacture and assembly relevant layers and/or components for >=1 new optimal integrated nonlinear all optical machine learning system or subsystem, IBNLT, linearly transformation optical components or layers (e.g., optical fiber, 1D/2D/3D waveguide, microRing, MZI, directional coupler, polarizer, BS, PBS, lens [e.g., fresnel lens, micro-lens, metalens, liquid lens], modulator [e.g, SLM, digital micromirror device, optical phase arrays], mirror, optical amplifiers, optical attenuators, optical filters, waveplate, diffractive optical element, prism, grating, gradient-index optics), optical vortex plate, metamaterial (e.g., metalens, 1D metaline, 2D metasurface), laser, 0D/1D/2D CW and/or spiking neurons, sensor (e.g., PD, APD), linear and/or nonlinear material/device/element (e.g., linear or nonlinear CW NORs, spiking NORs, CW NORs mixed with spiking NORs in same and/or different layers);
2) optimal design may be used to manufacture, assembly and replace relevant layers and/or parts and/or components of >=1 existing integrated nonlinear all optical machine learning system for optimal performance (e.g., SLM layer is replaced by optimal 3D print layer, existing 3D print layer is replaced by new optimal 3D print layer, lens is replaced by optimal meta-lens, CW and/or spiking NOR layer is replaced by optimal CW and/or spiking NOR layer);
3) various fabrication methods may be used, including but not limited, 3D print, photo-lithography, multi-photon lithography, Metal-Organic Chemical Vapour Deposition, Molecular Beam Epitaxy, Atomic Layer Deposition; and/or
4) optimal design may be applied directly to tunable parameters of relevant parts or components or layers (e.g., laser, CW and/or spiking NOR layers, modulators, input layers, PD, movable or configurable components/parts) of >=1 existing integrated nonlinear all optical machine learning system.

As shown in operation 1214 of FIG. 24, step 5 is to perform >=1 target task/function with >=1 physical embodiment of the optimal design of the integrated nonlinear all optical machine learning system. As will be appreciated by those skilled in the art, in some embodiments, 1) various performance metrics (e.g., accuracy, power consumption, inference speed, latency) may be used to evaluate the actual performance of >=1 physical embodiment of optimal integrated nonlinear all optical machine learning system, and/or compare with those of simulated optimal integrated nonlinear all optical machine learning system, and/or provide feedback loop to further optimize >=1 existing integrated nonlinear all optical machine learning system.

As will be appreciated by those skilled in the art, in some embodiments, 1) operations 1210 to 1214 may be repeated multiple times to achieve the best performance of >=1 physical embodiment of optimal integrated nonlinear all optical machine learning system for same or different tasks/functions using same or different simulation models: for example, in one embodiment, coarse or less accurate but fast models [e.g., rate equations for CW or spiking NORs] are used to generate a set of optimal designs for new or existing integrated nonlinear all optical machine learning systems to collects data and/or feedback, then those data/feedback is used as part of input for more accurate but slow models [e.g., FEM, EEM, FDTD, multi-physics simulation models, comprehensive optical+electrical+thermal simulation, multi-wavelength simulation] to generate another set of more accurate designs for new or existing integrated nonlinear all optical machine learning systems; as another example, multiple optimal designs may be used for >=1 new or existing integrated nonlinear all optical machine learning systems, then subset of best designs are chosen according to certain criteria (e.g., ranking by quality of metrics, domain knowledge) after data/feedback is collected.

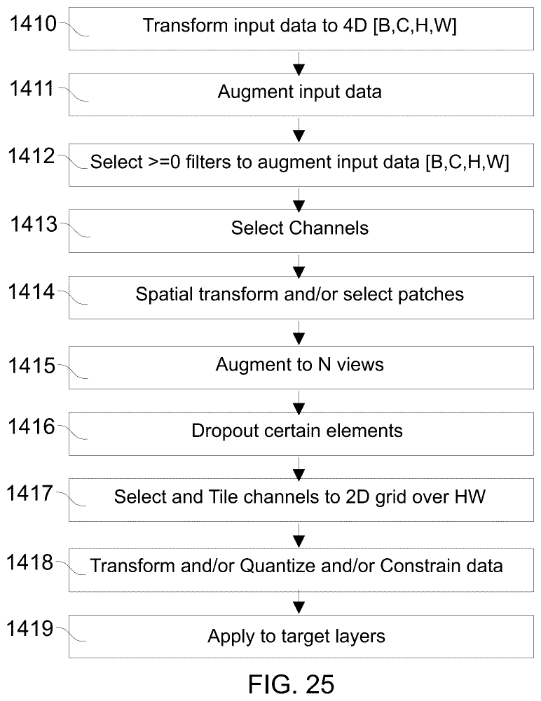

In some embodiments, during the optimization of the integrated nonlinear all optical machine learning system, input data to the integrated nonlinear all optical machine learning system may be transformed before applying to 2D layer/array of target optical components (e.g., input layer, modulation layer [e.g., phase and/or amplitude SLM, 3D printed], activation layer [e.g., nonlinear optical resonator-based continuous wave or spiking neurons], PD layer, either simulated or real one) of the integrated nonlinear all optical machine learning system. FIG. 25 illustrates a flowchart of an example embodiment of operations/processes/steps to transform and/or encode and/or augment input data before applying to 2D layer/array of target optical components of the integrated nonlinear all optical machine learning system. As will be appreciated by those skilled in the art, in some embodiments, 1) Operations 1410 to 1419 may be in different sequence; 2) some of the operations 1410 to 1419 may be omitted.

As shown in operation 1410 of FIG. 25, step 1 is to transform input data to 4D (e.g., [B=Batch, C=Channel_number, H=Height, W=Width]) or 2D (e.g., [H,W] with B=1 and C=1). As will be appreciated by those skilled in the art, in some embodiments, 1) input data may be IBNLT, text, image, video, speech; 2) 2D text token data (e.g., [B, T=token_length]) may be encoded to 3D (e.g., [B,T,E=embedding_dimension]) at first using various embedding method, then transformed to 4D in various ways, such as, reshape (e.g., [B,T,E]→[B,C=1,T,E], or [B,T,E]→[B,T,1E], or [B,T,E]→[B,T*E]→[B,(T*E+padding_num)=C*H*W] with enough 0 paddings→[B,C,H,W]); 3) 5D video data (e.g., [B,T=time,C,H,W]) may be transformed to 4D by reshape (e.g., [B,T,C,H,W]→[B*T,C,H,W], or [B,T,C,H,W]→[B,T*C,H,W]); 4) speech waveform data (e.g., [B,C,F=frame_num]) may be transformed to 4D by reshape (e.g., [B,C,F]→[B,C,(F+padding_num)=H*W] with enough 0 padding→[B,C,H,W], or [B,C,F]→[B,C,1,F], or [B,C,F]→[B,1,C,F]).

As shown in operation 1411 of FIG. 25, step 2 is to augment input data. As will be appreciated by those skilled in the art, in some embodiments, 1) all possible transformation and augment methods may be used, IBNLT, random resize/crop/rotate/flip/affine_transform/color_jitter/solarize, random blur, normalize, mix-up, random erase, RandAug, AutoAug.

As shown in operation 1412 of FIG. 25, step 3 is to select >=0 filters to augment input data. As will be appreciated by those skilled in the art, in some embodiments, 1) all possible filters may be used to augment input data, IBNLT, spatial gradient (e.g., 1^{st} or 2^{nd} order image derivative over H and W), edge filter (e.g., Sobel, Laplacian, Canny), blurring filter (e.g., box, gaussian, motion), fourier filter (e.g., fourier transform, high-pass, low-pass, band-pass), wavelet filter (e.g., haar, bior2.4), convolution filter, threshold filter; 2) same or different types of filters may be used to augment all or subset of channels of all or subset of input data; and/or 3) same or different types of filters may be used for same or different channels.

As shown in operation 1413 of FIG. 25, step 4 is to select channels from augment input data. As will be appreciated by those skilled in the art, in some embodiments, 1) fixed (e.g., first 3, all) or random subset of channels may be selected.

As shown in operation 1414 of FIG. 25, step 5 is to spatially transform input data and/or select patches. As will be appreciated by those skilled in the art, in some embodiments, 1) input data [B,C,H,W] may be spatially split into patches (e.g., [B,P=Patch_number,C,Hp=H_patch,Wp=W_patch] over H and W dims; 2) optionally, 5D [B,P,C,Hp,Wp] data may be reshaped to 4D [B*P,C,Hp,Wp]; 3) optionally, fixed or random subset of patches may be selected to perform transformation or augmentation (e.g., mask with 0 or certain or random value, fixed or random set of image transformation or augment); 4) optionally, fixed or random subset of patches (e.g., [B*P_select,C,Hp,Wp]) may be selected; 4) optionally, transformed 4D [B*P_select,C,Hp,Wp] data may be reshaped to 5D [B,P_select,C,Hp,Wp], then back to 4D [B,C,H_select,W_select].

As shown in operation 1415 of FIG. 25, step 6 is to augment input data from [B,C,H,W] to N views (e.g., [B,C*N,H,W]). As will be appreciated by those skilled in the art, in some embodiments, 1) N augments are randomly selected from a list of available transformations/augments/filters according to corresponding probabilities; 2) each of N augments is applied to input data for an augmented view [B,C,H,W]; and/or 3) all N augmented views are concatenated over channel dim (e.g., [B,C*N,H,W]).

As shown in operation 1416 of FIG. 25, step 7 is to dropout certain elements of input data. As will be appreciated by those skilled in the art, in some embodiments, 1) various criteria may be used to select certain elements for dropout (e.g., mask with fixed or random value), IBNLT, randomly dropout pixels over any dims (e.g., [H,W] or [C,H,W], or [B,C,H,W]) according to certain probability (e.g., 10%), randomly dropout subset of channels and/or batches, randomly dropout certain shape (e.g., >=1 rectangle or box, >=1 circle, >=1 ring) over H,W dims according to certain probability.

As shown in operation 1417 of FIG. 25, step 8 is to select and tile channels to 2D grid over H,W dim. As will be appreciated by those skilled in the art, in some embodiments, 1) fixed (e.g., first, all) or random subset of channels are selected from input data to [B,C,H,W]; and/or 2) selected channels are tiled over H,W dim to 2D grid (e.g., [B,C=1,Hg=H_grid,Wg=W_grid]) according to certain criteria, for example, reshape (e.g., [B,C=2*2,H,W]→[B,C=1,H*2,W*2], or [B,C=3,H,W]→[B,C=(3+1),H,W] with new channel padded with fixed or random value→[B,C=2,H*2,W*2]. Optionally fixed or random value padding may be added between channels tiled on 2D grid), padding (e.g., [B,C=1,H,W]→[B,C=1,Hg,Wg] with fixed or random padding over H,W).

As shown in operation 1418 of FIG. 25, step 9 is to transform and/or quantize and/or constrain input data. As will be appreciated by those skilled in the art, in some embodiments, 1) transformation step uses a sequence of functions to map input data X to certain range and/or to certain distribution (e.g., approximate normal distribution, reduced skewness, smoothing) and/or to certain statistical assumptions, IBNLT, multiply (e.g., X*a), add (e.g., X+a), divide (e.g., X/a), absolute function (e.g., abs(X)), square root (e.g., sqrt(X)), hyperbolic functions (e.g., tanh(X)), trigonometric functions (e.g., sin(X), cos(X)), sigmoid (e.g., sigmoid(X)), logarithm (e.g., log(X)); 2) quantization step uses a sequence of functions to map input data from large set of values (e.g., continuous set) to a smaller set of discrete values (e.g., 8-bit for 256 levels), IBNLT, modulus, divide, sigmoid, round, ceiling, floor; and/or 3) constrain step uses certain functions to maps values of input data to certain range [min,max], IBNLT, MinMax, sigmoid (e.g., sigmoid(X*scale+shift)*(max-min)+min), softsign (e.g., softsign(X*scale+shift)+1)*0.5*(max-min)+min), modulus (e.g., mod(X*scale+shift, (max-min))+min), tanh (e.g., tanh(X*scale+shift)+1)*0.5*(max-min)+min), sin (e.g., sin(X*scale+shift)+1)*0.5*(max-min)+min).

As shown in operation 1419 of FIG. 25, step 10 is to apply input data to >=1 target layers. As will be appreciated by those skilled in the art, in some embodiments, 1) target layer may be any relevant layers of ONN, such as, input layer, modulation layer (e.g., SLM for phase and/or amplitude and/or polarization, 3D printed), activation layer (e.g., nonlinear CW or spiking NORs), PD layer, either simulated or real one; and/or 2) 4D input data [B,C=1,H,W] may be applied to target layers sequentially (e.g., sequence length=B of 2D [H,W]), or as a whole (e.g., tile sequence length=B of [1,1,H,W] to a single 2D grid [H_grid, W_grid]), or separately (e.g., 1^{st} [1,1,H,W] to 1^{st} target layer, 2^{nd} [1,1,H,W] to 2^{nd} target layer).

In some embodiments:
1) input data (e.g., 4D [B,C=1,H,W], 2D [H,W]) may be converted to 3D/4D spike train of time steps (e.g., 4D [B,T=time_step,H,W], 3D [T,H,W]) according to various spike coding schemes, IBNLT, rate or frequency coding (e.g., uses the frequency of spikes to represent input values. Higher input values result in higher spike frequencies), latency coding (e.g., encodes input values in the timing of the first spike. Stronger inputs lead to earlier spikes), phase coding (e.g., encodes information in the phase relationship between spikes and a background oscillation), population coding (e.g, uses the collective activity of a group of neurons to represent information, rather than relying on single neuron responses), delta modulation (e.g., generates spikes based on changes in the input signal over time. Spikes are produced when the input changes by a certain threshold amount), threshold coding (e.g. generates a spike if the input exceeds a threshold), stochastic coding (e.g., probabilistically generates spikes based on input values), hybrid coding (e.g, combine multiple coding schemes);
2) 3D spike train data [T,H,W] may be applied to target layers sequentially (e.g., sequence length=T of 2D [H,W]), or as a whole (e.g., tile sequence length=T of [1,H,W] to a single 2D grid [H_grid, W_grid]), or separately (e.g., 1^{st} [1,H,W] to 1^{st} target layer, 2^{nd} [1,H,W] to 2^{nd} target layer); and/or
3) 4D spike train data [B,T,H,W] may be applied to target layers sequentially (e.g., sequence length=B of 3D [T,H,W] spike train), or as a whole (e.g., tile sequence length=B*T of [1,H,W] to a single 2D grid [H_grid, W_grid]), or separately (e.g., 1^{st} spike train [1,T,H,W] to 1^{st} T target layers and 2^{nd} spike train [1,T,H,W] to 2^{nd} T target layer, or 1^{st} batch train [B,1,H,W] to 1^{st} B target layers and 2^{nd} batch train [B,1,H,W] to 2^{nd} B target layer);

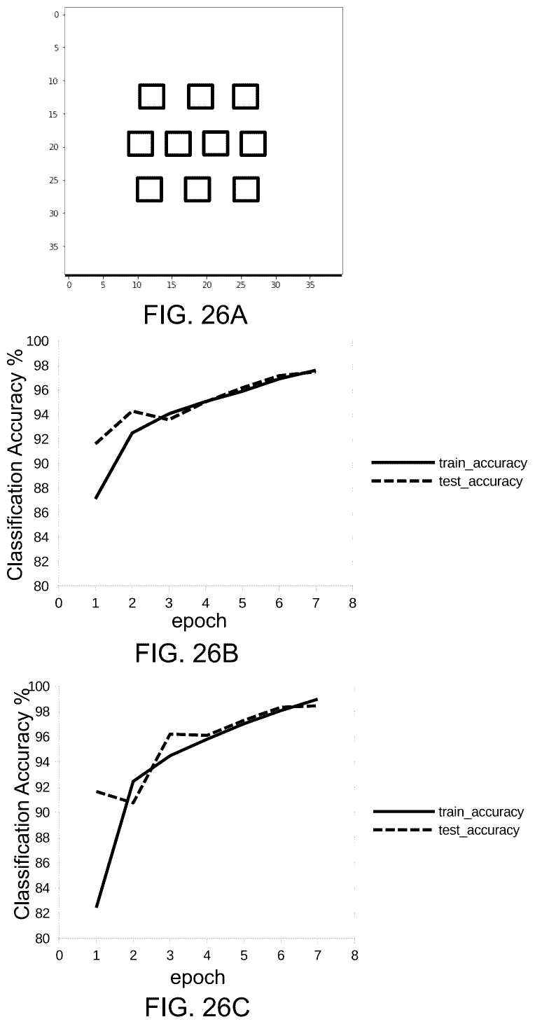

FIG. 26A-C illustrate how an example embodiment of optical nonlinear resonators as CW NORs (for FIG. 26B) or spiking NORs (for FIG. 26C) is used as optical activation function (CW or spiking neurons) of diffractive deep neural network (D2NN) for classification tasks, as an example embodiment for FIG. 23, FIG. 24 and FIG. 25.

FIG. 26A illustrates the layout of 10 rectangle detection areas (3×3 H×W, 3-4-3 layout with distance 4-2-4 horizontally per row and distance 4 vertically) on PD layer (40×40 H×W) of D2NN, which are used as 10 detectors for 10 classification labels of Mnist dataset (https://en.wikipedia.org/wiki/MNIST_database).

When CW NORs is used in D2NN for classification (as illustrated in FIG. 26B), as will be appreciated by those skilled in the art, in some embodiments:
1) D2NN architecture is laser|input|lens|phas|lens|amp|act|lens|phas|lens|amp|act|lens|phas|lens|amp|act|lens|amp|phas|lens|pd, where laser generates Gaussian beam, input is 40×40 phase modulated SLM for input data, lens is lens layer, amp/phas is 40×40 transmissive or reflective amplitude/phase modulated SLM or 3D printed modulation layer, act is activation layer of 40×40 CW NORs (e.g., transmissive or reflective VCSEL or VCSOA), pd is 40×40 photodetector layer;
2) differentiable (pytorch-based) cubic spline is used to fit the same curves (output intensity or phase_shift vs input intensity) as illustrated in FIG. 5M-5N (which is optimized by hyperparameter optimization as illustrated in FIG. 23) for transmissive VCSOA in order to generate output intensity and phase_shift for any input intensity to each CW NOR in act layer; in some embodiments, any differentiable (e.g., pytorch/tensorflow/jax based) simulation model (e.g., based on rate equations [e.g., laser rate equations, Fabry-Perot rate equations, spin-flip model, multimode rate equations, hybrid model or rate equations, etc] and/or FDTD and/or FEM and/or EEM and/or neural network) may be used to simulate CW NOR in act layer;
3) D2NN is trained to classify Mnist dataset with 10 classes/labels;
4) as illustrated in FIG. 25, resize (from 28×28 to 20×20) and normalization (mean=0.1307, std=0.3081) is used to augment input data;
5) channels of augmented input data [B,C=1,H=20,W=20] is repeated 4 times to [B,C=4,H=20,W=20], and tiled over H-W dim to [B,C=1,H=40,W=40] before applied to 40×40 input layer;
6) light intensity on PD is normalized to range [0,1] by dividing light intensity of each pixel on PD by the maximum light intensity on PD layer, then normalized light intensity of all pixels on each of 10 detection areas (as illustrated in FIG. 26A) is summed to generate 10 total light intensity for 10 detectors;
7) total light intensity for each of 10 detectors is transformed to log-probability by Softmax and logarithm function;
8) negative log likelihood loss (NLL_loss) is used for classification loss;
9) in addition to NLL loss, an auxiliary intensity_loss (negative ratio of total light intensity on all 10 detectors on PD layer to total light intensity on input layer) is also used to maximize light intensity on detectors; and/or
10) total loss (NLL_loss+0.1*intensity_loss) is optimized by Adam optimizer (total number of learnable parameters for all phas/amp layers is 12800, learning rate is 0.09 with cosine annealing schedule, batch size is 128).

FIG. 26B illustrates, using CW NORs in D2NN, training and testing classification accuracy curves over 7 epochs of training, with 97.58% best training accuracy and 97.46% best testing accuracy.

When spiking NORs is used in D2NN for classification (as illustrated in FIG. 26C), as will be appreciated by those skilled in the art, in some embodiments:
1) D2NN architecture is: laser|input|lens|phas|lens|amp|lif|lens|phas|lens|amp|lif|lens|phas|lens|amp|lif|lens|phas|lens|amp|lif|lens|phas|lens|pd, where laser generates Gaussian-shape pulse with 10 ps pulse width, input is 40×40 phase modulated SLM for input data, lens is lens layer, amp/phas is 40×40 transmissive or reflective amplitude/phase modulated SLM or 3D printed modulation layer, lif is activation layer of 40×40 NORs (e.g., transmissive or reflective VCSEL-SA) as spiking neurons, pd is 40×40 photodetector layer;
2) Well-known LIF rate equation model for VCSEL-SA (same design parameters as those used for FIG. 5O, which is optimized by hyperparameter optimization as illustrated in FIG. 23) is used to simulate VCSEL-SA based spiking NOR as differentiable (e.g., pytorch based) spiking neuron to generate output pulse for any input pulse to each spiking neuron in lif layer, which is solved by differentiable (pytorch-based) Euler solver; in some embodiments, any differentiable (e.g., pytorch/tensorflow/jax based) simulation model (e.g., rate equation [e.g., LIF model, yamada model, spin-flip model, circuit model, hybrid model or rate equations, etc] and/or FDTD and/or FEM and/or EEM and/or neural network) may be used to simulate spiking NOR as spiking neuron in lif layer;
3) D2NN is trained to classify Mnist dataset with 10 classes/labels;
4) As illustrated in FIG. 25, resize (from 28×28 to 20×20) and normalization (mean=0.1307, std=0.3081) is used to augment input data;
5) channels of augmented data [B,C=1,H=20,W=20] is repeated 4 times to [B,C=4,H=20,W=20], and tiled over H-W dim to [B,C=1,H=40,W=40] before applied to 40×40 input layer;
6) light intensity on PD is normalized to range [0,1] by dividing light intensity of each pixel on PD by the maximum light intensity on PD layer, then normalized light intensity of all pixels on each of 10 detection areas (as illustrated in FIG. 26A) is summed to generate 10 total light intensity for 10 detectors;
7) total light intensity for 10 detectors is multiplied by a temperature parameter (e.g., 40) and transformed to log-probability by Softmax and logarithm function;
8) negative log likelihood loss (NLL_loss) is used for classification loss;
9) in addition to NLL loss, an auxiliary intensity_loss (negative ratio of total light intensity on all 10 detectors on PD layer to total light intensity on input layer) is also used to maximize light intensity on detectors; and/or
10) total loss (NLL_loss+0.1*intensity_loss) is optimized by Adam optimizer (total number of learnable parameters or weight for all phas/amp SLMs is 14400, learning rate is 0.09 with cosine annealing schedule, batch size is 80).

FIG. 26C illustrates, using spiking NORs in D2NN, training and testing classification accuracy curves over 7 epochs of training, with 98.97% best training accuracy and 98.44% best testing accuracy.

The embodiments described herein may include the use of a special purpose or general-purpose computer including various computer hardware or software modules.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In some embodiments, a computer program product can include anon-transient, tangible memory device having computer-executable instructions that when executed by a processor, cause performance of a method that can include: providing a dataset having object data for an object and condition data for a condition; processing the object data of the dataset to obtain latent object data and latent object-condition data with an object encoder; processing the condition data of the dataset to obtain latent condition data and latent condition-object data with a condition encoder; processing the latent object data and the latent object-condition data to obtain generated object data with an object decoder; processing the latent condition data and latent condition-object data to obtain generated condition data with a condition decoder; comparing the latent object-condition data to the latent-condition data to determine a difference; processing the latent object data and latent condition data and one of the latent object-condition data or latent condition-object data with a discriminator to obtain a discriminator value; selecting a selected object from the generated object data based on the generated object data, generated condition data, and the difference between the latent object-condition data and latent condition-object data; and providing the selected object in a report with a recommendation for validation of a physical form of the object. The non-transient, tangible memory device may also have other executable instructions for any of the methods or method steps described herein. Also, the instructions may be instructions to perform a non-computing task, such as synthesis of a molecule and or an experimental protocol for validating the molecule. Other executable instructions may also be provided.

In some embodiments, a computer program product can include anon-transient, tangible memory device having computer-executable instructions that when executed by a processor, cause performance of a method described herein.

The non-transient, tangible memory device may also have other executable instructions for any of the methods or method steps described herein. Also, the instructions may be instructions to perform a non-computing task, such as synthesis of a molecule and or an experimental protocol for validating the molecule. Other executable instructions may also be provided.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

All references recited herein are incorporated herein by specific reference in their entirety.

What is claimed is:

1. A nonlinear all-optical machine learning system with one or more nonlinear optical resonator-based neurons, comprising:
one or more optical input modules configured to convert input information to optical information in the form of at least one of one or more continuous wave lights or one or more light pulses;
one or more linear optical components or layers, each of the linear optical components or layers comprising one or more linear optical elements or devices, each of the one or more linear optical elements or devices configured to perform a linear transformation of at least one of one or more previous output continuous wave or pulse lights;
one or more nonlinear optical components or layers, each of the one or more nonlinear optical components or layers comprising the one or more nonlinear optical resonator-based neurons, each of the one or more nonlinear optical resonator-based neurons configured to perform an optical nonlinear transformation of at least one of the one or more previous output continuous wave or pulse lights; and
one or more output modules, each of the one or more output modules configured to capture at least one of the one or more previous output continuous wave or pulse lights;
wherein the one or more previous output continuous wave or pulse lights comprise at least one of
one or more continuous wave or pulse lights generated by the one or more input modules,
one or more linearly transformed continuous wave or pulse lights by one or more previous linear optical components or layers, or
one or more nonlinearly transformed continuous wave or pulse lights by one or more previous nonlinear optical components or layers;
wherein the optical nonlinear transformation comprises at least one of
a generation of one or more nonlinearly transformed output continuous wave lights,
a generation of one or more nonlinearly transformed output pulse lights, or
a generation of one or more output light pulses if one or more predetermined conditions are met; and
wherein the one or more nonlinear optical resonator-based neurons and the one or more linear optical components or layers collectively define one or more learnable mapping functions between one or more input lights and one or more output lights of the nonlinear all-optical machine learning system in order to meet one or more target objectives or criteria for one or more target tasks or functions.

2. The nonlinear all-optical machine learning system of claim 1, wherein each of the one or more nonlinear optical components or layers is at least one of transmissive or reflective.

3. The nonlinear all-optical machine learning system of claim 1, wherein the one or more nonlinear optical resonator-based neurons comprises at least one of first nonlinear optical resonator-based neurons and at least one of second nonlinear optical resonator-based neurons, and the first and second nonlinear optical resonator-based neurons are at least one of:
a same type or a different type from each other,
or a same design or a different design from each other.

4. The nonlinear all-optical machine learning system of claim 1, wherein each of the one or more nonlinear optical components or layers is at least one of polarization controlled or not polarization controlled.

5. The nonlinear all-optical machine learning system of claim 1, further comprising one or more controllers configured to manage one or more operational states of the one or more nonlinear optical resonator-based neurons based on at least one of one or more temperature values, one or more power consumption values, one or more locations or positions, one or more time periods, one or more types of information, one or more criteria, one or more objectives, or one or more tasks;
wherein each of the one or more power consumption values is selected from the group consisting of a detected value, an estimated value, and a predicted value; and
wherein each of the one or more temperature values is selected from the group consisting of a detected value, an estimated value, and a predicted value.

6. The nonlinear all-optical machine learning system of claim 1, wherein the one or more linear optical components or layers are configured to perform at least one of:
an optical diffraction of one or more light beams comprising at least one of the one or more previous output continuous wave or pulse lights,
a modulation of the one or more light beams,
a split of the one or more light beams into two or more separate light beams,
a combination of two or more light beams into the one or more light beams,
a split and combination of the one or more light beams,
a routing of the one or more light beams from a first subset of one or more optical modules or components to a second subset of the one or more optical modules or components, each optical module or component of the one or more optical modules or components selected from the group consisting of an optical input module, a linear optical component or layer, a nonlinear optical component or layer, and an output module,
a redirection of the one or more light beams,
a steering of the one or more light beams,
a reflection of the one or more light beams,
a reduction of one or more unwanted reflections from at least one of the one or more optical modules or components,
a redirection of one or more reflections from at least one of the one or more optical modules or components,
a coupling of the one or more light beams between at least two of the one or more optical modules or components,
a manipulation or control or transformation of one or more polarization states of the one or more light beams,
a selection of a specific polarization state of the one or more light beams,
a linear amplification of the one or more light beams,
a linear attenuation of the one or more light beams,
a filtering of the one or more light beams,
a guiding of the one or more light beams,
a shaping of the one or more light beams,
a focusing or converging of the one or more light beams,
or a divergence of the one or more light beams.

7. The nonlinear all-optical machine learning system of claim 1, wherein:
a topological layout of two or more nonlinear all-optical machine learning systems is configured with at least one of
a sequential design,
a parallel design,
a symmetric or loop-like design,
a tree like design,
a cyclic graph like design,
or an acyclic graph like design;
and at least one of the two or more nonlinear all-optical machine learning systems is configured with at least one of
a sequential design,
a parallel design,
a symmetric or loop-like design,
a tree like design,
a cyclic graph like design,
or an acyclic graph like design.

8. The nonlinear all-optical machine learning system of claim 1, wherein the nonlinear optical resonator-based neuron comprises at least one of a nonlinear optical resonator-based continuous wave neuron or a nonlinear optical resonator-based spiking neuron.

9. The nonlinear all-optical machine learning system of claim 1, wherein one or more output lights from at least one of the one or more nonlinear optical resonator-based neurons on the one or more nonlinear optical components or layers are polarization controlled,
and the one or more output lights are at least one of one or more reflective output lights, or one or more transmissive output lights.

10. The nonlinear all-optical machine learning system of claim 1, wherein at least one of the one or more nonlinear optical components or layers further comprises at least one of
one or more modulators,
one or more sensors,
one or more transistors,
one or more diffractive optical elements,
one or more lenses or lens arrays,
one or more micro-electro-mechanical systems,
one or more nano-electro-mechanical systems,
one or more active components,
one or more passive components,
one or more active materials,
one or more passive materials,
one or more metamaterials,
one or more thin films,
or one or more composite pixels.

11. The nonlinear all-optical machine learning system of claim 1, further comprising:
one or more first subsets, each first subset comprising one or more first components or pixels on one or more layers or modules of the nonlinear all optical machine learning system, wherein each first subset is configured for one or more first objectives or tasks according to at least one of:
information received by the one or more first subsets,
information processed by the one or more first subsets,
information from one or more integrated computing components,
information from one or more external computing components,
information from the one or more input modules,
or information from the one or more output modules; and
one or more second subsets, each second subset comprising one or more second components or pixels on the one or more layers or modules of the nonlinear all optical machine learning system, wherein each second subset is configured for one or more second objectives or tasks according to at least one of:
information received by the one or more first subsets,
information processed by the one or more first subsets,
information received by the one or more second subsets,
information processed by the one or more second subsets,
information from the one or more integrated computing components,
information from the one or more external computing components,
information from the one or more input modules,
or information from the one or more output modules;
wherein at least one of the one or more first components or pixels and at least one of the one or more second components or pixels are a same component or pixel or a different component or pixel from each other.

12. A nonlinear all-optical machine learning method to inversely design and optimize one or more nonlinear optical resonator-based neurons to be integrated on one or more nonlinear optical components or layers of a nonlinear all-optical machine learning system and configured to perform one or more optical nonlinear transformations of at least one of one or more previous output continuous wave or pulse lights for the nonlinear all-optical machine learning system to function properly to meet one or more target objectives or criteria for one or more target tasks or functions, comprising:
identifying one or more inversely designed optimization objectives or tasks and one or more inversely designed design parameter spaces of at least one of the one or more nonlinear optical resonator-based neurons according to relevant information, wherein the one or more inversely designed optimization objectives or tasks and the one or more inversely designed design parameter spaces are inversely designed for the nonlinear all-optical machine learning system to function properly to meet the one or more target objectives or criteria for the one or more target tasks or functions;
choosing at least one of one or more experiment designs or one or more models to optimize one or more designs of the at least one of the one or more nonlinear optical resonator-based neurons;
sampling a set of design points in the one or more inversely designed design parameter spaces according to at least one of the one or more experiment designs or the one or more models;
performing at least one of one or more real experiments or one or more virtual experiments to collect relevant information for each design point of at least one of the one or more nonlinear optical resonator-based neurons; and
building or updating at least one of the one or more models to optimize the one or more designs of at least one of the one or more nonlinear optical resonator-based neurons according to one or more relationships between one or more design parameters and the relevant information collected from at least one of the one or more real experiments or the one or more virtual experiments;
wherein the sampling, the performing, and the building or updating are iterated one or more times until one or more criteria are met.

13. The nonlinear all-optical machine learning method of claim 12, wherein the one or more inversely designed optimization objectives or tasks in the identifying comprises at least one of:
one or more types of at least one of the one or more nonlinear optical resonator-based neurons,
one or more targets or expected properties of at least one of the one or more nonlinear optical resonator-based neurons,
one or more targets or expected properties of one or more input lights for at least one of the one or more nonlinear optical resonator-based neurons,
one or more targets or expected properties of one or more output lights for one or more input lights for at least one of the one or more nonlinear optical resonator-based neurons,
one or more targets or expected properties of one or more relationships between the one or more output lights and the one or more input lights for at least one of the one or more nonlinear optical resonator-based neurons,
one or more optimization objectives for at least one of the one or more nonlinear optical resonator-based neurons,
one or more tasks using the one or more nonlinear optical resonator-based neurons,
or one or more objectives for the one or more tasks using the one or more nonlinear optical resonator-based neurons.

14. The nonlinear all-optical machine learning method of claim 12, wherein the one or more inversely designed optimization objectives or tasks in the identifying comprises at least one of:
one or more target or expected properties of electric currents or voltage or signal applied to one or more gain or loss components to generate nonlinear output response for at least one of the one or more nonlinear optical resonator-based neurons, wherein the one or more gain or loss components comprise at least one of one or more gain medium, one or more loss materials, one or more phase change materials, or one or more modulating devices,
one or more target or expected properties of the one or more gain or loss components to generate nonlinear output response for at least one of the one or more nonlinear optical resonator-based neurons,
one or more target or expected properties of one or more cavities to generate nonlinear output response for at least one of the one or more nonlinear optical resonator-based neurons,
one or more target or expected ranges of one or more frequency detunings to generate nonlinear output response for at least one of the one or more nonlinear optical resonator-based neurons,
one or more target or expected polarization states of at least one of one or more input lights, one or more output transmissive lights, or one or more output reflective lights,
one or more target or expected ranges of at least one of top aperture size or bottom aperture size to generate nonlinear output response for at least one of the one or more nonlinear optical resonator-based neurons,
one or more target or expected nonlinear response ranges for one or more input light intensities,
a minimization of one or more triggering input light intensities to start triggering the nonlinear output response over the one or more target or expected nonlinear response ranges for at least one of the one or more nonlinear optical resonator-based neurons,
a maximization of one or more similarities between one or more target or expected curve shapes and one or more transmissive output light curve shapes over the one or more target or expected nonlinear response ranges for at least one of one or more transmissive nonlinear optical resonator-based neurons,
a maximization of one or more ratios of one or more transmissive output light intensities to the one or more input light intensities over the one or more target or expected nonlinear response ranges for at least one of the one or more transmissive nonlinear optical resonator-based neurons,
a maximization of one or more ratios of the one or more transmissive output light intensities to one or more reflective output light intensities over the one or more target or expected nonlinear response ranges for at least one of the one or more transmissive nonlinear optical resonator-based neurons,
a minimization of one or more ratios of the one or more reflective output light intensities to the one or more input light intensities over the one or more target or expected nonlinear response ranges for at least one of the one or more transmissive nonlinear optical resonator-based neurons,
a minimization of the one or more reflective output light intensities over the one or more target or expected nonlinear response ranges for at least one of the one or more transmissive nonlinear optical resonator-based neurons,
a maximization of the one or more transmissive output light intensities over the one or more target or expected nonlinear response ranges for at least one of the one or more transmissive nonlinear optical resonator-based neurons,
a maximization of one or more nonlinearities between two or more transmissive output light intensities and two or more input light intensities over the one or more target or expected nonlinear response ranges for at least one of the one or more transmissive nonlinear optical resonator-based neurons,
a maximization of one or more similarities between the one or more target or expected curve shapes and one or more reflective output light curve shapes over the one or more target or expected nonlinear response ranges for at least one of one or more reflective nonlinear optical resonator-based neurons,
a maximization of the one or more reflective output light intensities over the one or more target or expected nonlinear response ranges for at least one of the one or more reflective nonlinear optical resonator-based neurons,
a maximization of one or more ratios of the one or more reflective output light intensities to the one or more input light intensities over the one or more target or expected nonlinear response ranges for at least one of the one or more reflective nonlinear optical resonator-based neurons,
a maximization of one or more nonlinearities between two or more reflective output light intensities and the two or more input light intensities over the one or more target or expected nonlinear response ranges for at least one of the one or more reflective nonlinear optical resonator-based neurons,
a minimization of one or more spiking response times over the one or more target or expected nonlinear response ranges for at least one of one or more nonlinear optical resonator-based spiking neurons,
a minimization of one or more threshold input light intensities to trigger one or more output light pulses over the one or more target or expected nonlinear response ranges for at least one of the one or more nonlinear optical resonator-based spiking neurons,
a minimization of one or more refractory periods over the one or more target or expected nonlinear response ranges for at least one of the one or more nonlinear optical resonator-based spiking neurons,
a minimization of one or more peak widths of the one or more output light pulses over the one or more target or expected nonlinear response ranges for at least one of the one or more nonlinear optical resonator-based spiking neurons,
one or more constraints or limits on one or more pulse numbers of the one or more output light pulses over the one or more target or expected nonlinear response ranges for at least one of the one or more nonlinear optical resonator-based spiking neurons,
one or more constraints or limits on one or more light intensity ranges of the one or more output light pulses over the one or more target or expected nonlinear response ranges for at least one of the one or more nonlinear optical resonator-based spiking neurons,
a minimization of one or more light intensities of one or more reflective output light pulses over the one or more target or expected nonlinear response ranges for at least one of one or more reflective nonlinear optical resonator-based spiking neurons,
a minimization of one or more ratios of the one or more light intensities of the one or more reflective output light pulses to the one or more input light intensities over the one or more target or expected nonlinear response ranges for at least one of one or more reflective nonlinear optical resonator-based spiking neurons,
a minimization of the one or more light intensities of one or more transmissive output light pulses over the one or more target or expected nonlinear ranges for at least one of one or more transmissive nonlinear optical resonator-based spiking neurons,
a minimization of one or more ratios of the one or more light intensities of one or more transmissive output light pulses to the one or more input light intensities over the one or more target or expected nonlinear ranges for at least one of one or more transmissive nonlinear optical resonator-based spiking neurons,
a minimization of the one or more light intensities of one or more reflective output light pulses over the one or more target or expected nonlinear ranges for at least one of one or more transmissive nonlinear optical resonator-based spiking neurons,
a minimization of one or more ratios of the one or more light intensities of one or more reflective output light pulses to the one or more input light intensities over the one or more target or expected nonlinear ranges for at least one of one or more transmissive nonlinear optical resonator-based spiking neurons, or
a minimization of one or more ratios of the one or more light intensities of one or more reflective output light pulses to the one or more light intensities of one or more transmissive output light pulses over the one or more target or expected nonlinear ranges for at least one of one or more transmissive nonlinear optical resonator-based spiking neurons.

15. A nonlinear all-optical machine learning method to generate one or more learnable mapping functions of a nonlinear all-optical machine learning system by directly integrating one or more nonlinear optical resonator-based neurons on one or more nonlinear optical components or layers of the nonlinear all-optical machine learning system and directly optimizing a resulting integrated nonlinear all-optical machine learning system to meet one or more target objectives or criteria for one or more target tasks or functions, comprising:
building one or more design models for one or more types or designs of the one or more nonlinear optical resonator-based neurons;
integrating the one or more design models with a simulation model of the nonlinear all-optical machine learning system for one or more target tasks or functions;
obtaining an optimal design of the integrated nonlinear all-optical machine learning system by optimizing at least one of
one or more architectures of the integrated nonlinear all-optical machine learning system,
one or more architectures of the simulation model,
one or more properties or parameters of the integrated nonlinear all-optical machine learning system,
one or more properties or parameters of the simulation model,
one or more designs of at least one of the one or more nonlinear optical resonator-based neurons,
one or more properties or parameters of at least one of the one or more nonlinear optical resonator-based neurons,
or one or more properties or parameters of at least one of the one or more design models;
obtaining one or more physical embodiments of the optimal design of the integrated nonlinear all-optical machine learning system by performing at least one of
a manufacture and assembly of one or more new integrated nonlinear all-optical machine learning system,
a manufacture and assembly of one or more new optical subsystems to replace relevant components or layers of one or more existing nonlinear all-optical machine learning system,
or an application of the optimal design to one or more existing nonlinear all-optical machine learning system; and
performing the one or more target tasks or functions with the one or more physical embodiments of the optimal design of the integrated nonlinear all-optical machine learning system;
wherein the building, the integrating, the obtaining the optimal design, the obtaining the one or more physical embodiments, and the performing are iterated one or more times until one or more criteria are met.

16. The nonlinear all-optical machine learning method of claim 15, wherein each of the one or more design models for the one or more types or designs of the one or more nonlinear optical resonator-based neurons in the building comprises at least one of
a direct model directly used to predict or generate one or more outputs for one or more inputs, or
an indirect model built from one or more inputs and one or more outputs of at least one of the one or more nonlinear optical resonator-based neurons under at least one of one or more designs or one or more input conditions, the indirect model then used to predict or generate the one or more outputs for the one or more inputs.

17. The nonlinear all-optical machine learning method of claim 15, wherein the one or more types or designs of the one or more nonlinear optical resonator-based neurons in the identifying comprise at least one of:
one or more types of at least one of the one or more nonlinear optical resonator-based neurons on one or more nonlinear optical components or layers of the integrated nonlinear all-optical machine learning system,
one or more designs of at least one of the one or more nonlinear optical resonator-based neurons on the one or more nonlinear optical components or layers of the integrated nonlinear all-optical machine learning system,
a candidate list of one or more candidate types of at least one of the one or more nonlinear optical resonator-based neurons on the one or more nonlinear optical components or layers of the integrated nonlinear all-optical machine learning system,
or a candidate list of one or more candidate designs of at least one of the one or more nonlinear optical resonator-based neurons on the one or more nonlinear optical components or layers of the integrated nonlinear all-optical machine learning system.

18. The nonlinear all-optical machine learning method of claim 15, further comprising at least one of:
performing one or more transformations of one or more non-differentiable design models for the one or more types or designs of the one or more nonlinear optical resonator-based neurons to one or more differentiable design models which are then optimized by one or more gradient based optimization methods in the obtaining the optimal design,
performing one or more transformations of at least one of one or more non-differentiable discrete parameters or variables of the one or more types or designs of the one or more nonlinear optical resonator-based neurons to one or more differentiable variables which are then optimized by one or more gradient based optimization methods in the obtaining the optimal design,
performing one or more transformations of at least one of one or more non-differentiable discrete parameters or variables of the one or more design models to one or more differentiable variables which are then optimized by one or more gradient based optimization methods in the obtaining the optimal design,
performing one or more transformations of at least one of one or more non-differentiable discrete parameters or variables of the one or more architectures of the simulation model to one or more differentiable variables which are then optimized by one or more gradient based optimization methods in the obtaining the optimal design, or
performing one or more transformations of at least one of one or more non-differentiable discrete parameters or variables of the one or more architectures of the integrated nonlinear all-optical machine learning system to one or more differentiable variables which are then optimized by one or more gradient based optimization methods in the obtaining the optimal design.

19. The nonlinear all-optical machine learning method of claim 15, further comprising
using one or more first models to generate a first set of one or more optimal designs,
and using one or more second models to generate a second set of one or more optimal designs according to relevant information or feedback from at least one of the one or more first models, or performance of applying the first set of one or more optimal designs to the integrated nonlinear all-optical machine learning system.

20. The nonlinear all-optical machine learning method of claim 15, further comprising
transforming an input data to be applied to one or more target two-dimensional (2D) optical layers of the integrated nonlinear all-optical machine learning system, wherein the transforming comprising at least one of:
transforming the input data to four dimensions (4D),
augmenting an output data from a previous step,
selecting one or more filters to augment the output data from the previous step,
selecting one or more channels from the output data from the previous step,
performing at least one of a spatial transformation of the output data from the previous step or a selection of one or more patches from the output data from the previous step,
augmenting the output data from the previous step to two or more views,
dropouting one or more elements of the output data from the previous step,
selecting one or more channels from the output data from the previous step and tiling the selected one or more channels to 2D grid spatially over H and W dimensions,
performing at least one of a transformation of the output data from the previous step, a quantization of the output data from the previous step, or a constraining of the output data from the previous step, or
applying the output data from the previous step to the one or more target 2D optical layers of the integrated nonlinear all-optical machine learning system.
